(19) United States
(12) Patent Application Publication
(10) Pub. No.: US 2025/0312911 A1
(43) Pub. Date: Oct. 9, 2025

(54) HIP ASSEMBLY AND KINEMATICS OF A HUMANOID ROBOT

(71) Applicant: Figure AI Inc., San Jose, CA (US)

(72) Inventors: Victor Ragusila, San Jose, CA (US); Ryan Benyshek, San Jose, CA (US); Brian Mick, San Jose, CA (US); Jose Domingo Briones Bravo, San Jose, CA (US)

(21) Appl. No.: 19/171,181

(22) Filed: Apr. 4, 2025

Related U.S. Application Data
(60) Provisional application No. 63/574,349, filed on Apr. 4, 2024.
(60) Provisional application No. 63/633,113, filed on Apr. 12, 2024.
(60) Provisional application No. 63/634,042, filed on Apr. 15, 2024.
(60) Provisional application No. 63/634,599, filed on Apr. 16, 2024.

(51) Int. Cl. B25J 9/00; B25J 9/12

(52) U.S. Cl. CPC B25J 9/0015; B25J 9/126

(57) ABSTRACT

The present disclosure provides a humanoid robot with an arrangement of components that allows the robot to mimic the movements, functionality and capabilities of a human being. The robot includes a torso coupled to a waist, an arm assembly, and a head assembly. A pelvis is coupled to the waist and has left and right actuator mounts. Left and right hip assemblies are coupled to the respective actuator mounts. Each hip assembly includes a hip pitch actuator assembly, a hip roll actuator assembly, and a leg twist actuator assembly. The hip pitch actuator assembly has a portion positioned within the pelvis and is coupled to the actuator mount. The hip roll actuator assembly is coupled to the hip pitch actuator assembly, with a non-90 degree angle formed between their axes. The leg twist actuator assembly is coupled to the hip roll actuator assembly and positioned below extents of both the hip pitch and hip roll actuator assemblies.

### PRIORITY CLAIM AND CROSS-REFERENCE TO RELATED APPLICATIONS

This application claims priority under 35 U.S.C. § 119 (e) to U.S. Provisional Patent Application No. 63/634,599, filed Apr. 16, 2024, U.S. Provisional Patent Application No. 63/634,042, filed Apr. 15, 2024, U.S. Provisional Patent Application Nos. 63/633,113 filed Apr. 12, 2024, U.S. Provisional Patent Application No. 63/574,349, filed Apr. 4, 2024, U.S. Provisional Patent Application No. 63/574,993, filed Apr. 5, 2024, U.S. Provisional Patent Application No. 63/575,887, filed Apr. 8, 2024, each of which is expressly incorporated by reference herein in its entirety.

Reference is hereby made to: (i) PCT Application Nos. PCT/US2025/012544, PCT/US2025/010425, PCT/US2025/011450, PCT/US2025/016930, PCT/US2025/019793, PCT/US2025/023064, (ii) U.S. patent application Ser. Nos. 18/919,263, 18/919,274, 19/006,191, 19/000,626, 19/038,657, 19/064,596, 19/066,122, (iii) U.S. Provisional Patent Application Nos. 63/561,295, 63/561,302, 63/564,534, 63/561,325, 63/561,304, 63/564,560, 63/632,630, 63/626,030, 63/626,035, 63/626,028, 63/626,034, 63/564,741, 63/626,037, 63/707,547, 63/708,003, 63/557,874, 63/626,040, 63/696,533, 63/696,507, 63/626,039, 63/722,057, 63/626,105, 63/625,362, 63/625,370, 63/625,381, 63/625,384, 63/625,389, 63/625,405, 63/625,423, 63/625,431, 63/685,856, 63/700,749, 63/633,405, 63/635,152, 63/561,317, 63/573,543, 63/561,311, 63/561,313, 63/633,920, 63/561,318, 63/556,102, 63/633,931, 63/633,941, 63/632,683, 63/634,697, each of which is expressly incorporated by reference herein in its entirety.

### TECHNICAL FIELD

This disclosure relates to a hip assembly and associated kinematics for a robot, specifically a general-purpose humanoid robot. The hip assembly includes a pelvis, as well as various actuators and associated components, configured to provide the robot with the ability to substantially mimic the movements, capabilities, and configuration of human hips.

### BACKGROUND

The present disclosure pertains generally to the field of robotics, with a more specific focus on the mechanical design and kinematic optimization of humanoid robots engineered for operation within human-centric environments and performing tasks traditionally undertaken by humans. A significant impetus for development in this field arises from pressing contemporary workforce dynamics, notably persistent labor shortages across various sectors, particularly impacting roles often characterized as unsafe, physically demanding, or otherwise undesirable. The scale of this issue, exemplified by millions of such job vacancies in the United States alone, underscores a critical need for robust automation solutions. General-purpose humanoid robots, designed to approximate human morphology and function-typically featuring bipedal locomotion, articulated arms, and a head-like structure-represent a promising avenue for addressing these labor gaps, offering the potential for versatile task execution in spaces inherently designed for human presence and activity.

For such humanoid robots to transition from potential solutions to effective operational assets, their design must confer capabilities for seamless interaction with and navigation through complex environments built for humans. This necessitates sophisticated locomotion and articulation systems capable of closely emulating the nuances of human movement patterns, including walking, balancing, turning, and manipulating objects. Central to achieving this requisite level of mobility, stability, and overall dexterity is the intricate design of the robot's core structural and kinematic interface: the hip, pelvis, and waist assemblies. This integrated system governs the robot's posture, balance, the coordination between the torso and lower limbs, and critically defines the available range of motion for legged locomotion and complex body positioning. The requirement for this assembly to mimic human biomechanics is not merely cosmetic; it is fundamentally tied to the robot's ability to function effectively, reliably, and efficiently. An advanced hip, pelvis, and waist assemblies must enable fluid, stable, and adaptable movement across varied terrains, including navigating obstacles like stairs or cluttered floors, while simultaneously ensuring operational durability and optimizing energy consumption within the constraints of the robot's onboard power resources, typically a finite battery supply. Furthermore, precise and predictable control over this complex assembly is paramount for safe and effective task execution. Consequently, there is a well-recognized and pressing unmet need within the robotics field for the disclosed hip, pelvis, and waist assemblies that include optimized kinematics capabilities.

### SUMMARY

The presently disclosed subject matter is directed to a humanoid robot. Particularly, the robot comprises a torso coupled to a waist, an arm assembly, and a head and neck assembly. The robot includes a pelvis coupled to the waist and having a left side with a left actuator mount and a right side with a right actuator mount. The robot includes a left hip assembly coupled to the left actuator mount of the pelvis and including: a left hip pitch actuator including: (i) a portion that is positioned within the pelvis, (ii) a first extent coupled to the left actuator mount of the pelvis, (iii) a second extent, and (iv) a hip pitch axis, a hip roll actuator including: (i) a first extent coupled to the second extent of the hip pitch actuator, (ii) a second extent, and (iii) a hip roll axis, and wherein a non-90 degree angle is formed between said hip roll axis and hip pitch axis, and a leg twist actuator: (i) a first extent coupled to the second extent of the hip roll actuator, (ii) a second extent, and (iii) positioned below an extent of both of the hip pitch actuator and hip roll actuator. The robot includes a right hip assembly coupled to the right actuator mount of the pelvis and including: a hip pitch actuator including: (i) a portion that is positioned within the pelvis, (ii) a first extent coupled to the right actuator mount of the pelvis, (iii) a second extent, and (iv) a hip pitch axis, a hip roll actuator including: (i) a first extent coupled to the second extent of the hip pitch actuator, (ii) a second extent, and (iii) a hip roll axis, and wherein a non-90 degree angle is formed between said hip roll axis and hip pitch axis, and a leg twist actuator: (i) a first extent coupled to the second extent of the hip roll actuator, (ii) a second extent, and (iii) positioned below an extent of both of the hip pitch actuator and hip roll actuator.

The presently disclosed subject matter is directed to a humanoid robot. Particularly, the robot comprises a torso coupled to a waist, an arm assembly, and a head and neck assembly, and wherein the waist includes: a main body; a torso twist actuator having: (i) a first extent coupled to the main body, (ii) a second extent, and (iii) a torso twist axis that is coplanar with the coronal plane, when the humanoid robot is in a neutral position; a pelvis having: a pelvis frame coupled to a left hip assembly and a right hip assembly; a torso lean actuator coupled to the pelvis frame and including: (i) a portion that is positioned within said pelvis frame, (ii) a first extent, and (iii) a torso lean axis; a spine support assembly coupled to the second extent of the torso twist actuator and a first extent of the torso lean actuator, and wherein a spine angle is formed between the torso twist axis and the torso lean axis, when the humanoid robot is in the neutral position.

The presently disclosed subject matter is directed to a humanoid robot. Particularly, the robot comprises a lower region configured to be in contact with a support surface; a central region coupled to the lower region and having: a waist with a torso twist actuator with a torso twist axis; a leg twist actuator with a leg twist axis, and wherein the leg twist axis and the torso twist axis are substantially parallel with one another when the humanoid robot is in a neutral position; an upper region coupled to the central region and having: a head and neck assembly, an arm assembly, a torso coupled to the waist and lacking an actuator that is positioned above the torso twist actuator and is configured to allow the robot to move its torso toward the support surface.

The presently disclosed subject matter is directed to a humanoid robot. Particularly, the robot comprises a lower region configured to be in contact with a support surface; a central region coupled to the lower region and having: a waist with a torso twist actuator with a torso twist axis; a leg twist actuator with a leg twist axis, and wherein the leg twist axis and the torso twist axis are substantially parallel with one another when the humanoid robot is in a neutral position; a pelvis coupled to the waist, and wherein the humanoid robot lacks: (i) a structure that is directly coupled to both of the leg twist actuator and the torso twist actuator, and (ii) a rotatory actuator that is aligned with and positioned below the torso twist axis.

The presently disclosed subject matter is directed to a humanoid robot. Particularly, the robot comprises a torso; a torso twist actuator coupled to the torso and configured to allow the torso to move about a torso twist axis, and wherein said torso twist axis is arranged coplanar with the coronal plane, when the humanoid robot is in a neutral position; and a torso lean actuator: (i) coupled to the torso twist actuator, and (ii) having a torso lean axis that is oriented at a spine angle relative to the torso twist axis, when the humanoid robot is in the neutral position.

The presently disclosed subject matter is directed to a humanoid robot. Particularly, the robot comprises a torso coupled to an arm assembly and a pelvis; a hip assembly coupled to the pelvis and including: a hip pitch actuator with a hip pitch axis, a hip roll actuator coupled to the hip pitch actuator and including a hip roll axis, and wherein the hip roll axis is oriented at a hip angle relative to the hip pitch axis, and a leg twist actuator: (i) coupled to the hip roll actuator, (ii) positioned below an extent of both of the hip pitch actuator and hip roll actuator, and (iii) includes a leg twist axis that is arranged coplanar with the hip pitch axis.

The presently disclosed subject matter is directed to a humanoid robot. Particularly, the robot comprises a torso; a waist coupled to the torso; a pelvis coupled to the waist; and a hip assembly coupled to the pelvis, wherein the hip assembly includes a plurality of actuators arranged in a non-orthogonal configuration.

The presently disclosed subject matter is directed to a humanoid robot. Particularly, the robot comprises a waist; a pelvis coupled to the waist; and a leg coupled to the pelvis, wherein the leg includes a first actuator positioned above a second actuator, and wherein the second actuator is configured to rotate about an axis that is non-vertical when the humanoid robot is in a neutral standing position.

The presently disclosed subject matter is directed to a humanoid robot. Particularly, the robot comprises a central body portion; an upper body portion coupled to the central body portion; and a lower body portion coupled to the central body portion, wherein the central body portion includes an actuator configured to enable twisting motion between the upper body portion and the lower body portion.

The presently disclosed subject matter is directed to a humanoid robot. Particularly, the robot comprises a torso; a pelvis; and a hip joint connecting the torso to the pelvis, wherein the hip joint includes a first actuator positioned within the pelvis and a second actuator positioned outside the pelvis.

The presently disclosed subject matter is directed to a humanoid robot. Particularly, the robot comprises a waist; a pelvis coupled to the waist; and a leg coupled to the pelvis, wherein the leg includes a first actuator configured to enable rotation about a first axis and a second actuator configured to enable rotation about a second axis, and wherein the first axis and the second axis are non-parallel and non-perpendicular to each other.

The presently disclosed subject matter is directed to a humanoid robot. Particularly, the robot comprises a torso; a pelvis; and a hip assembly connecting the torso to the pelvis, wherein the hip assembly includes a first actuator and a second actuator arranged in a stacked configuration, and wherein an axis of rotation of the first actuator is offset from an axis of rotation of the second actuator.

The presently disclosed subject matter is directed to a humanoid robot. Particularly, the robot comprises a central portion including a waist and a pelvis; an upper portion coupled to the central portion; and a lower portion coupled to the central portion, wherein the central portion includes an actuator configured to enable rotation of the upper portion relative to the lower portion about an axis that is non-vertical when the humanoid robot is in a neutral standing position.

The presently disclosed subject matter is directed to a humanoid robot. Particularly, the robot comprises a torso; a pelvis; and a hip joint connecting the torso to the pelvis, wherein the hip joint includes a first actuator configured to enable rotation about a first axis and a second actuator configured to enable rotation about a second axis, and wherein the first axis and the second axis are skew lines.

The presently disclosed subject matter is directed to a humanoid robot. Particularly, the robot comprises a waist; a pelvis coupled to the waist; and a leg coupled to the pelvis, wherein the leg includes a first actuator, a second actuator, and a third actuator arranged in a non-collinear configuration.

In other embodiments, the humanoid robot may include left and right hip assemblies connecting the lower portion to a central pelvis. Each hip assembly comprises multiple actuators, typically including a hip pitch actuator (potentially positioned within the pelvis), a hip roll actuator coupled externally, and a leg twist actuator positioned below the others. Said humanoid robot also includes a non-perpendicular orientation between the hip pitch axis and the hip roll axis, with embodiments specifying this angle as being between 15 and 25 degrees, potentially relative to the flex axis or a vertical axis, or alternatively between 65 and 75 degrees relative to the hip pitch axis. These rotary hip actuators may possess a peak torque of 101.6-152.4 N-m, utilize cross-roller bearings, and feature through-bores for internal wiring. The pelvis frame itself may incorporate integral motion limit stops restricting hip pitch movement (e.g., 10-40 degrees backward, 145-175 degrees forward), while the leg twist axis is generally parallel to the torso twist axis or vertical in a neutral position.

Further, the robot's central portion may include a pelvis and a waist, connecting to the upper torso. The waist often has a distinct shallow parabolic shape (wider than high) with a downward-projecting actuator housing offset towards the front. This central region houses actuators for torso movement, including a torso lean actuator (typically coupled to the pelvis above the hip pitch actuators) enabling lateral leaning, and a torso twist actuator (often housed in the waist's projecting housing) allowing rotation relative to the pelvis. A spine support assembly can link these torso actuators. Motion limits for these torso actuators may be implemented via limitings. An Inertial Measurement Unit (IMU) is often mounted on the pelvis frame as a reference point. Notably, embodiments may lack specific actuators, such as one for bending the torso towards a support surface or a rotary actuator aligned directly below the torso twist axis.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIGS. 1A-1B are perspective view of a robot in an extended position, and wherein said robot includes: (i) an upper portion having the following parts: (a) a head and neck assembly, (b) a torso, (c) left and right shoulders, (d) left and right upper arm assemblies that each include an upper humerus, lower humerus, upper forearms, and lower forearms, (e) left and right wrists, and (f) left and right hands, (ii) a central portion having the following parts: (a) a waist/spine, (b) a pelvis, (c) left and right hips, (d) left and right upper thighs, and (f) left and right lower thighs, and (iii) a lower portion having the following parts: (a) a left and right shins, (b) left and right talus, and (c) left and right feet;

FIG. 2 is a front view of the cross-roller bearings contained in the central portion of the robot of FIG. 1;

FIG. 3 is a side view of the cross-roller bearings of FIG. 2;

FIG. 4 is a perspective view of a waist, pelvis, and hip assemblies of the robot of FIG. 1;

FIG. 5 is a side view of the waist, pelvis, and hip assemblies of FIG. 4;

FIG. 6 is a rear view of the waist, pelvis, and hip assemblies of FIG. 4;

FIG. 7 is a top view of the waist, pelvis, and hip assemblies of FIG. 4;

FIG. 8 is a bottom view of the waist, pelvis, and hip assemblies of FIG. 4;

FIGS. 9A-9B is an exploded view of the waist, pelvis, and the hip assembly of FIG. 4, wherein said waist includes: (i) a waist body, (ii) perforated vent panels, (iii) a spine support assembly, and said hip assembly includes a pelvis;

FIG. 10 is a front view of the waist, pelvis, and hip assemblies of FIG. 4;

FIG. 11 is a cross-sectional view of the waist, pelvis, and hip assemblies taken along line 11-11 of FIG. 10, and showing the hard stop of the spine actuator J10 and how the spine support assembly is coupled to J9;

FIG. 12 is a perspective view of the pelvis of FIG. 4 with the spine support assembly of the spine twist actuator J9 of the waist and the spine lean actuator J10 of the pelvis;

FIG. 13 is a front view of the pelvis and an extent of the waist of FIG. 12;

FIG. 14 is a front view of the pelvis and an extent of the waist of FIG. 12;

FIG. 15 is a cross-sectional view of the pelvis and an extent of the waist taken along line 15-15 of FIG. 14, and showing the through boring wiring of J9, how the spine support assembly is coupled to J9, and the robot IMU;

FIG. 16 is a first exploded view of the pelvis and an extent of the waist of FIG. 12;

FIG. 17 is a second exploded view of the pelvis and an extent of the waist of FIG. 12, wherein said portion includes a pelvis frame, an IMU, and a rear cover;

FIG. 18 is a front perspective view of the pelvis frame of FIG. 17;

FIG. 19 is a rear perspective view of the pelvis frame of FIG. 18;

FIG. 20 is a front view of the pelvis of FIG. 18;

FIG. 21 is a side view of the pelvis frame of FIG. 18;

FIG. 22 is a front perspective of the pelvis of FIG. 12, and showing an output adapter associated with J9;

FIG. 23 is a perspective view of the output adapter of FIG. 22;

FIG. 24 is a bottom perspective view of the output adapter of FIG. 23;

FIG. 25 is a side view of the output adapter of FIG. 23;

FIG. 26 is a side view of the pelvis and an extent of the waist of FIG. 12;

FIG. 27 is a cross-sectional view of the pelvis taken along line 27-27 of FIG. 26, and showing the hard stops associated with the output adaptor of J9;

FIG. 28 is a top view of the spine support assembly having a torso twist limiting adapter of FIG. 12;

FIG. 29 is a cross-sectional view of the spine support assembly taken along line 29-29 of FIG. 29;

FIG. 30 is a perspective view of the spine support assembly of FIG. 30;

FIG. 31 is a cross-sectional view of the pelvis, an extent of the waist, and hip assembly taken along line 31-31 of FIG. 10, and showing the hard stop of J11, and the positional relationship of J11, J12, and J13;

FIG. 32 is a cross-sectional view of the pelvis, an extent of the waist, and hip assembly taken along line 32-32 of FIG. 10, and showing the through bore wiring of J11;

FIG. 33 is an internal perspective view of a hip pitch actuator J11 of FIG. 1, and showing J11, a hip frame, a pelvis adaptor, and a hip cover;

FIG. 34 is an exploded view of the hip pitch actuator of FIG. 33;

FIG. 35 is a side view of the hip pitch actuator of FIG. 33;

FIG. 36 is a cross-sectional view of the hip pitch actuator taken along line 36-36 of FIG. 35;

FIG. 37 is a first zoomed in view of the circled area F37 in FIG. 36, and showing the interaction between the cover and the housing of J11;

FIG. 38 is a second zoomed in view of the circled area F38 in FIG. 36, and showing the seal formed between the cover and the housing of J11;

FIG. 39 is a first zoomed in view of the circled area F39 in FIG. 36, and showing the interaction between the cover and the frame of J11;

FIG. 40 is a rear perspective view of a cover of the hip pitch actuator of FIG. 33;

FIG. 41 is a side view of the hip pitch actuator cover of FIG. 40;

FIG. 42 is a cross-sectional view of the hip pitch actuator cover taken along line 42-42 in FIG. 42;

FIG. 43 is a perspective view of a hip frame of FIG. 33;

FIG. 44 is a perspective view of the pelvis adapter of FIG. 33;

FIG. 45 is an exploded view of an upper thigh assembly of FIG. 1;

FIG. 46 is front view of the upper thigh assembly of FIG. 45, wherein the front housing or cover has been omitted;

FIG. 47 is a perspective view of the upper thigh assembly of FIG. 46;

FIG. 48 is a front view of the upper thigh assembly of FIG. 46;

FIG. 49 is a cross-sectional view of the upper thigh assembly taken along line 49-49 in FIG. 48, and showing the positional relationship of J12 and J13 along with the through bore wiring of said actuators;

FIG. 50 is a perspective view of a rear housing of the upper thigh assembly of FIG. 45;

FIG. 51 is a front view of the rear housing of FIG. 50;

FIG. 52 is a front perspective view of the rear housing of FIG. 50; and

FIG. 53 is a cross-sectional view of the rear housing taking along 53-53 of FIG. 52.

### DETAILED DESCRIPTION

In the following detailed description, numerous specific details are set forth by way of examples in order to provide a thorough understanding of the relevant teachings. It should be apparent to those skilled in the art, however, that the present teachings may be practiced without such details. In other instances, well-known methods, procedures, components, and/or circuitry have been described at a relatively high-level, without detail, in order to avoid unnecessarily obscuring aspects of the present disclosure.

While this disclosure includes several embodiments in many different forms, there is shown in the drawings and will herein be described in detail embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the hip assembly may be performed in a different order. Accordingly, the drawings, flow charts, and detailed description are to be regarded as illustrative in nature, not restrictive or limiting.

### A. Introduction

The hip assembly disclosed in this Application is designed to be a component within a robot system, potentially a versatile humanoid robot. Enabling such a robot system to execute general human tasks poses a challenge due to the vast array of potential positions and locations, and states said robots could occupy at any given time in a challenging environment. The multitude of these permutations can be minimized by training the robot system through various methods such as: (i) imitation learning or teleoperation, (ii) supervised learning, (iii) unsupervised learning, (iv) reinforcement learning, (v) inverse reinforcement learning, (vi) regression techniques, and/or (vii) other established methodologies. While training may help minimize the multitude of permutations, including undesirable components or undesirable configurations will likely reverse any benefit of training the robot and may make specific tasks impossible or nearly impossible. Accordingly, it is advantageous to include the desirable components and an arrangement of the same to maximize the utilization of training the robot and enable it to perform as many tasks as specified by the robot designer.

An example preferred arrangement of components for a hip assembly is disclosed herein. This configuration can include a pelvis that facilitates coupling to a torso in a manner that allows for torso twist along a super-inferior axis or an axis of a spine of the torso (i.e., Z-axis rotation of the torso relative to the pelvis, or at the intersection between the sagittal and coronal planes) and torso lean about an anterior-posterior axis (i.e., X-axis rotation of the torso relative to the pelvis, or at the intersection of a horizontal reference plane that is parallel with the transverse plane and the sagittal plane). This configuration can further include hip pitch actuator assemblies that couple to the pelvis and facilitate rotation of the legs about a medial-lateral axis (i.e., Y-axis rotation of the legs relative to the pelvis, or at the intersection of a vertical reference plane that is parallel with either of the sagittal or coronal planes and the transverse plane). Also, this configuration can further include hip roll actuator assemblies that are coupled to the hip pitch actuator assemblies and facilitate rotation of the legs about an angled axis (i.e., X-axis rotation of legs relative to the pelvis). Still further, this configuration can include leg twist actuator assemblies that couple to the hip roll actuator assemblies and facilitate rotation of the legs about a longitudinal axis of an upper thigh (i.e., Z-axis rotation of legs relative to an upper thigh). The combination of these ranges of motion, including the positioning of the various actuators and movement joints disclosed herein, can create a hip assembly with desirable packaging and performance characteristics similar to a human's hips.

The positional relationship of the actuators to one another and their general position within the robot 1 provides a substantial advantage over conventional robots. As shown in the Figures, at least a majority of the hip X or hip roll and hip Z or leg twist actuators (i.e., J12 and J13) are positioned below the hip Y or hip pitch (J11), which enables the robot to have a substantially larger torso in relation to conventional robots that lack this configuration. The substantially larger torso provides an advantage because it can house computers, batteries and other required electronics/wiring without requiring the robot to wear a backpack, require swapping of batteries over a short period, or offload the computing requirements to an external computing device/system.

The hip pitch actuator (J11) is directly coupled to the pelvis of the robot 1 and it is positioned closer to both the: (i) spine X or spine/torso roll actuator (J9), and (ii) spine Z or spine/torso yaw actuator (J10), then all other actuators. Unlike in conventional robots, the rotational axis of the hip roll actuator (J12) is not perpendicular to the support surface when the robot is in the neutral position. Instead, the rotational axis of the hip roll actuator (J12) is angled relative to the transverse or horizontal plane when the robot is in the neutral position. In particular, said angle may be: (i) between 0 and 40 degrees, preferably between 10 and 30 degrees, and most preferably between 15 and 25 degrees when the robot is in the neutral position. This positional arrangement is beneficial because it increases the hip roll actuator's (J12) range of motion, allowing robot 1 to bend further down (e.g., in a deep squat) than needed to engage an object resting on the floor or a low shelf.

The hip roll actuator (J12) is not directly connected to the pelvis; instead, it is directly connected to the hip pitch actuator (J11). By coupling the hip roll actuator (J12) to the hip pitch actuator (J11), the center of the cross-roller bearing of the hip roll actuator (J12) is positioned below the cross-roller bearing for each of the following actuator assemblies: (i) the spine X or spine/torso roll (J9), (ii) the spine Z or spine/torso yaw (J10), and (iii) the hip Y or hip/leg pitch, which also performs the spine Y, spine/torso pitch (J11). This configuration is beneficial over conventional robots that lack it because it increases the robot's range of motion and does not limit the size of the torso. Also, the leg twist actuator (J13) is positioned below all other actuators that perform hip or spine movements and is not directly coupled to the pelvis of the robot 1. This enables robot 1 to turn one leg, step on it, turn the whole robot around, and then twist the other leg. This is beneficial because the robot can turn backward 180 degrees by taking only two steps, and in some situations, only a single step. Stated another way, said robot 1 can turn around and start walking in the opposite direction by taking only two (and sometimes one) steps.

When the robot is in the neutral position: (i) the torso twist actuator (J10) is vertically stacked with hip pitch actuator (J11), (ii) hip pitch actuator (J11) is vertically stacked with knee actuator (J14), and (iii) the axis of the leg twist actuator (J13) is substantially perpendicular to the axes of hip pitch actuator (J11) and knee actuator (J14). Also, the axis of torso twist actuator (J10) is configured to be substantially perpendicular to the axis of hip pitch actuator (J11). Also, the axis of hip pitch actuator (J11) is configured to be substantially parallel with the axis of knee actuator (J14). Additionally, the axis of hip roll actuator (J12) is angled relative to the axes of hip pitch actuator (J11), leg twist actuator (J13), and knee actuator (J14). This configuration allows the robot to maintain its legs positioned underneath its body and achieve the desired range of motion.

Unlike conventional robots, the disclosed robot 1 lacks an actuator that controls spine pitch or torso pitch (i.e., bending forward at the robot's belly). By eliminating this actuator, the overall number of actuators in robot 1 is reduced, which eliminates failure points and increases run times. While robot 1 lacks a specific actuator to enable it to bend at its belly, the robot 1 does not lack the ability to pitch its torso forward, because the hip/legs can perform this functionality. The robot utilizes its legs (i.e., hip pitch actuator (J11)) to accomplish this forward pitch. Using the robot's legs to perform this forward motion beneficially places the loads on the hip pitch actuator (J11) for lifting objects off the ground. In other words, robot 1 maintains the ability to bend forward or backward but eliminates the need for an actuator or multiple actuators to allow robot 1 to perform this movement.

The configuration of the leg and its associated actuators ensures that said leg (i.e., hip pitch actuator (J11), hip roll actuator (J12), and leg twist actuator (J13)) cannot be placed in a singularity. This is because the hip roll actuator (J12) cannot be rotated outward to 90 degrees in order to place the axis of the hip pitch actuator (J11) parallel with the axis of the leg twist actuator (J13). Additionally, there is very little utility in rotating the leg outward more than 55 degrees from the sagittal plane. Thus, the configuration of the actuators provides the robot with a significant range of motion without a singularity. In other words, said singularity is positioned outside of the usable working range of the robot's legs.

Unlike some conventional robots that lack a pelvis and directly couple each leg to the torso, the disclosed robot 1 includes a pelvis, which beneficially provides said robot 1 with additional stability and durability. Unlike conventional robot pelvises, the disclosed pelvis frame does not include a substantially flat surface coupled to multiple actuators whose rotational axes are positioned in the Z and X directions. Instead, the disclosed pelvis frame has a depth elongated lateral hyperboloid configuration coupled to multiple actuators whose rotational axes are positioned in the X and Y directions. This configuration increases the robot's durability, allows for clearance of J10, and enables the robot to have the desired range of motion.

Further, the pelvis of the disclosed robot 1 couples the hip actuators (J11) forward of the spine actuators (J9 and J10). The forward coupling of the J11 actuators is beneficial over coupling J11 rearward of the spine actuators because it allows J12 to extend rearward from J11 and position the robot's legs under its torso. Finally, unlike conventional robots, the disclosed robot 1 is able to lean its torso to the left or right using a single rotary actuator. This capability beneficially allows said robot to efficiently pick up items positioned at an angle relative to the robot without requiring it to move, which increases run times and speeds up the time it takes to complete the task.

The positional relationship of the actuators to one another and their general position within robot 1 allows said robot 1 to have a plurality of joints, wherein each joint has its desired range of motion. In particular, the J11 actuator allows the robot to move its leg: (i) backward between 5 degrees and 55 degrees, preferably between 25 and 45 degrees, and most preferably between 30 and 40 degrees, and (ii) forward between 25 and 210 degrees, preferably between 80 and 190 degrees, and most preferably between 145 and 175 degrees. In other words, J11 may be able to move the leg backward at least 5 degrees, preferably at least 25 degrees, and most preferably at least 30 degrees. Likewise, the J11 actuator may be able to move the leg forward at least 25 degrees, preferably at least 80 degrees, and most preferably at least 145 degrees. Thus, the J11 actuator has a range of motion that is at least 30 degrees, preferably at least 105 degrees, and most preferably at least 175 degrees. In some embodiments, J11 may have a range of motion that is approximately 200 degrees.

When J11 is moved to the maximum forward position, it places the knee right next to the chest of the torso. However, in this configuration, the leg contacts the torso. Thus, when J11 is moved to the maximum forward position, J12 needs to move the leg slightly to the side or outward. In other words, the leg needs to be angled outward relative to the sagittal plane. This positional relationship would be beneficial if the robot is lifting a weight or getting off the ground. In particular, the angle of J12 may need to be at least 5 degrees, preferably at least 10 degrees, and most preferably at least 15 degrees from being parallel with the sagittal plane to allow the torso to clear the leg when said leg is in the maximum forward position. However, it is desirable to allow for the clearance of the leg in this maximum forward position with the least amount of rotation needed by J12. As such, the leg may be designed to clear the torso in the maximum forward position when J12 is rotated less than 40 degrees, preferably less than 30 degrees, and most preferably less than 25 degrees from being parallel with the sagittal plane. In other words, said rotation of J12 may need to be positioned between 5 degrees and 40 degrees, preferably between 10 degrees and 30 degrees, and most preferably between 25 degrees and 30 degrees from being parallel with the sagittal plane in order to minimize the amount of rotation needed from J12 and allow for the leg to be fully forward and clear the torso without interference.

As shown in the Figures, J10 allows the robot to twist its torso. This feature helps the robot to reach and grab objects that are positioned to its sides. Accordingly, said robot has a twisting range of motion associated with J10 that is more than 45 degrees, preferably more than 120 degrees, and most preferably more than 170 degrees. While the robot cannot bend forward at its belly, it can bend sideways (as shown in FIGS. 155-157) at its belly. This sideways bending is accomplished using J9. Said range of motion of J9 is between 5 and 50 degrees, preferably between 15 and 40 degrees, and most preferably between 20 and 40 degrees. Also, because the forward bending of the robot is performed using the legs, J9 can be a small/have less torque than J11.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Although selected human medical terminology is used to describe features and/or relative positions related to the humanoid robot, it should be understood that said medical terminology does not directly correspond to the exact same features of a human. It should be understood that names of various assemblies and components (e.g., including housings and assemblies contained within) may generally relate to a location of similar anatomy of a human body but do not have an exact correlation in dimension, function, or shape. The reference system, including three orthogonal reference planes, is defined with respect to the robot in a neutral standing position to describe the relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Neutral Position: In this position, the robot is standing upright on a horizontal support surface SS and facing forward with its torso vertically aligned over its pelvis and legs, where the legs are substantially straight with the knees aligned under the hips and above the ankles, such that the robot's weight is balanced over its feet. In the neutral position, the robot's head is facing forward, the arm assemblies are located at the sides of the robot, the hands are oriented with the palms facing inward, and the fingers are pointing in a substantially downward direction toward the horizontal support surface.

Extended position: a position of the robot with the arm assemblies extended outward laterally at the shoulder and oriented with the palms of the hands facing forward and the fingers pointing in a substantially outward direction, where the central and lower portions of the robot remain in a neutral position.

Sagittal plane: a vertical plane that aids in defining the left and right sides of the robot. Accordingly, the sagittal plane may: (i) divide the robot and/or the torso into left and right sections or halves, (ii) extend through the axis of rotation about which the torso twists or rotates relative to the pelvis and legs, (iii) contain the origin point of the robot, and/or (iv) be directly positioned between the left and right legs, and/or left and right arm assemblies. In the illustrative embodiment, the sagittal plane (P_{S}) is a vertical plane that contains the rotational torso twist axis A₁₀ of the torso twist actuator (J10) located in the spine 60 of the robot 1 and divides the left and right sides of the robot 1. In other words, the sagittal plane (Ps) and the coronal plane (Pc) are coplanar with the rotational torso twist axis A₁₀ of the torso twist actuator (J10), when robot 1 is in the neutral position.

Coronal plane: a vertical plane that aids in defining the front and back portions of the robot. Accordingly, the coronal plane may: (i) divide the robot and/or the torso into front and back sections or halves, (ii) extend through the axis of rotation about which the torso pitches forward or backward, (iii) extend through the axis of rotation about which the knees pitch forward and backward, and/or (iv) extend through the axis of rotation about which the elbow moves forward and backward, when the robot is in the extended position. In various embodiments, said axis of rotation for torso pitch may be bilateral colinear axes, a single centrally located axis, or an axis defined by a line connecting the center of the actuator bearings of two actuators that provide the torso pitch function. In the illustrative embodiment, the coronal plane (P_{C}) is a vertical plane that contains the rotational hip pitch axis A₁₁ of the hip pitch actuators (J11) located in the hips 70 and the rotational torso twist axis A₁₀ of the torso twist actuator (J10) located in the spine 60 of the robot 1. In other words, the coronal plane (P_{C}) is a plane that is coplanar with the rotational hip pitch axis A₁₁ of the hip pitch actuators (J11) and the rotational torso twist axis A₁₀ of the torso twist actuator (J10). Also, as shown in these figures, the coronal plane (P_{C}) does not bisect the robot, or torso, into equal front and back halves, it is offset forward of a majority of the arm actuators in the extended position, and other positional relationships can be understood from the figures.

Transverse plane: a horizontal plane that aids in defining the upper and lower portions of the robot. Accordingly, the transverse plane may: (i) divide the robot into upper and lower sections or halves, (ii) extend through the axis of rotation about which the torso pitches forward or backward, as defined above, and/or (iii) extend through the widest part of the pelvis. In the illustrative embodiment, the transverse plane (P_{T}) is a horizontal plane that contains the rotational hip pitch axis A₁₁ of the hip pitch actuators (J11) located in the hips 70 of robot 1. Also, as shown in these figures, the transverse plane (P_{T}) is positioned below both spine actuators (J9 and J10), in front of a majority of the arm actuators, and other positional relationships that can be understood from the figures.

Origin point: the orthogonal intersection point of the sagittal plane, coronal plane, and transverse plane, all of which extend through the humanoid robot disclosed herein.

Reference Axes: consist of: (i) the Z-axis (vertical) is defined at the intersection of the sagittal plane and coronal plane, (ii) the Y-axis (horizontal) is defined at the intersection of the coronal plane and transverse plane; and (iii) the X-axis (depth) is defined at the intersection of the sagittal plane and transverse plane.

Range of motion: a range of rotational motion of an actuator about an axis of rotation, where a first and second angle defines a rotational limit in opposing rotational directions from a neutral position, expressed in degrees of rotation.

Degrees of Freedom (DoF): the number of parameters that define the configuration of a kinematic chain and the possible movements associated therewith.

Joint singularities: geometric configurations of the robot's joints in which one or more degrees of freedom are effectively lost due to the alignment or overlap of rotational or translational axes.

### C. Robot

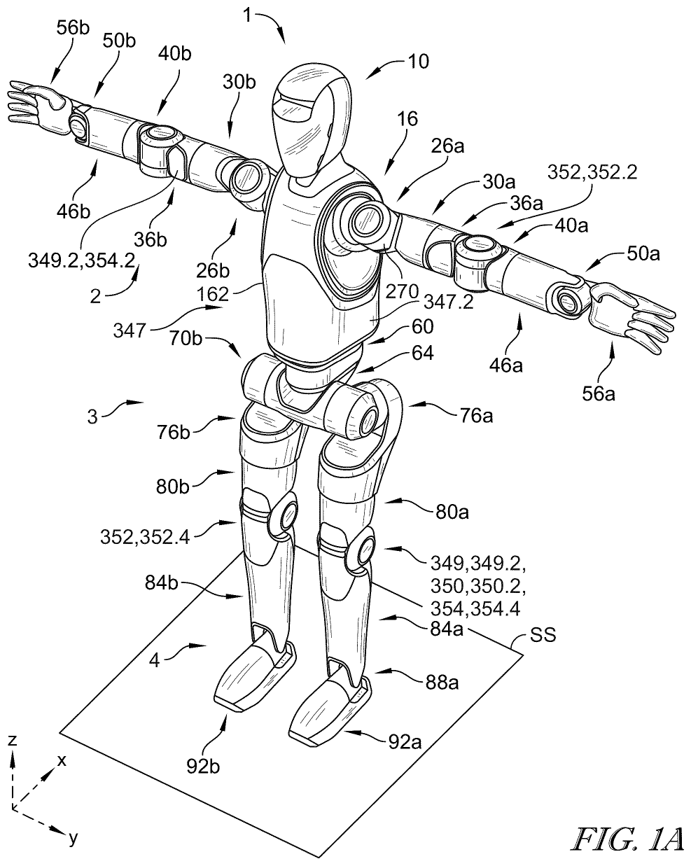

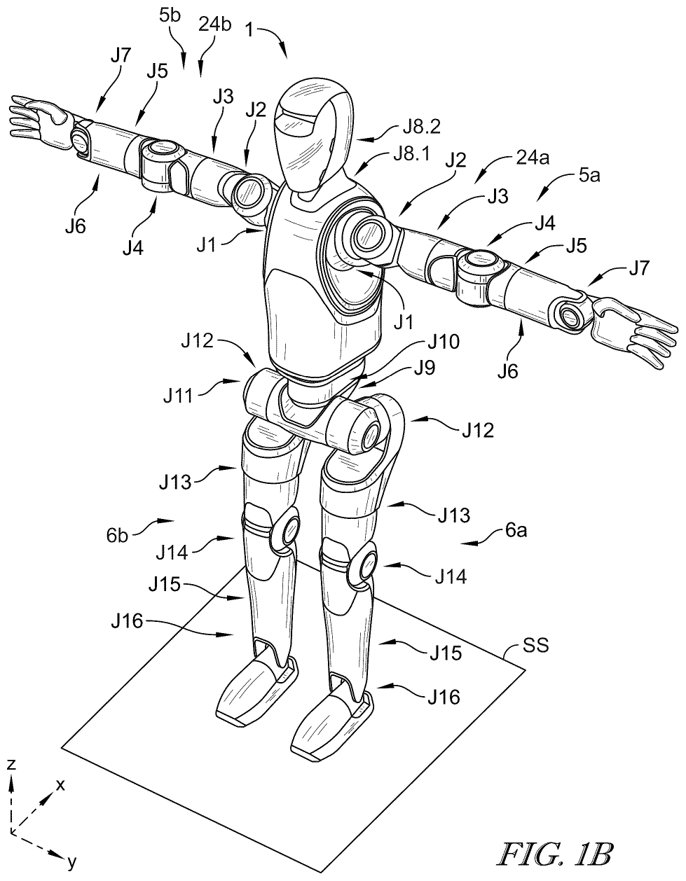

Referring to FIG. 1, a humanoid robot 1 may include the following systems, assemblies, components, and/or parts: (i) an upper region including a head and neck assembly 10, torso 16, left and right arm assemblies 5, and left and right hands 56; (ii) a central region including a spine 60, a pelvis 64, and left and right upper leg assemblies, each upper leg assembly including a hip 70, an upper thigh 76, and a lower thigh 80; and (iii) a lower region including left and right lower leg assemblies, each lower leg assembly including a shin 84 and a talus 88, and feet 92. Each arm assembly 5 includes a shoulder 26, an upper humerus 30, a lower humerus 36, an upper forearm 40, a lower forearm 46, and a wrist 50. Each leg 6 includes a hip 70, an upper thigh 76, a lower thigh 80, a shin 84, and a talus 88.

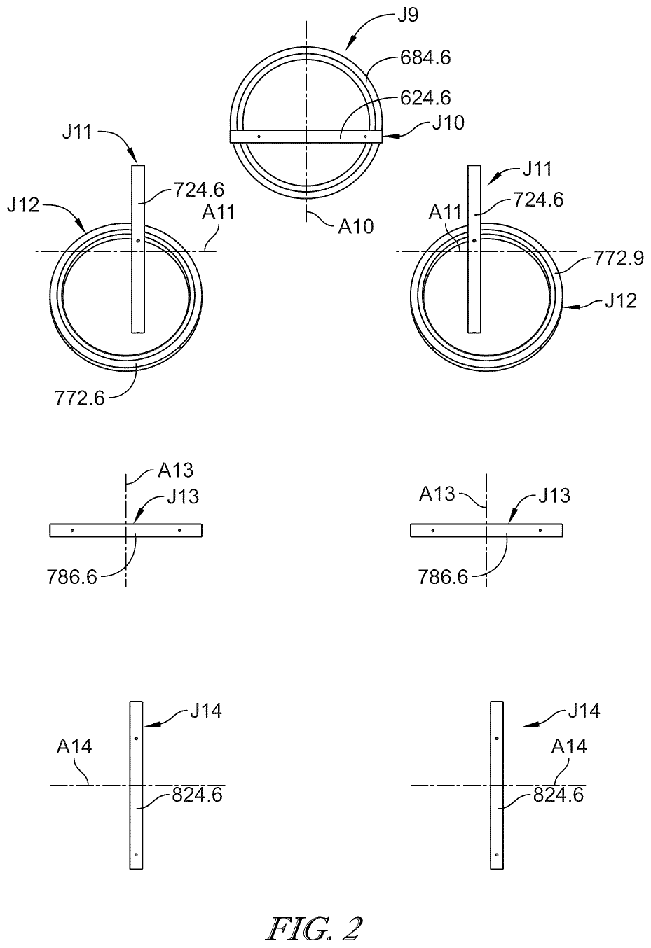

A plurality of actuators are arranged within and coupled to various housings of robot 1 and are configured to move one or more parts of the robot 1. In the illustrative embodiment, the positions of various actuators are indicated in FIG. 2, showing the individual actuator bearings contained within various rotary actuators (J1-J14, J16) and suggesting corresponding rotational axes that are centered within and orthogonal to a plane intersecting the individual actuator bearings. For example, the actuator bearings in the illustrative embodiment may be cross-roller bearings. The individual actuator names, actuator bearings, and axes are further detailed in Table 1 below. It should be understood that in other embodiments, some of these systems, assemblies, components, and/or parts may be omitted, combined, or replaced with alternative systems, assemblies, components, and/or parts.

The robot 1 includes various actuators arranged within the robot 1 to closely replicate human movements and capabilities. In the illustrative embodiment, the left and right legs 6 extend from the pelvis 64 of the robot 1. The actuators in the upper leg assembly 6.1 include: (i) a hip pitch actuator (J11) 720 configured to move the leg 6 forward and backward relative to the robot's torso 16, (ii) a hip roll actuator (J12) 768 configured to move the leg 6 sideways (e.g., to the left or right) relative to the robot's torso 16, (iii) a leg twist actuator (J13) 782 configured to rotate the leg 6 relative to the robot's torso 16, and (iv) a knee actuator (J14) 820 configured to bend the knee or leg of the robot 1. The lower leg assembly 6.2 includes a foot flex actuator (J15) 860 configured to change the pitch of the foot 92 and a foot roll actuator (J16) 900 configured to roll the foot 92.

The housing or exoskeleton of the components of robot 1 can vary in shape and form based on individual structural and/or material requirements for the specific components (e.g., torso, shoulder, head, etc.). Although it may be desirable to utilize a particular material for all the housings to have a consistent exterior appearance for the robot, fabrication may be complicated by the varying structural or operational needs at different robot positions. It may not be necessary to utilize the same materials in different component housings that have different load requirements. Various materials may be preferred for a specific component housing based on strength, toughness, elasticity, yield point, strain energy, resilience, elongation during load, weight, conductivity, etc. Similarly, the complexity of some housing designs may be better suited for one type of manufacture over another. Various fabrication methods of the housing components can include machining, die casting, injection molding, compression molding, composite fabrication, etc. For example, some housings may be cast metal instead of machined metal to achieve the desired cost, form, speed of manufacturing, and mechanical properties.

To hide the fact that different fabrication methods may be used, different materials may be used, the finishes caused by the fabrication methods, or the finishes of the materials themselves, it may be advantageous to obscure the exterior of housings using an exterior covering system 347. Said exterior covering system 347 may provide additional benefits, as it can be easily replaced if damaged, protects internal components from dust and debris, conforms to the robot's form without excessive wrinkling, is generally inexpensive, and accommodates ventilation and thermal regulation needs. Further, the exterior covering system 347 may not impede the robot's 1 range of motion, may maintain access to underlying components, and may allow for access and/or operation of indicators or other functional elements (e.g., buttons, levers, etc.) on the robot's exterior surface. The exterior covering system 347 may include attachment mechanisms for secure, detachable mounting at multiple locations, such as the collar, waist, sleeves, ankles, etc. Multi-point attachment ensures a snug fit, reducing the risk of interference between the robot 1 and factory equipment. In some instances, the cover members 347.2 of the exterior covering system 347 can attach directly to the surface of specific components or their portions. The exterior covering system 347 can be constructed from highly durable textiles with high stretch capabilities and resistance to pilling, abrasions, and cuts. Additional information about said cover members and/or their materials is disclosed in U.S. patent application Ser. No. 19/066,122, which is incorporated herein by reference.

The disclosed exterior covering system 347 for the humanoid robot 1 is form-fitting, meaning it is neither loose nor detached by more than a small margin (e.g., between 1 inch and 5 inches, preferably 3 inches) from the robot's exterior surface or the outer surface of the energy attenuation assembly without becoming disconnected. In other words, rather than draping loosely over the robot's frame, the exterior covering system is precisely and securely fitted to specific regions. The exterior covering material exhibits an elongation or stretch percentage exceeding 10% (preferably more than 30%, and most preferably greater than 50%), ensuring that when affixed to the robot 1, it remains under tension to conform closely to the robot's structure. Furthermore, a single cover member 347.2 does not cover or surround all actuators within the robot 1, a majority of the actuators contained in an upper portion of the robot 1, nor does it typically enclose more than three actuators at a time. In other words, a single cover member 347.2 does not resemble an oversized jumpsuit with a single zipper extending from the pelvis to the head region. Additionally, it does not feature a hood that covers a substantial portion of the robot's head. Instead, the exterior covering system 347 may be designed to include textile inserts positioned strategically between moving joint components to further ensure that pivoting motion is not restricted at the robot's joints. Different textile patterns are incorporated to facilitate movement in specific regions, enhancing the robot's functional dexterity.

The humanoid robot 1 may also integrate an energy attenuation assembly 349 comprising multiple energy attenuation members 349.2. These members 349.2 may be positioned beneath the exterior coverings and in contact with certain housings, contributing to impact absorption and structural integrity. The inclusion of energy attenuation members 349.2 is beneficial for protecting the robot 1 during operation and interaction with its environment. These members 349.2 may be strategically placed adjacent to particular housings or specific portions thereof to provide additional support and protection to underlying components. The energy attenuation members 349.2 are composed of non-rigid, deformable, compressible, or energy-absorbing materials. For example, component housings may include coupling features designed to accommodate energy attenuation members 349.2, particularly in interference zones where excessive rotation could result in a component collision. The energy attenuation members 349.2 can be designed as detachable and replaceable elements. Depending on the embodiment, they may be coupled directly to the housing, surround the housing, or be secured via the cover members 347.2. These features allow for modularity, enabling the replacement or removal of energy attenuation members 349.2 as needed.

A portion of the energy attenuation assembly 349 may be included in a rotation limiting system 350 configured to prevent damage due to over rotation of certain actuators. The rotation limiting system 350 includes external replaceable members 350.2 that are coupled to various housings to prevent possible damage due to over rotation of certain actuators. For example, the rotation limiting system 350 includes deformable members 350.2 that are made from an energy-absorbing material (e.g., TPU) and are designed to: (i) help ensure that the actuator and/or the leg portion does not over-rotate in either direction, (ii) reduce pinch points associated with the knee, and (iii) allow the robot to have a more human-like appearance. The rotation limiting system 350 includes a protective assembly 352 and a soft stop assembly 354. The protective assembly 352 includes an elbow protective assembly 352.2 and a knee protective assembly 352.4. The soft stop assembly 354 includes an elbow soft stop assembly 354.2 and a knee soft stop assembly 354.4. In various embodiments, the actuators may also include internal limiting features (e.g., hard-stop or range of motion limiters).

Shown in at least FIGS. 1-4, the actuators contained within the physical robot 1 include actuators (J1-J16) housed within components of robot 1 to actuate movement of the components of said robot 1. Below is a summary table showing the actuator reference names and numbers, actuator names, and associated components from a high level configuration of robot 1. In particular, the actuator bearing of individual actuators may help define the motion of the component or structure attached to the output driven by the individual actuators.

TABLE 1

| | | | Actuator |
|---|---|---|---|
| | | | Bearing |
| | | | Plane B, |
| | | | and |
| | | | (Actuator |
| Actuator | Actuator Name | Actuator Axis | Bearings) |
| J1 | Arm Actuator | Arm Axis, A₁ | B₁ |
| (190) | | | (194.12) |
| J2 | Shoulder Actuator | Shoulder Axis, A₂ | B₂ |
| (280) | | | (284.6) |
| J3 | Upper Arm Twist, | Upper Arm Twist, Upper | B₃ |
| (320) | Upper Arm X, or | Arm X, or Upper Arm | (324.6) |
| | Upper Arm Roll | Roll Axis, A₃ | |
| | Actuator | | |
| J4 | Elbow, Arm Z, | Elbow, Arm Z, Arm Yaw, | B₄ |
| (374) | Arm Yaw, or Lower | or Lower Humerus Axis, | (378.6) |
| | Humerus Actuator | A₄ | |
| J5 | Lower Arm Twist, | Lower Arm Twist, Lower | B₅ |
| (468) | Lower Arm X, | Arm X, or Lower Arm Roll | (472.6) |
| | or Lower Arm | Axis, A₅ | |
| | Roll Actuator | | |
| J6 | Wrist Flex, | Wrist Flex, Wrist/Hand Y, | B₆ |
| (484) | Wrist/Hand Y, | Wrist/Hand Pitch, or Flick | (488.6) |
| | Wrist/Hand Pitch, | Axis, A₆ | |
| | or Flick Actuator | | |
| J7 | Wrist Pivot, | Wrist Pivot, Wrist/Hand Z, | B₇ |
| (520) | Wrist/Hand Z, | Wrist/Hand Yaw, or Wave | (524.6) |
| | Wrist/Hand Yaw, | Axis, A₇ | |
| | or Wave Actuator | | |
| J8.1 | Head Twist, Head | Head Twist, Head No, | B_{8.1} |
| (120) | No, or First | or First Head Axis, A_{8.1} | (124.6) |
| | Head Actuator | | |
| J8.2 | Head Nod, Head | Head Nod, Head Yes, or | B_{8.2} |
| (140) | Yes, or Second | Second Head Axis, A_{8.2} | (144.6) |
| | Head Actuator | | |
| J9 | Torso Lean, | Torso Lean Actuator, Spine | B₉ |
| (680) | Spine X, | X, Torso/Spine Roll, or | (684.6) |
| | Torso/Spine | First Spine Axis, A₉ | |
| | Roll, or | | |
| | First Spine | | |
| | Actuator | | |
| J10 | Torso Twist, | Torso Twist, Spine Z, | B₁₀ |
| (620) | Spine Z, | Torso/Spine Yaw, or | (624.6) |
| | Torso/Spine Yaw, | Second Spine Axis, A₁₀ | |
| | or Second Spine | | |
| | Actuator | | |
| J11 | Hip Flex, Hip Y, | Hip Flex, Hip Y, Hip/Leg | B₁₁ |
| (720) | Hip/Leg Pitch, | Pitch, Forward Kick, or | (724.6) |
| | Forward Kick, or | First Hip Axis, A₁₁ | |
| | First Hip Actuator | | |
| J12 | Hip Pivot, Hip X, | Hip Pivot, Hip X, Hip/Leg | B₁₂ |
| (768) | Hip/Leg Roll, | Roll, Sideways Kick, or | (772.6) |
| | Sideways Kick, or | Second Hip Axis, A₁₂ | |
| | Second Hip | | |
| | Actuator | | |
| J13 | Leg Twist, Hip | Leg Twist, Hip Z, or | B₁₃ |
| (782) | Z, or Hip/Leg | Hip/Leg Yaw Axis, A₁₃ | (786.6) |
| | Yaw Actuator | | |
| J14 | Knee, Lower Thigh, | Knee, Lower Thigh, Lower | B₁₄ |
| (820) | Lower Leg Y, | Leg Y, Lower Leg Pitch, or | (824.6) |
| | Lower Leg | Rear Kick Axis, A₁₄ | |
| | Pitch, or Rear | | |
| | Kick Actuator | | |
| J15 | Foot Flex, Foot Y, | Foot Flex, Foot Y, Foot | N/A |
| (860) | Foot Pitch, or First | Pitch, or First Ankle Axis, | |
| | Ankle Actuator | A₁₅ | |
| J16 | Talus, Foot Roll, | Talus, Foot Roll, Foot X or | B₁₆ |
| (900) | Foot X or Second | Second Ankle Axis, A₁₆ | (904.6) |
| | Ankle Actuator | | |

### D. Actuators

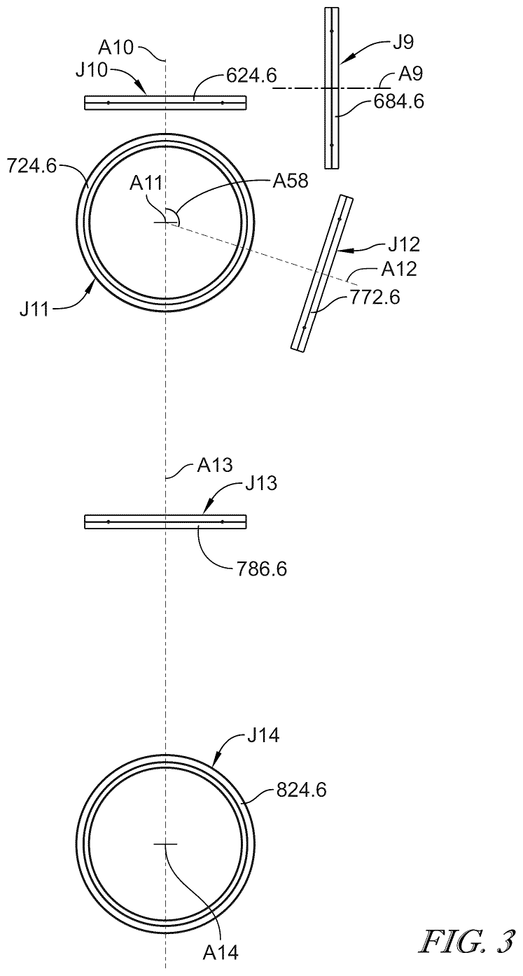

A plurality of actuators are arranged within and coupled to various housings of the robot 1 and are configured to move one or more parts of the robot 1. For illustrative purposes, the arrangement of actuators within the robot 1 is indicated by the actuator bearing (e.g., cross-roller bearing) of the individual rotational axes, as shown in FIG. 1. Further, the positions of the actuators contained in the central and lower portions of the robot are shown in FIGS. 2-3. In the illustrative embodiment, the cross-roller bearings shown are a component of the rotary actuators contained within the robot 1, where the cross-roller bearings are centered about a rotational axis of the individual actuators. Therefore, each rotational axis of the respective individual actuators extends in a direction perpendicular to a plane intersecting a mid-width of the actuator bearing.

In particular, the hip pitch actuator (J11) 720 is coupled to the pelvis 64. The upper thigh 76 is coupled to the hip pitch actuator (J11) 720 and includes: (i) the hip roll actuator (J12) 768 and (ii) the leg twist actuator (J13) 782. The lower thigh 80 is coupled to the leg twist actuator (J13) 782 and houses at least a portion of a knee actuator (J14) 820. The shin 84 is coupled to the knee actuator (J14) 820 and encloses said knee actuator (J14) 820. The shin 84 includes a foot flex actuator (J15) 860 housed in the shin housing 842 to control the pitch movement of the talus 88. Because the talus 88 directly interfaces with the foot 92, changing the pitch of the talus 88 corresponds to a change in the pitch of the foot 92. Additionally, the talus 88 contains a foot roll actuator (J16) 900 that controls the roll of the foot 92.

It should be noted that the leg actuators (J11-J16) may utilize a range and/or combination of advanced motor types, including brushless DC motors, stepper motors, servo motors, coreless DC motors, synchronous AC motors, asynchronous induction motors, linear motors, piezoelectric motors, direct-drive motors, switched reluctance motors, permanent magnet synchronous motors (PMSMs), axial flux motors, and hybrid stepper motors. These motors may employ rare-earth permanent magnets, such as neodymium-iron-boron (NdFeB) alloys, samarium-cobalt (SmCo) magnets, ferrite magnets, alnico magnets, flexible magnets, bonded rare-earth magnets, and high-temperature permanent magnets, to achieve high torque density and energy efficiency. Motor windings may include high-conductivity copper wire with advanced ceramic or polyimide insulation for superior thermal and electrical performance. The motors may be coupled with various high-reduction gear mechanisms designed for precision and load handling, such as strain wave gearboxes (e.g., Harmonic drives), cycloidal reducers, planetary gearboxes, bevel gear systems, worm gears, parallel shaft helical gear mechanisms, spur gear assemblies, crossed helical gear systems, double-enveloping worm gears, herringbone gears, hypoid gears, rack-and-pinion systems, bevel hypoid gears, epicyclic gear trains, and differential gear systems. Additionally, some implementations may incorporate custom gear profiles optimized for torque transfer efficiency, backlash reduction, and noise minimization. Further, said actuators may include brakes or clutches to protect the gearbox and/or to allow for power to be removed from the actuators without causing robot 1 to fall to the ground.

In applications where back drivability is useful, such as in the knee actuator (J14) 820, a direct-drive torque motor might be used in conjunction with a tendon-driven differential mechanism. The tendon system could be designed to achieve modest reduction ratios (e.g., 1:5 to 1:15) while maintaining high efficiency and low friction. For joints requiring extreme precision, like the head nod actuator (J8.2) 140, a closed-loop stepper motor system coupled with a micro-harmonic drive could be implemented. This configuration allows for micro-stepping capabilities and ultra-high reduction ratios (potentially exceeding 1:1000), enabling very fine angular adjustments. In scenarios where weight reduction is paramount, such as in distal joints like the wrist flex actuator (J6) 484, a flat or pancake-style brushless DC motor might be combined with a strain wave gearbox. This ultra-compact design could achieve reduction ratios from 1:50 to 1:160 while minimizing the added mass at the end of the arm assembly. For actuators that experience widely varying loads, like the hip pitch actuator (J11) 720, a variable transmission system could be employed. This might involve a continuously variable planetary (CVP) gearbox coupled with a high-torque AC servomotor. The CVP allows for dynamic adjustment of the reduction ratio (e.g., from 1:1.5 to 1:120) based on real-time load conditions, optimizing performance across different operating scenarios.

Additionally, to achieve exceptional positional accuracy and ensure reliable operation, each motor may be equipped with advanced encoders, which could be optical, magnetic, capacitive, inductive, resistive, piezoelectric, hall-effect, potentiometric, or ultrasonic. These encoders may facilitate sub-millimeter-level accuracy, critical for applications requiring meticulous movement control. To complement positional data, said actuator may include integrated torque sensors that have strain gauges, piezoresistive sensors, magnetoelastic sensors, capacitive sensors, fiber-optic sensors, or rotary transformers. Additionally, or alternatively, the actuators may include current sensors, such as Hall-effect sensors, shunt resistors, fluxgate sensors, Rogowski coils, or magnetoresistive sensors. Furthermore, the system may incorporate micro-electromechanical systems (MEMS) gyroscopes and/or accelerometers, which provide additional sensory data related to orientation, angular velocity, and linear acceleration. This sensory integration enhances the robot's ability to navigate complex environments and maintain stability during operation.

Further, the actuators or the output of the actuators may include bearing housings constructed using advanced materials like carbon-fiber-reinforced polymers (CFRPs), fiberglass-reinforced polymers (FRPs), metal alloys, polyetheretherketone (PEEK), thermoplastic composites, and ultra-high-molecular-weight polyethylene (UHMWPE). Additionally, the manufacturing processes for CFRPs, such as filament winding or automated fiber placement, allow for precise control over fiber orientation, further optimizing the mechanical performance of the housings. The bearings themselves can be fabricated from, include, or be processed using high-grade steel alloys (e.g., AISI 52100, M50, or 440C stainless steel), high-performance nickel-based superalloys (e.g., Inconel 718 or Hastelloy), cobalt-based alloys (e.g., Stellite), advanced ceramics (e.g., alumina or zirconia-based composites), and polymer matrix composites reinforced with carbon or aramid fibers. These materials may also benefit from advanced heat treatments (e.g., vacuum hardening or cryogenic treatment), surface engineering processes (e.g., ion implantation or physical vapor deposition), or specialized coatings.

To further optimize performance, the rolling elements of the bearings may be composed of advanced ceramic materials (e.g., silicon nitride, tungsten carbide, or zirconia), sapphire, or composite materials combining ceramic with metal or polymer matrices. In another embodiment, the assembly may incorporate cylindrical roller bearings, angular contact ball bearings, or hybrid bearings that combine steel races with ceramic rolling elements. Additionally, spherical roller bearings, tapered roller bearings, needle roller bearings, magnetic bearings, or hybrids or combinations thereof. Cutting-edge manufacturing techniques, including additive manufacturing methods like selective laser melting (SLM), could be employed to create complex bearing geometries. These geometries may integrate features such as internal cooling channels, lubrication reservoirs, or textured surfaces to enhance lubrication retention and minimize wear.

The incorporation of such features allows for improved thermal management, reduced friction, and consistent lubrication distribution, even under challenging operating conditions. Additive manufacturing also enables the production of customized bearing designs with minimal material waste, aligning with sustainable manufacturing practices. In addition to additive manufacturing, other advanced processes like precision machining, laser hardening, or chemical vapor deposition (CVD) coatings may be applied to enhance the surface properties of the bearings. These techniques can improve wear resistance, reduce friction, and provide protection against corrosion, further extending the operational life of the components. The integration of smart sensors within the bearing housing is another potential enhancement, allowing for real-time monitoring of parameters such as temperature, vibration, and load. This data can be used to predict maintenance needs and prevent unexpected failures, ensuring optimal performance and reliability.

### E. Central Region and Leg

The arrangement of actuators (J9-J13) 620, 680, 720, 768, 782 in the central portion 3 of the robot 1 may represent a biomechanical design that optimizes functionality, stability, and energy efficiency. These central portion actuators J9-J13 are similar to, but have higher torque than, the actuators included within the arm assemblies 5. Also, similar to the arm assemblies 5, the central portion 3 may be constructed from advanced materials to enhance mechanical properties, reduce weight, and improve durability. The torso lean actuator (J9) 680 may be positioned within the housing 642 of the pelvis 64, providing a stable base for torso movements. This positioning may allow for efficient force transmission and load distribution throughout the robot's structure. The output of the torso lean actuator (J9) 680 may be coupled to an extent of the spine 60, enabling precise control of the robot's lean or roll motion. The torso twist actuator (J10) 620 may be located within the robot's waist/spine 60, at a junction between the upper and lower body. The output adaptor of the torso twist actuator (J10) 620 may interface directly with an extent of the pelvis 64, facilitating rotational movement of the torso 16 relative to the lower body. The waist/spine 60 itself may be coupled to a lower extent of the torso 16, creating a continuous kinematic chain from the pelvis 64 to the upper body.

The spatial arrangement of the torso lean actuator (J9) 680 and the torso twist actuator (J10) 620 may be engineered to maximize the robot's range of motion while maintaining structural integrity. Both actuators may be substantially centered along the sagittal plane of the robot 1, ensuring balanced force distribution and symmetrical movement capabilities. This centering may be important for maintaining the robot's stability during complex maneuvers and for preventing undesired torques that could compromise balance or efficiency. Variations of this design could include: (i) offsetting the actuators slightly from the sagittal plane to introduce asymmetrical capabilities, (ii) integrating active stabilization mechanisms, such as gyroscopic systems or dynamically adjustable counterweights, and/or (iii) a compliant actuator system with integrated spring-damping elements could provide passive shock absorption and energy recovery, improving the robot's efficiency during dynamic operations.

The two degrees of freedom (2-DoF) for the torso 16 (roll and yaw) provided by the torso lean actuator (J9) 680 and the torso twist actuator (J10) 620 may enhance the robot's operational versatility. This configuration may allow robot 1 to pivot its body to pick up items positioned at extreme angles, such as 90 degrees to its side, without the need for full body rotation. Additionally, it may enable the robot to lean over obstacles, expanding its reach and workspace. These capabilities may be valuable in dynamic environments where the robot must interact with objects in various positions relative to its body. Variations of this setup could include: (i) integrating additional degrees of freedom, (ii) using a gimbal-like mechanism to replace the torso lean actuator (J9) 680 and the torso twist actuator (J10) 620, (iii) using sealed actuators with advanced thermal management systems, and/or (iv) using modular actuator designs.

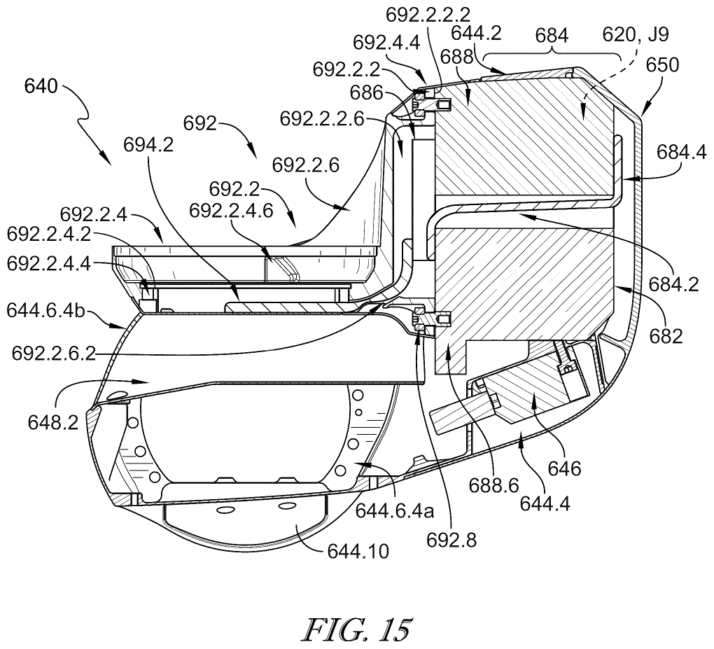

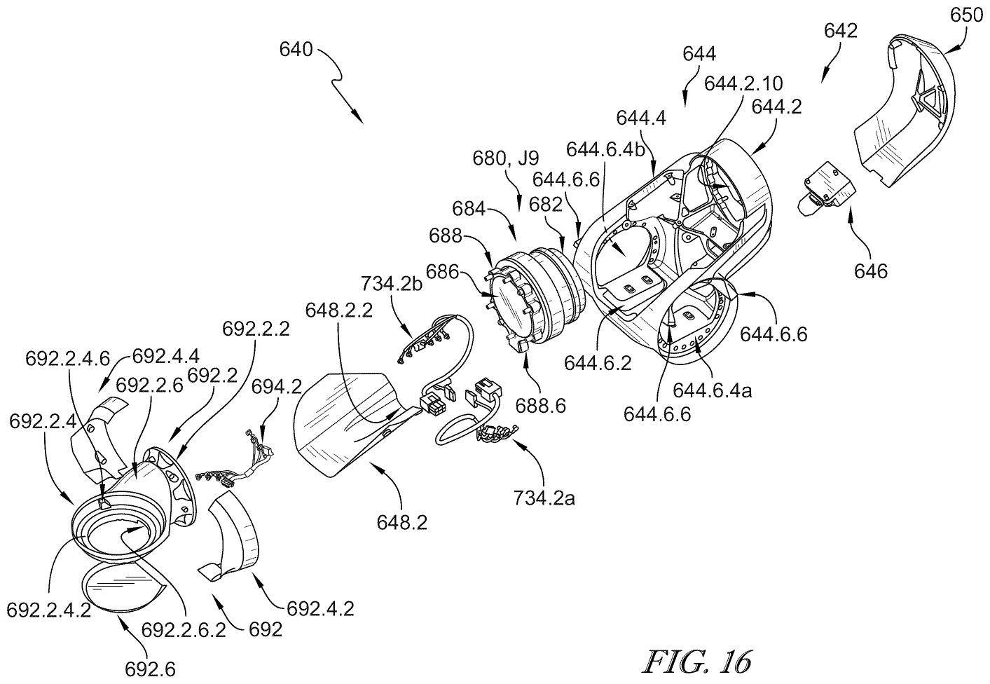

As illustrated in FIGS. 15-16, the torso lean axis A₉ may be parallel with the transverse plane P_{T}, positioned within the sagittal plane P_{S}, and perpendicular to the coronal plane P_{C}. This orientation may allow for smooth lateral bending of the torso. Conversely, the torso twist axis A₁₀ may be parallel with the coronal plane P_{C}, positioned within the sagittal plane P_{S}, and perpendicular to the transverse plane P_{T}, facilitating twisting of the torso. The perpendicular relationship between the torso lean axis A₉ and the torso twist axis A₁₀ may ensure independent control of yaw and roll motions, minimizing mechanical interference and simplifying control algorithms. In other embodiments, the interior spine angle may be formed between the torso lean axis A₉ and the torso twist axis A₁₀, wherein said spine angle is greater than 45 degrees and less than 135 degrees when the robot is in the neutral position. In other words, a spine angle may be formed between the torso twist axis and the torso lean axis, wherein said spine angle may be acute or may be obtuse. Variations or alternatives could include: (i) designing torso lean axis A₉ and torso twist axis A₁₀ with adjustable axes to provide customizable ranges of motion, and/or (ii) replacing the actuators with spherical joints driven by multi-axis actuators.

The spatial offset between the torso lean actuator (J9) 680 and the torso twist actuator (J10) 620 may be a design feature that optimizes the robot's structure and functionality. The center of the actuator bearing 624.6 of the torso twist actuator (J10) 620 may be offset downward along the Z-axis from the center of the actuator bearing 684.6 of the torso lean actuator (J9) 680 by a distance ranging from about 5 mm to 10 mm, representing 10% to 20% of the radius of the actuator bearing 684.6 of the torso lean actuator (J9) 680. This offset may allow for a more compact design of the waist while maintaining the necessary range of motion for both actuators. Variations or alternatives to this design could include: (i) introducing dynamically adjustable offsets using linear actuators or telescoping mechanisms, (ii) utilizing rotary dampers or friction-based locking systems within the offset assembly, (iii) including compliant elements such as elastomeric couplings, and/or (iv) using magnetic or fluid-based bearings could replace traditional actuator bearings, offering smoother motion and reduced wear.

Furthermore, the center of the actuator bearing 684.6 of the torso lean actuator (J9) 680 may be offset rearward along the X-axis from the center of the actuator bearing 724.6 of the hip pitch actuator (J11) 720 by a distance of at least 50 mm and preferably between 80 mm and 120 mm, equivalent to 80% to 120% of the diameter of the actuator bearing 684.6 of the torso lean actuator (J9) 680. This rearward offset may allow robot 1 to maintain its center of gravity within a stable range during forward-leaning motions. These carefully calculated offsets may result in the upper extents of the torso lean actuator (J9) 680 and the torso twist actuator (J10) 620 being substantially parallel to one another. This parallel configuration may be advantageous as it reduces the space required for spine roll and yaw movements, allowing for a more compact design of the central portion 3. The reduced space requirement in the waist may directly translate to an increased volume in the torso 16, which can be utilized for larger battery capacity and enhanced computing capabilities, such as additional GPUs. In some embodiments, the torso lean axis A₉ may be angled with respect to the transverse plane P_{T} and may range between 1 and 45 degrees, preferably between 5 and 25 degrees, or more specifically between 10 and 20 degrees.

The design of robot 1 may incorporate an approach to torso articulation that deviates from conventional humanoid robot architectures. Specifically, robot 1 may lack a dedicated spine pitch actuator, a design choice that may yield advantages in terms of internal volume and power capacity. By eliminating this actuator, the volume within the torso 16 may be substantially increased, potentially by over 270%, from approximately 7 liters to over 19 liters. This expanded internal space may allow for the integration of larger power and computing systems, which may be beneficial for enhancing the robot's operational capabilities and autonomy.

To further leverage the available internal volume, alternative configurations could incorporate modular battery packs that allow for hot-swapping during extended operations, ensuring near-continuous uptime. The design could also accommodate advanced energy storage technologies, such as solid-state batteries or supercapacitors, which provide higher energy densities and faster charging times. Additional variations might include segmented internal compartments for electromagnetic shielding, preventing interference between power systems and sensitive electronics. These adaptations may provide a scalable framework for enhancing the robot's capabilities while maintaining its overall efficiency and robustness.

While the omission of a dedicated spine pitch actuator may present certain limitations in terms of torso flexion, the robot 1 may compensate for this through an innovative use of its hip pitch actuators (J11) 720. By coordinating the rotation of the hip pitch actuators (J11) 720 in the left and right hips 70, the robot 1 may achieve forward bending motions that approximate the functionality typically provided by a spine pitch actuator. This approach may represent a solution to maintaining forward bending capabilities while optimizing internal space utilization. The hip pitch actuator (J11) 720 may be designed with enhanced torque and range of motion capabilities to accommodate this dual functionality. For instance, the hip pitch actuator (J11) 720 may utilize any motor, gearbox, sensors, bearings, encoders, and/or other components or parts that are discussed in the actuators section, optimized for these hip movements. In an alternative embodiment, the pelvis 64 may include integrated elastic elements or compliant mechanisms into the hip assemblies to provide passive assistance during bending motions, reducing energy consumption. For environments requiring high durability, sealed bearing assemblies with integrated thermal management systems could ensure reliable operation under harsh conditions.

The structural configuration of the hip pitch actuator (J11) 720 ensures optimized force transmission and enhanced stability. The direct coupling of the output adaptor of the hip pitch actuator (J11) 720 to both sides of the pelvis 64 forms a robust mechanical interface, effectively minimizing unnecessary motion loss and ensuring efficient torque transmission to the pelvis 64 and lower limbs or leg 6. By positioning the hip pitch axis A₁₁ orthogonally to both the torso lean axis A₉ and the torso twist axis A₁₀, the design achieves an optimized distribution of forces and moments within the central portion of the robot. This orthogonal relationship allows independent and precise control of hip flexion/extension, spine yaw, and roll, mimicking the biomechanics of the human pelvis. In some embodiments, the hip pitch axis A₁₁ may be angled with respect to the transverse plane P_{T} and may range between 1 and 45 degrees, preferably between 5 and 25 degrees, or more specifically between 10 and 20 degrees.

In an alternative embodiment, an output adaptor of the hip pitch actuator (J11) 720 could be replaced with a flexible or semi-flexible joint to introduce compliance that absorbs and dissipates external shocks during motion. Further, the robot 1 may include modular coupling systems allowing the pelvis 64 to be easily replaced or reconfigured. The orthogonal arrangement of hip pitch axis A₁₁ with respect to torso lean axis A₉ and torso twist axis A₁₀ could also be adjusted to a skewed or angled configuration to address unconventional load paths or specialized tasks, such as navigating uneven terrain or executing non-linear movements. These modifications could integrate compliant or actively adjustable mechanisms to enable real-time reorientation of hip pitch axis A₁₁ based on sensor feedback, optimizing the system's adaptability to dynamic environments. Further enhancements might include shock-dampening elements embedded within the adaptor assembly to mitigate wear and extend operational longevity. For example, these could include non-linear or helical geometries to simulate distinct gaits or stances.

The deliberate offset of hip pitch axis A₁₁ along the Z-axis by over 30 mm, and preferably over 70 mm, increases the moment arm for hip movements, thereby reducing the torque requirements for the actuator during certain operations while aligning the design with human anatomical structures to enable natural, human-like motion with an expanded range of movement. Variations of this configuration could involve modifying the offset to less than 70 mm. Adjustable mechanisms, such as telescoping mounts or modular inserts, could be implemented to allow real-time customization for specific tasks. Further derivatives may include dynamic axis repositioning, facilitated by actuated linkages or compliant mechanisms, to adapt the Z-axis offset dynamically during operation, optimizing the balance between high-torque and high-speed movements. Enhanced structural integration through the use of flexible composite joints or vibration-damping materials could also be introduced to improve movement precision and durability while mitigating wear during extended operation, ensuring the offset configuration remains versatile and beneficial across a wide range of humanoid robotic applications.

The alignment of hip pitch axis A₁₁ with torso twist axis A₁₀ in the coronal plane P_{C} is a feature contributing to the robot's ability to maintain balance and perform complex locomotion tasks. This configuration ensures consistency of the hip flexion/extension axis relative to the spine's yaw axis, facilitating intuitive control algorithms and simplifying the inverse kinematics calculations required for precise leg movements. The co-planar relationship between a hip pitch axis A₁₁ and a torso twist axis A₁₀ via a vertical plane parallel to the coronal plane is particularly noteworthy, allowing synchronized movements between hip flexion/extension and spine yaw. This enables fluid, human-like motions, such as turning while walking or reaching across the body, and enhances energy efficiency during locomotion by enabling more natural weight transfer between legs. As an alternative, the alignment of hip pitch axis A₁₁ could be adjusted to accommodate non-human gait patterns or specialized locomotion tasks, such as asymmetric axis alignment to support uneven terrain navigation. Such adjustments could utilize actuated mechanisms or compliant linkages driven by integrated sensor systems to maintain balance and optimize force distribution.

The direct coupling of the hip pitch actuator (J11) 720 to the pelvis 64, positioning it closer to the torso lean actuator (J9) 680 and the torso twist actuator (J10) 620 than other actuators, represents an unconventional approach offering several advantages. This compact configuration lowers the robot's center of gravity, enhances stability, and simplifies the mechanical design of the hip joint, improving reliability and reducing manufacturing complexity. The configuration of the hip roll actuator (J12) 768 in relation to the hip pitch actuator (J11) 720 and the pelvis 64 represents an advancement in humanoid robot kinematics. This arrangement, wherein the output adaptor 778 of the hip roll actuator (J12) 768 is coupled to an extent of the housing of the hip pitch actuator (J11) 720, creates an angular relationship (i.e., hip angle or angle gamma) between the hip roll axis A₁₂ and the transverse plane P_{T}. In other words, the hip roll axis A₁₂ is angled relative to a reference plane that contains the hip pitch axis A₁₁. Said reference plane contains the hip pitch axis A₁₁ and is parallel with the transverse plane P_{T} when the robot 1 is in the neutral position. The angle between said reference plane and the hip roll axis A₁₂ is a hip angle or angle gamma. Said hip angle or angle gamma is a non-90-degree angle. Stated another way, a non-90 degree angle is formed between said reference plane and the hip roll axis A₁₂. Specifically, the non-90 degree angle, hip angle, or angle gamma may range between 1 and 45 degrees, preferably between 5 and 25 degrees, or more specifically between 10 and 20 degrees. As such, the hip angle or angle gamma that is formed between the reference plane and the hip roll axis A₁₂, wherein said hip angle or angle gamma is a non-90 degree angle, may be an acute angle that is between 1 and 45 degrees, preferably between 5 and 25 degrees, or more specifically between 10 and 20 degrees. Stated in a further way, the reference plane and the hip roll axis A₁₂ are angled relative to one another, and wherein said angle may be an acute angle that is between 1 and 45 degrees, preferably between 5 and 25 degrees, or more specifically between 10 and 20 degrees. Further, the hip roll axis A₁₂ is oriented at a hip angle relative to a reference plane that contains the hip pitch axis A₁₁ and is parallel with the transverse plane P_{T}, and wherein said hip angle is an acute angle that is between 1 and 45 degrees, preferably between 5 and 25 degrees, or more specifically between 10 and 20 degrees. Finally, a non-90-degree angle is formed between said hip roll axis and said reference plane that is parallel with the transverse plane P_{T}, and wherein said non-90-degree angle is between 1 and 45 degrees, preferably between 5 and 25 degrees, or more specifically between 10 and 20 degrees.

This is a design feature that enhances the robot's overall range of motion and functionality. This angled configuration (i.e., hip angle or angle gamma) of the hip roll axis A₁₂ relative to the transverse plane P_{T} offers several biomechanical advantages. Primarily, it allows for an increased range of motion in the hip Y or hip pitch direction. This expanded mobility is particularly beneficial in enabling the robot 1 to perform deep squats, facilitating easier transitions from a prone position to standing, and compensating for the absence of a dedicated spine pitch or spine Y actuator. The ability to achieve these complex movements is useful for a humanoid robot designed to operate in diverse environments and perform a wide array of tasks. Additionally, the leg twist axis A₁₃ and the torso twist axis A₁₀ are arranged substantially parallel with one another when the humanoid robot is in a neutral position. Further, the leg twist axis A₁₃ is coplanar with the hip pitch axis A₁₁ when the humanoid robot is in the neutral position. Finally, the torso twist axis A₁₀ is coplanar with the coronal plane of the humanoid robot.

In alternative embodiments, the coupling mechanism between the hip roll actuator (J12) 768 and the hip pitch actuator (J11) 720 may incorporate a spherical joint, a custom-designed universal joint, or a semi-compliant pivot assembly to accommodate the angular offset while allowing for smooth, multi-axis motion. This joint could employ advanced bearing technologies, such as ceramic hybrid bearings, diamond-like carbon (DLC) coated surfaces, or polymer-based tribological coatings to reduce friction and wear under high loads and frequent articulation. Furthermore, the angular range of the hip roll axis A₁₂ could be dynamically adjustable through actuated linkages, compliant mechanisms, or shape-adaptive structures that leverage integrated micro-actuators. These features would enable the robot to optimize its posture and movement for specific tasks, such as crawling, climbing, or navigating constrained spaces. Variations may also include modular configurations, where the hip roll actuator (J12) 768 can be reoriented, adjusted in length, or swapped with alternative actuators. Additionally, the integration of smart materials, such as shape memory alloys or magnetorheological elastomers, could further enhance the adaptability and functionality of the hip roll actuator (J12) 768 by allowing it to self-adjust based on load conditions or dynamic interactions with the environment. Advanced iterations might incorporate active damping mechanisms or energy recovery systems to improve efficiency and extend operational life under continuous high-stress movements.

The configuration of the hip roll actuator (J12) 768 within the robot 1 represents a departure from conventional humanoid robot designs, offering benefits in terms of range of motion, structural integrity, and overall functionality. As highlighted, the hip roll axis A₁₂ of the hip roll actuator (J12) 768 is not parallel or perpendicular to any other axis within the robot's kinematic chain. This non-orthogonal arrangement creates a complex but highly versatile joint configuration that enhances the robot's mobility and adaptability. Additional alternatives to this configuration could include introducing a hybrid mechanism combining rotational and translational degrees of freedom to further expand the versatility of the hip roll actuator (J12) 768. For example, a prismatic joint integrated along the hip roll axis A₁₂ could provide linear movement, enabling the robot to extend or retract its leg laterally for tasks requiring wide stances or precise positioning. Another variation might incorporate a cam-based system within the coupling mechanism to dynamically modify the angular orientation of the hip roll axis A₁₂ in real time, optimizing the actuator's range for specific tasks or environments. Further, a dual-axis actuator system could be employed, where the hip roll actuator (J12) 768 is coupled to a secondary actuator providing supplementary rotational or oscillatory motion, enhancing the robot's agility and ability to perform complex maneuvers.

A vertical plane containing the hip roll axis A₁₂ is perpendicular to a horizontal plane containing the hip pitch axis A₁₁, where the hip pitch axis A₁₁ represents the axis of another actuator, potentially the hip pitch actuator (J11) 720 or the leg twist actuator (J13) 782. This geometric arrangement allows for a clear delineation of functions between the hip pitch actuator (J11) 720, which provides hip/leg pitch, and the hip roll actuator (J12) 768, which provides hip/leg roll. To expand upon this design, alternative configurations could involve non-perpendicular alignments between these planes to introduce controlled coupling effects, enabling coordinated motions for complex tasks such as twisting while pitching. Another variation might include integrating a secondary, adjustable joint along the hip roll axis A₁₂ to allow dynamic modulation of its spatial orientation relative to the hip pitch axis A₁₁, offering greater adaptability for varied terrains or task-specific requirements. Additionally, the use of compliant mechanisms or elastomeric connectors in the coupling of the hip roll actuator (J12) 768 to other actuators could enhance energy absorption during rapid movements, reducing stress on structural components and improving durability in high-load scenarios.

As shown in the Figures, the hip roll actuator (J12) 768 is not directly connected to the pelvis 64. Stated another way, the robot lacks a structure that directly couples the hip roll actuator (J12) 768 to the pelvis 64 or spine twist actuator (J10) 620. Instead, it is directly coupled to the hip pitch actuator (J11) 720. This configuration allows the hip roll actuator (J12) 768 to be angled relative to both the hip pitch actuator (J11) 720 and the pelvis 64, creating a unique kinematic chain that enhances the robot's range of motion and load-bearing capabilities. These alternatives further diversify the functional capabilities of the hip roll actuator (J12) 768 configuration, broadening its applicability across various robotic applications. Additionally, the angled positioning of the hip roll actuator (J12) 768 may be achieved through a specialized coupling mechanism, potentially incorporating a universal joint, a ball-and-socket joint, or a custom-designed interface that accommodates the non-orthogonal alignment while allowing smooth multi-axis motion. Alternative approaches could include a compliant linkage system, integrating elastomeric joints or flexure-based designs to absorb and redistribute dynamic loads, enhancing durability and range of motion.

Also, the center of the actuator bearing 772.6 of the hip roll actuator (J12) 768 is located below, or closer to the support surface than, the actuator bearing centers of (J9) 680, (J10) 620, and (J11) 720. This lower positioning of the hip roll actuator (J12) 768 creates a unique load path through the robot's structure, placing the main stresses for supporting the robot on an angled link that is not co-linear with other axes in the leg or hip. The angled configuration of the hip roll actuator (J12) 768 also has implications for the robot's overall balance and stability. By positioning the hip roll actuator (J12) 768 lower in the kinematic chain, the robot's center of mass during lateral movements may be more stable, potentially improving balance during single-leg support phases or when subjected to lateral forces. This configuration may allow for more human-like gait patterns and enhanced agility in multi-directional movements. Potential modifications to this design could involve an actively adjustable mounting system for the hip roll actuator (J12) 768, utilizing linear actuators or stepper-controlled pivots to dynamically adjust the axis orientation, further optimizing the robot's performance in complex environments or under varied load conditions.

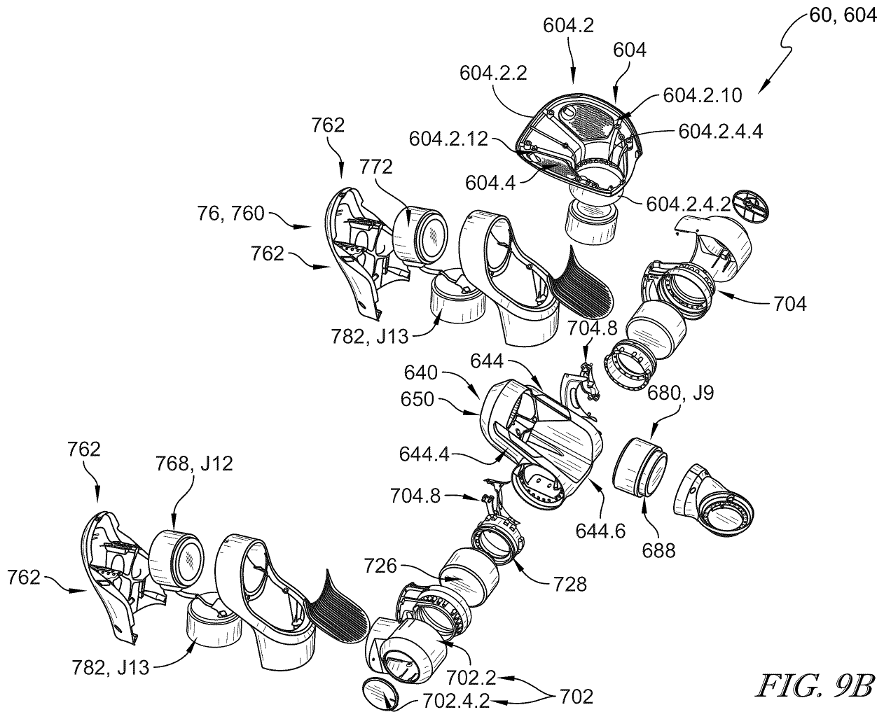

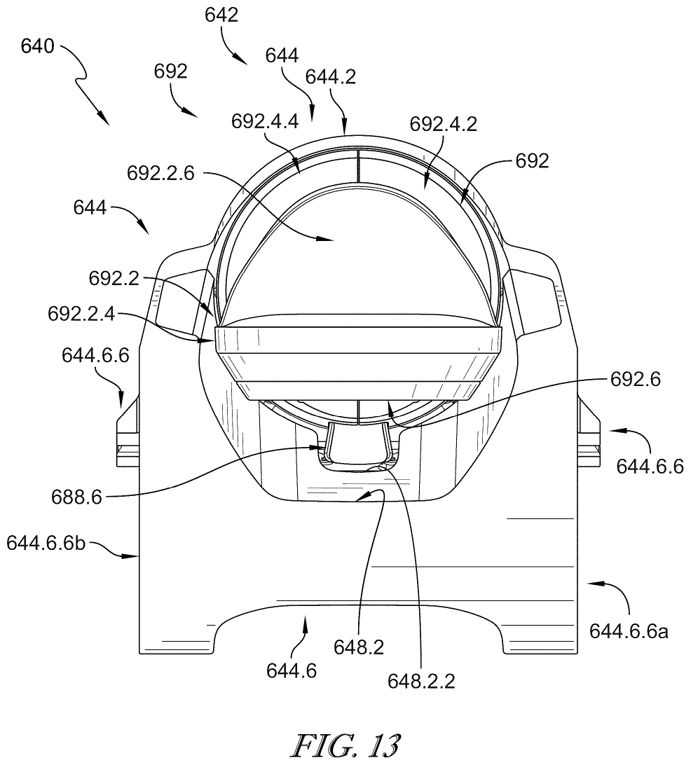

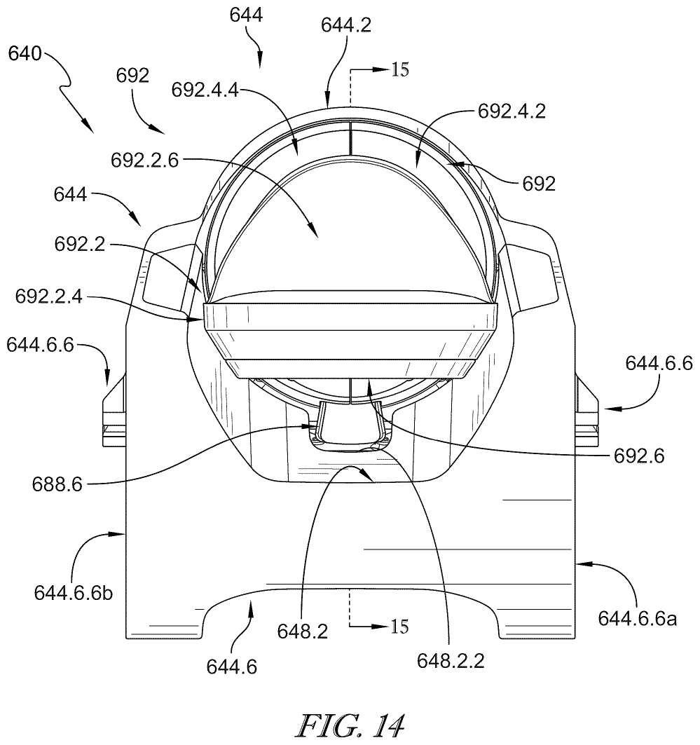

Still referring to FIGS. 8-10 and 13-14, the leg twist actuator (J13) 782 may be positioned near the hip roll actuator (J12) 768 within the hip housing 762, and its output adaptor 790 may be coupled to an extent of the lower thigh 80. Leg twist actuator (J13) 782 provides the robot 1 with leg yaw or leg twist, and its leg twist axis A₁₃ may be parallel with the torso twist axis A₁₀ of the torso twist actuator (J10) 620 and may be positioned perpendicular to the hip pitch axis A₁₁ of the hip pitch actuator (J11) 720. This placement allows axes A₁₀, A₁₁, and A₁₃ to be positioned in a single vertical plane or a plane parallel with the coronal plane P_{C}. This placement helps ensure that the weight of the robot 1 is supported by the hips/legs when robot 1 is at rest. The actuator bearings 624.6 associated with the torso twist actuator (J10) 620 could be positioned in the location of the actuator bearing 786.6 of the leg twist actuator (J13) 782 by translating the actuator bearing 624.6 by approximately 250 mm in the downward Z direction and translating in the Y direction to either one of the legs that contains the leg twist actuator (J13) 782.

The configuration of the hip roll actuator (J12) 768 within the robot 1 represents a departure from conventional humanoid robot designs, offering benefits in terms of range of motion, structural integrity, and overall functionality. As highlighted, the hip roll axis A₁₂ of the hip roll actuator (J12) 768 is not parallel or perpendicular to any other axis within the robot's kinematic chain. This non-orthogonal arrangement creates a complex but highly versatile joint configuration that enhances the robot's mobility and adaptability. Additional alternatives to this configuration could include introducing a hybrid mechanism combining rotational and translational degrees of freedom to further expand the versatility of the hip roll actuator (J12) 768. For example, a prismatic joint integrated along the hip roll axis A₁₂ could provide linear movement, enabling the robot to extend or retract its leg laterally for tasks requiring wide stances or precise positioning. Another variation might incorporate a cam-based system within the coupling mechanism to dynamically modify the angular orientation of the hip roll axis A₁₂ in real time, optimizing the actuator's range for specific tasks or environments. Further, a dual-axis actuator system could be employed, where the hip roll actuator (J12) 768 is coupled to a secondary actuator providing supplementary rotational or oscillatory motion, enhancing the robot's agility and ability to perform complex maneuvers.

A vertical plane containing the hip roll axis A₁₂ is perpendicular to a horizontal plane containing the hip pitch axis A₁₁, where the hip pitch axis A₁₁ represents the axis of another actuator, potentially the hip pitch actuator (J11) 720 or the leg twist actuator (J13) 782. This geometric arrangement allows for a clear delineation of functions between the hip pitch actuator (J11) 720, which provides hip/leg pitch, and the hip roll actuator (J12) 768, which provides hip/leg roll. To expand upon this design, alternative configurations could involve non-perpendicular alignments between these planes to introduce controlled coupling effects, enabling coordinated motions for complex tasks such as twisting while pitching. Another variation might include integrating a secondary, adjustable joint along the hip roll axis A₁₂ to allow dynamic modulation of its spatial orientation relative to the hip pitch axis A₁₁, offering greater adaptability for varied terrains or task-specific requirements. Additionally, the use of compliant mechanisms or elastomeric connectors in the coupling of the hip roll actuator (J12) 768 to other actuators could enhance energy absorption during rapid movements, reducing stress on structural components and improving durability in high-load scenarios. These alternatives further diversify the functional capabilities of the hip roll actuator (J12) 768 configuration, broadening its applicability across various robotic applications.

As shown in FIGS. 8-10 and 15-16, a knee actuator (J14) 820 may be housed in the lower thigh 80 and provides bending motion to the leg. Unlike other conventional robots, the knee actuator (J14) 820 may not be a linear actuator and may not be driven by a linkage. Instead, said knee actuator may be a rotary actuator that is coupled to the housings associated with the lower thigh 80 and the shin 84. As shown in FIG. 55, the actuator bearing 824.6 for the knee actuator (J14) 820 contained in both legs may be positioned on the left side of vertical planes that are parallel with the sagittal plane and aligned with the leg twist axis A₁₃. This is unlike the position of all other actuator bearings contained within the robot 1, as said actuator bearing 824.6 of the knee actuator (J14) 820 may not be in a mirrored location across the robot's sagittal plane P_{S}. This may be beneficial because it allows the lower thigh 80 and shin 84 to be identical to one another, which reduces manufacturing cost, unique parts, etc.

Finally, a foot flex actuator (J15) 860 may be housed in the shin and includes a ball screw linear actuator for pitch movement of the foot 92, and a foot roll actuator (J16) 900 may be housed within the talus 88 to allow a rolling motion of the foot. Placing the foot roll actuator (J16) 900 in the foot may be an uncommon solution because it increases the torque requirements for other actuators contained in the leg 6—namely, actuators (J11-J14) 720, 768, 782, 820. Unlike conventional coupling of linear and rotary actuators, the housing of the foot roll actuator (J16) 900 may be designed to be directly coupled to the output of the foot flex actuator (J15) 860.

To further mimic human-like movement capabilities, the leg 6 may incorporate passive dynamic elements. For instance, spring-loaded mechanisms in the ankle or knee joints may store and release energy during the gait cycle, potentially improving efficiency and providing a more natural walking motion. These passive elements may work in conjunction with the active actuators to create a hybrid system that combines the benefits of both active control and passive dynamics. In some implementations, the leg 6 may include active cooling systems to manage heat generated by the actuators during prolonged or high-intensity operations. This may involve the integration of heat sinks, fluid cooling channels, or thermoelectric devices to dissipate heat efficiently and maintain optimal operating temperatures for the electronic and mechanical components.

### F. Kinematics

As shown in the figures, the hip pitch actuator (J11) 720 can move the leg forward and backward relative to the robot's torso and/or coronal plane, while the hip roll actuator (J12) 768 can move the leg 6 left/right or sideways relative to the robot's torso 16 or in the coronal plane P_{C}. The leg twist actuator (J13) 782 can rotate the leg relative to the robot's torso 16, while the knee actuator (J14) 820 can bend the knee or leg of the robot 1. Moreover, the torso lean actuator (J9) 680 can allow the torso 16 of the robot to lean to its left or right relative to its feet 92, and the torso twist actuator (J10) 620 can allow the torso 16 of the robot to rotate or twist relative to its feet 92.

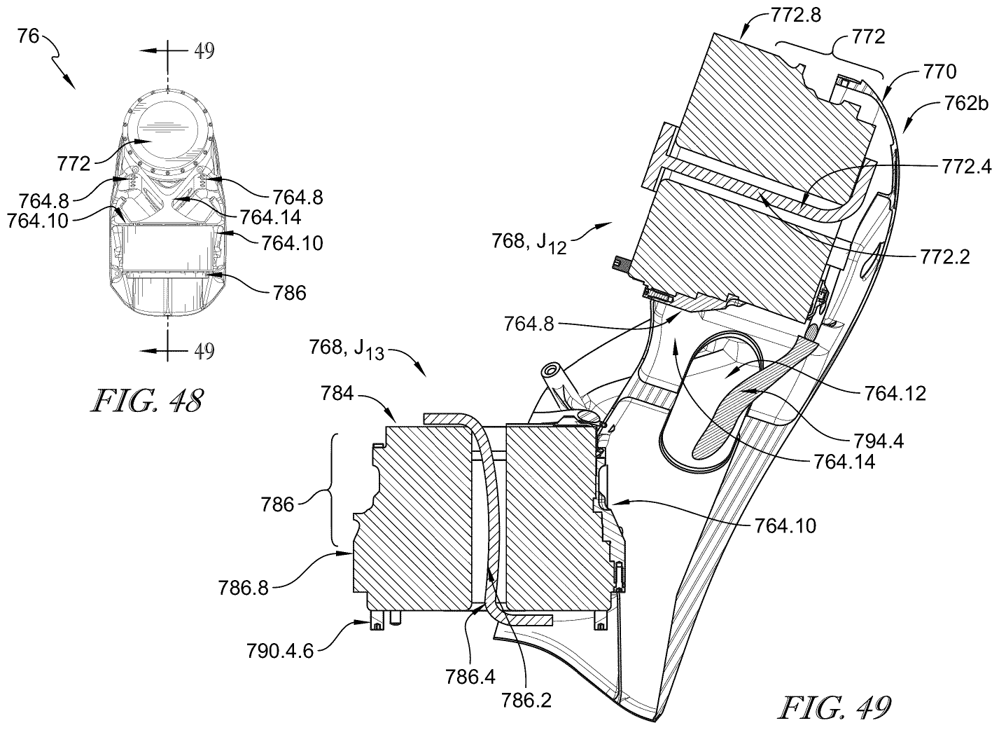

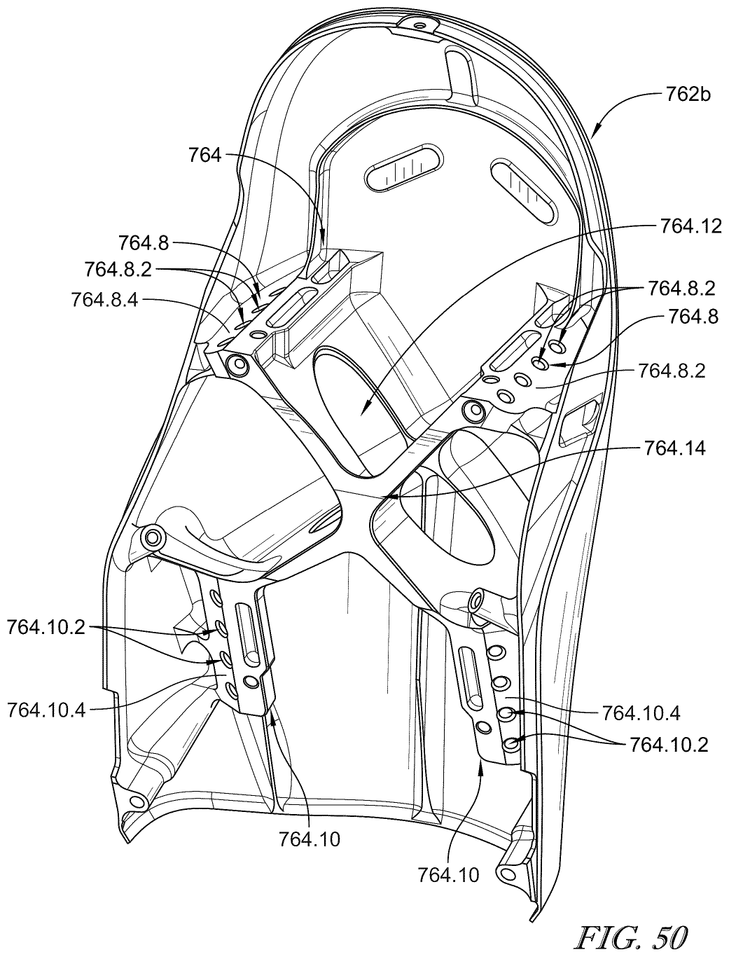

FIGS. 48-50 show the hip assembly in the central portion of the robot 1, where the left and right legs 6 extend from the pelvis 64. The hip pitch actuator (J11) 720, the hip roll actuator (J12) 768, and the leg twist actuator (J13) respectively provide the leg with axes of rotation A₁₁, A₁₂, and A₁₃ for Y-axis (pitch), X-axis (roll), and Z-axis (yaw or twist) at the hip and upper leg assembly 6.1. The leg twist actuators (J13) are located below the hip pitch actuator (J11) 720 and the hip roll actuator (J12) 768 and provide yaw motion for the legs 6. The hip roll actuators (J12) 768 are located below the hip pitch actuators (J11) 720 and provide roll motion for the legs 6. The hip pitch actuators (J11) 720 provide pitch motion for the legs 6, and they are located above the hip roll actuators (J12) 768 and the leg twist actuators (J13). Although the hip roll actuator (J12) 768 is identified as providing roll motion about the X-axis, it should be noted that the hip roll axis A₁₂ of the hip roll actuator (J12) 768 is not parallel to the X-axis or orthogonal to axes A₁₁ and A₁₃. In robot 1, the hip roll axis A₁₂ of the hip roll actuator (J12) 768 is angled with respect to the transverse plane P_{T} by a hip angle, or angle gamma, as shown in FIGS. 50 and 52.

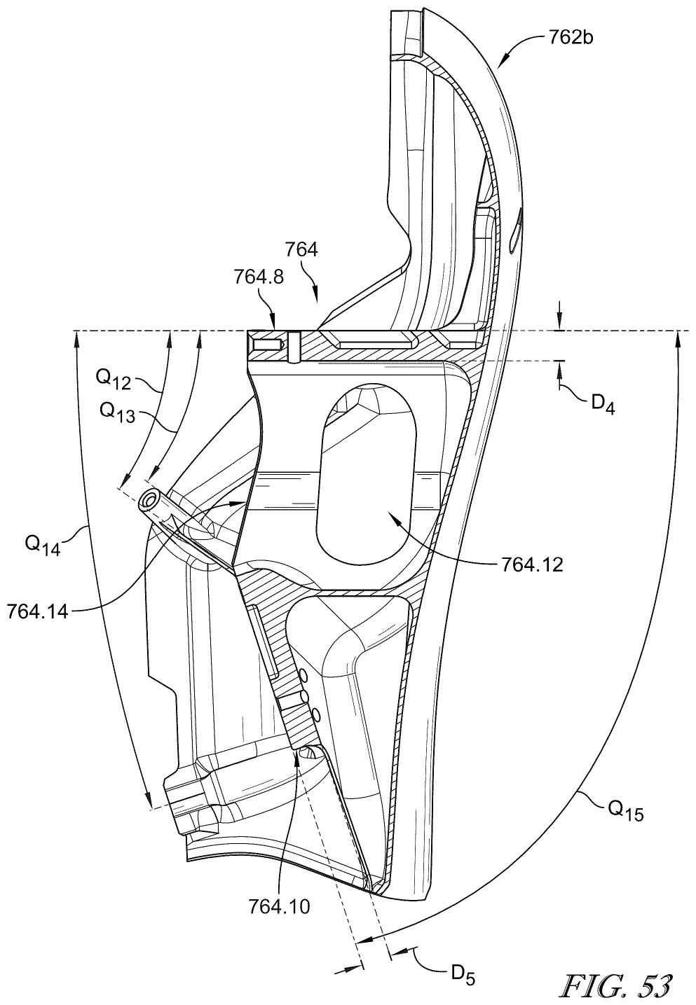

In robot 1, the left and right legs 6 are interchangeable, further reducing the number of unique parts. The kinematic chain for each leg 6 is shown in FIG. 53. This hip assembly design, having the Y-axis hip pitch actuator (J11) 720, a middle X-axis hip roll actuator (J12) 768, and a lower Z-axis leg twist actuator (J13), can offer benefits. For example, having the hip pitch actuator (J11) 720 in the robot's pelvic structure can be beneficial because this can be the actuator that is most used for the forward walking movements of the robot 1. On the other hand, the inertia of the pitch movements of the leg can be increased because the mass of both the hip roll actuator (J12) 768, and the leg twist actuator (J13) moves when the robot 1 walks. Having the actuators high up in the legs, however, can minimize the effects of the increased inertia for movement in the Y-axis degree of freedom (DOF) for pitch movements of the legs during walking and running.

a. Leg Pitch

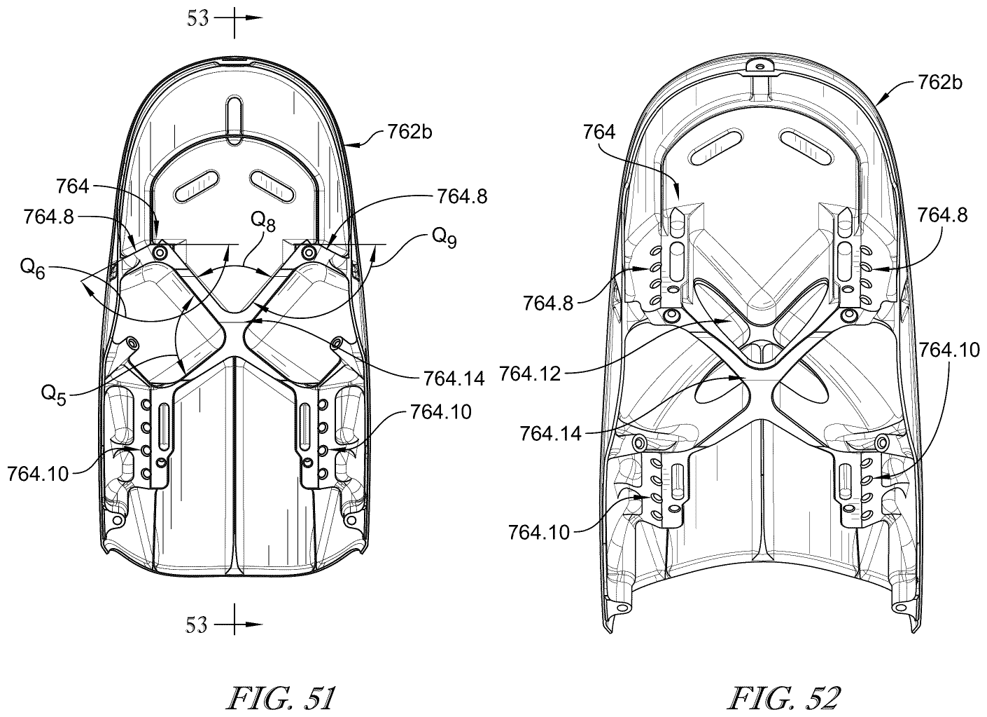

FIGS. 58-61 illustrate the robot 1 of FIG. 51 in various leg movement positions extending anteriorly and posteriorly to illustrate the range of motion of the hip pitch actuator (J11) 720. In these examples, the other leg actuators (J12-J16) in the leg assembly 6 do not apply any torque. For reference, when the robot 1 is in the neutral position, a leg reference axis R_{J11} is defined as a vertical axis extending downward from the hip pitch axis A₁₁ of the hip pitch actuator (J11) to the knee axis of rotation A₁₄ of the knee actuator (J14) 820 and is co-planar with a leg reference plane that is parallel to the sagittal plane (P_{S}). The leg reference plane includes the hip roll axis A₁₂ of the hip roll actuator (J12) 768 in the neutral position.

The hip pitch actuator (J11) 720 controls the movement of the respective leg 6 forward and backward, i.e., leg pitch movement. Note that, in some embodiments, a maximum anterior advancement or extension of the robot leg using the hip pitch actuator (J11) 720 can be about 160 degrees relative to the coronal plane P_{C}, but this can require simultaneous movement of the leg laterally outward by about 20 degrees using the hip roll actuator (J12) 768 to avoid interference between the leg and the torso 16. This concept of achieving greater extension of a leg about the hips by utilizing simultaneous laterally outward movement of the leg is similar to how humans move, e.g., when performing a deep squat.

b. Leg Flexion

The hip pitch actuator (J11) 720 can allow the robot to move its leg: (i) backward between about 5 degrees and about 55 degrees, preferably between about 25 and about 45 degrees, and most preferably between about 30 and about 40 degrees, and (ii) forward between about 25 and about 210 degrees, preferably between about 80 and about 190 degrees, and most preferably between about 145 and about 175 degrees. In other words, the hip pitch actuator (J11) 720 can move the leg backward at least about 5 degrees, preferably at least about 25 degrees, and most preferably at least about 30 degrees. Likewise, the hip pitch actuator (J11) 720 can move the leg forward at least about 25 degrees, preferably at least about 80 degrees, and most preferably at least about 145 degrees. Thus, the hip pitch actuator (J11) 720 can have a range of motion that is at least about 30 degrees, preferably at least about 105 degrees, and most preferably at least about 175 degrees. In some embodiments, the hip pitch actuator (J11) 720 can have a range of motion that is approximately 200 degrees.

FIGS. 58 and 59 show the leg in a rearmost position, i.e., a maximum rearward movement of the hip pitch actuator (J11) 720 that can substantially avoid interference with other components of the robot 1 while the torso twist actuator (J10) 620 is fully rotated in one direction and the torso lean actuator (J9) 680 is leaning fully to one direction. In such a position, there can be some interference between the parts, but placing all three actuators at their maximum position is rare, and no specific use case has been developed to date for why the robot would be placed in this configuration. It should be understood that the torso lean actuator (J9) 680 can be placed at the maximum lean and the hip pitch actuator (J11) 720 can be placed at a maximum rearward position. In this configuration, the components of the body will not contact each other, which is due in part to the design of the hip, pelvis, and waist bucket of the torso. Potential interference might only occur if the torso 16 were then twisted fully using the torso twist actuator (J10) 620 from this position, but as noted above, this is a rare configuration that is not typically desired. Accordingly, the spine and lower body assemblies include uniquely shaped structures that position the actuators associated therewith in specific locations to allow the robot to move in the designed manners.

c. Leg Extension

FIGS. 60-61 show side and front views of the robot of FIG. 51 in a position where its left leg is extended anteriorly forward by about 135 degrees using the hip pitch actuator (J11) 720. Of course, the robot 1 can be capable of achieving any other degree of forward leg extension between these illustrated neutral and extended positions. Further, and as noted above, additional degrees of leg extension beyond that shown in FIGS. 60 and 61 are possible when combined with lateral outward movement of the leg using the hip roll actuator (J12) 768 in combination with the hip pitch actuator (J11) 720.

For example, when the hip pitch actuator (J11) 720 is moved to a maximum forward position (e.g., about 160 degrees relative to the coronal plane P_{C}), it can place the knee right next to the chest of the torso 16. In this configuration, however, the leg can contact the torso 16 and be stopped prior to achieving the maximum forward extension of the hip pitch actuator (J11) 720. To address this, when the hip pitch actuator (J11) 720 is moved to the maximum forward position, the hip roll actuator (J12) 768 can move the leg slightly to the side or laterally outward (e.g., about 20 degrees in one embodiment). In other words, the leg 6 can be angled outward relative to the sagittal plane P_{S}. This positional relationship can be beneficial if the robot 1 is lifting a weight or getting off the ground. In particular, the angle of the hip roll actuator (J12) 768 can be at least 5 degrees, preferably at least 10 degrees, most preferably at least 15 degrees, and, in one embodiment, can be about 20 degrees from being parallel with the sagittal plane P_{S} in order to allow the torso 16 to clear the leg 6 when said leg is in the maximum forward position. It can be desirable to allow for the clearance of the leg in this maximum forward position with the least amount of rotation needed by the hip roll actuator (J12) 768. As such, the leg 6 can be designed to clear the torso 16 in the maximum forward position when the hip roll actuator (J12) 768 is rotated less than 40 degrees, preferably less than 30 degrees, and most preferably less than 25 degrees from being parallel with the sagittal plane P_{S}. In other words, said rotation of the hip roll actuator (J12) 768 can be positioned between 5 degrees and 40 degrees, preferably between 10 degrees and 30 degrees, and most preferably between 25 degrees and 30 degrees from being parallel with the sagittal plane P_{S} in order to minimize the amount of rotation needed from the hip roll actuator (J12) while allowing for the leg 6 to be fully forward and clear the torso 16 without interference.

d. Leg Roll

The hip roll actuator (J12) 768 controls the movement of the respective leg 6 from side to side, i.e., leg roll movement. FIGS. 62-64 illustrate the robot 1 of FIG. 51 in various medial and lateral movement positions to illustrate the range of motion of the hip roll actuator (J12) 768. In these examples, the hip pitch actuator (J11) 720 remains in a neutral initial position, and the other leg actuators (J13-J16) in the leg 6 do not apply any torque. Of course, the robot can be capable of achieving any other degree of medial or lateral roll between these illustrated example positions.

e. Leg Twist

As shown in FIGS. 65-70, the leg twist actuator (J13) is positioned below the torso lean actuator (J9) 680, torso twist actuator (J10) 620, hip pitch actuator (J11) 720, and hip roll actuator (J12) 768. The leg twist actuator (J13) is designed to allow the robot 1 to turn in place and provides up to about 90 degrees of rotation in either direction from the neutral position. This range of movement can allow the robot 1 to turn in place, in particular, by turning one leg about 90 degrees, stepping on it, turning the whole robot around about 180 degrees, and then twisting the other leg about 90 degrees. This is beneficial because the robot can turn 180 degrees (i.e., reverse direction) by only taking two steps and, in some situations, only a single step. Stated another way, said robot can turn around and start walking in the other direction by taking only two (and sometimes one) steps. This represents a significant advantage over many prior designs that can require many steps to reverse direction.

The configuration of the leg and its associated actuators (i.e., actuators J11, J12, and J13) also ensures that said leg cannot be placed in a singularity (where two or more actuator axes of rotation are parallel with one another). This is because the hip roll actuator (J12) 768 cannot be rotated outward by 90 degrees, which would be required in order to place the hip pitch axis A₁₁ of the hip pitch actuator (J11) 720 parallel with the leg twist axis A₁₃ of the leg twist actuator (J13). Additionally, there is very little use for rotating or rolling the leg laterally outward more than about 55 degrees from the sagittal plane. Thus, said configuration of the actuators provides the robot with a significant range of motion without a singularity. In other words, said singularity is positioned outside of the usable working range of the robot's legs.

FIGS. 65-66 illustrate the robot of FIG. 51 showing the range of motion for leg yaw, where only J13 is rotated and the other leg actuators (J11-J12 and J14-J16) do not apply torque. In FIG. 65, the right leg 6 is in a neutral position, and the left leg 6 is oriented twisted medially inward by about 90 degrees using the leg twist actuator (J13). In FIG. 66, the right leg 6 is in a neutral position, and the left leg 6 is oriented twisted laterally outward by about 90 degrees using the leg twist actuator (J13).

FIG. 67, for example, shows a bottom view of the robot of FIG. 51 in a position where a lower extent of its left leg (i.e., foot 92a) is twisted medially inward by about 45 degrees using the leg twist actuator (J13) and a lower extent of its right leg (i.e., foot 92b) is in a neutral (i.e., forward-facing) position. FIG. 68 shows a bottom view of the robot of FIG. 51 in a position where a lower extent of its left leg (i.e., foot 92a) is twisted medially inward by about 90 degrees using the leg twist actuator (J13) and a lower extent of its right leg (i.e., foot 92b) is in a neutral (i.e., forward-facing) position. FIG. 69 shows a bottom view of the robot 1 of FIG. 51 in a position where a lower extent of its left leg (i.e., foot 92a) is twisted laterally outward by about 45 degrees using the leg twist actuator (J13) and a lower extent of its right leg (i.e., foot 92b) is in a neutral (i.e., forward facing) position. Finally, FIG. 70 shows a bottom view of the robot 1 of FIG. 51 in a position where its lower left leg (i.e., foot 92a) is twisted laterally outward by about 90 degrees using the leg twist actuator (J13) and its right leg (i.e., foot 92b) is in a neutral (i.e., forward-facing) position. Of course, the robot 1 can be capable of achieving any other degree of medial or lateral yaw between these illustrated example positions.

f. Spine Bend

FIGS. 71-78 illustrate various movements of the spine, i.e., movements of the torso 16 relative to the pelvis 64. As shown in the figures, the robot 1 does not bend forward at its belly. Stated another way, the torso 16 lacks an actuator configured to allow the robot to move its torso toward a support surface that supports the humanoid robot. Stated a further way, the torso 16 lacks an actuator that is both positioned above the torso twist actuator (J10) 620 and configured to allow the robot to move its torso toward the support surface. As such, said robot 1 lacks a rotatory actuator that is aligned with and positioned below the torso twist axis.

To provide similar forward motion, the robot 1 utilizes the hip pitch actuators (J11) 720 of the legs 6. For example, the robot can bend the torso 16 forward at the hip pitch actuators (J11) 720 to reach downward. The use of the robot's legs to perform this forward motion reduces the need for additional actuators (e.g., in some embodiments, the two hip pitch actuators (J11) 720 can do the work of four actuators in prior robots) and beneficially places the loads on the hip pitch actuators (J11) 720 for lifting objects off the ground. Thus, the size/torque associated with the hip pitch actuators (J11) 720 can be adjusted to account for this functional movement. While the robot 1 does not bend forward at its belly, it can bend sideways at its belly (as shown in FIGS. 75-78). This sideways bending is accomplished using the torso lean actuator (J9) 680. Also, because the forward bending of the robot is done using the legs and the hip pitch actuators (J11) 720, the torso lean actuator (J9) 680 can be a smaller actuator having less torque than the hip pitch actuators (J11) 720.

g. Spine Twist

FIGS. 71-74 illustrate the robot of FIG. 51 in various example positions of spine or torso yaw or twist relative to the pelvis 64. This feature helps the robot 1 to be able to reach and grab objects that are positioned to its sides. Accordingly, said robot 1 can have a twisting range of motion associated with the torso twist actuator (J10) 620 that is more than about 45 degrees, preferably more than about 120 degrees, and most preferably more than about 170 degrees. In one embodiment, the torso twist actuator (J10) 620 can have a range of motion of about 180 degrees, i.e., about 90 degrees in either direction from the forward facing, neutral position. As shown in the figures, the robot 1 lacks a structure that is directly coupled to both the leg twist actuator (J13) and the torso twist actuator (J10) 620.

FIGS. 71 and 72 show front and top views of the robot of FIG. 51 in a position where its torso 16 is twisted to its right by about 90 degrees from the neutral position using the torso twist actuator (J10) 620. FIGS. 73 and 74 illustrate front and top views of a similar configuration but in the opposite direction, i.e., twisting the torso 16 of the robot to its left by about 90 degrees from the neutral position using the torso twist actuator (J10) 620. Of course, the robot 1 can be capable of achieving any other degree of torso twist between these illustrated example positions.

h. Spine Lean

As noted above, the robot can lean to its sides at its belly using the torso lean actuator (J9) 680. The range of motion of the torso lean actuator (J9) 680 can be between about 5 and about 50 degrees, preferably between about 15 and about 40 degrees, and most preferably between about 20 and about 40 degrees. In one embodiment, the torso lean actuator (J9) 680 can have a range of motion of about 30 degrees in either direction from the vertical, neutral position.

FIGS. 75 and 76, for example, show side and front views of the robot of FIG. 51 in a position where its torso 16 is leaned to its right by about 30 degrees from the neutral position using the torso lean actuator (J9) 680. FIGS. 77 and 78 illustrate front and side views of a similar configuration but in the opposite direction, i.e., leaning the torso 16 of the robot 1 to its left by about 30 degrees from the neutral position using the torso lean actuator (J9) 680. Of course, the robot 1 can be capable of achieving any other degree of torso lean or spine roll between these illustrated example positions.

### G. Waist

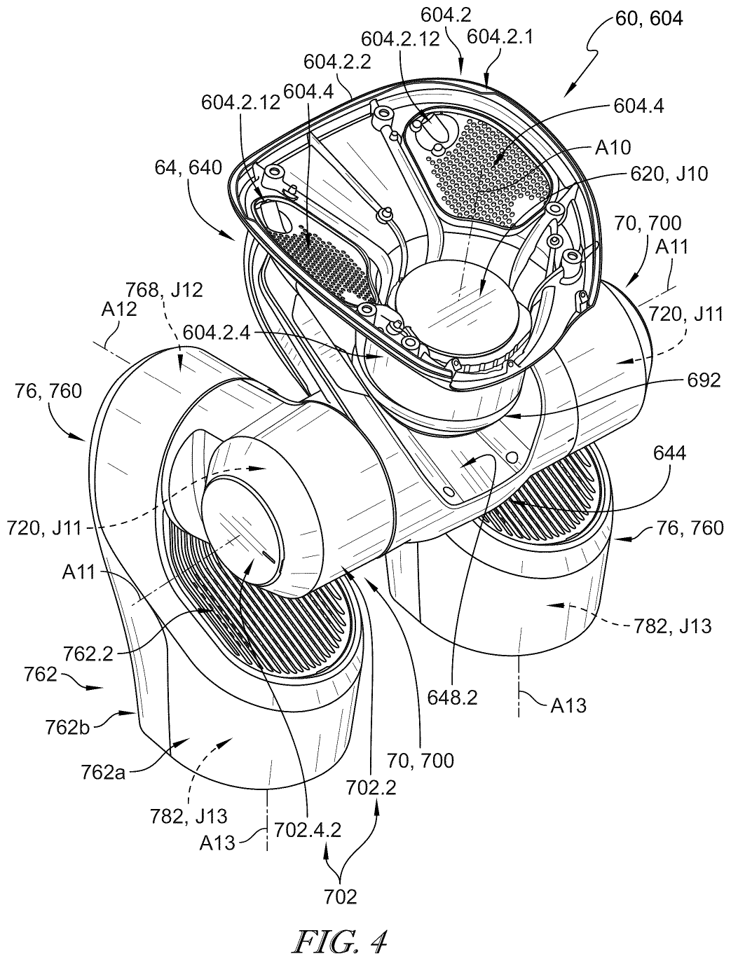

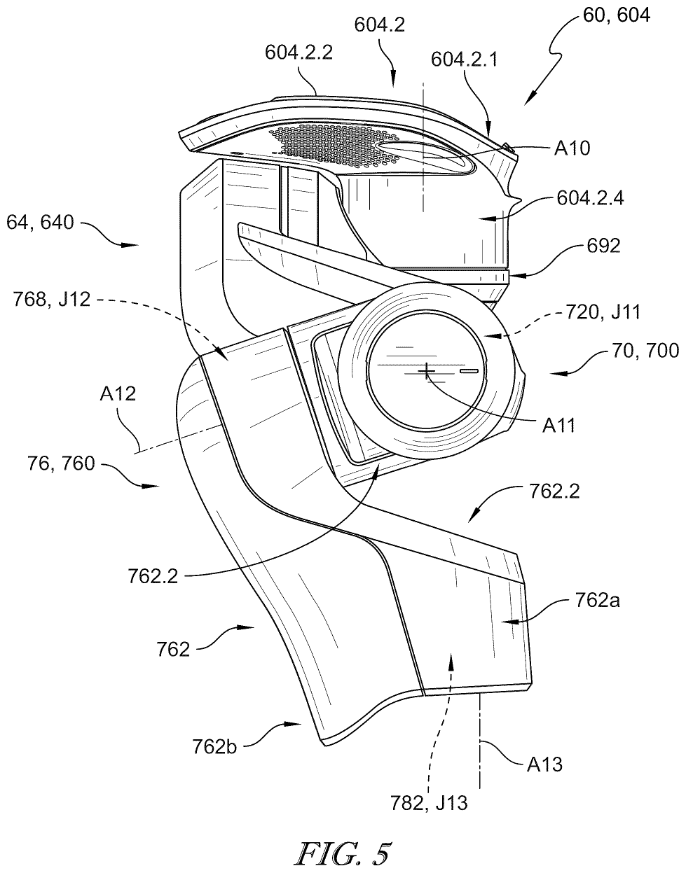

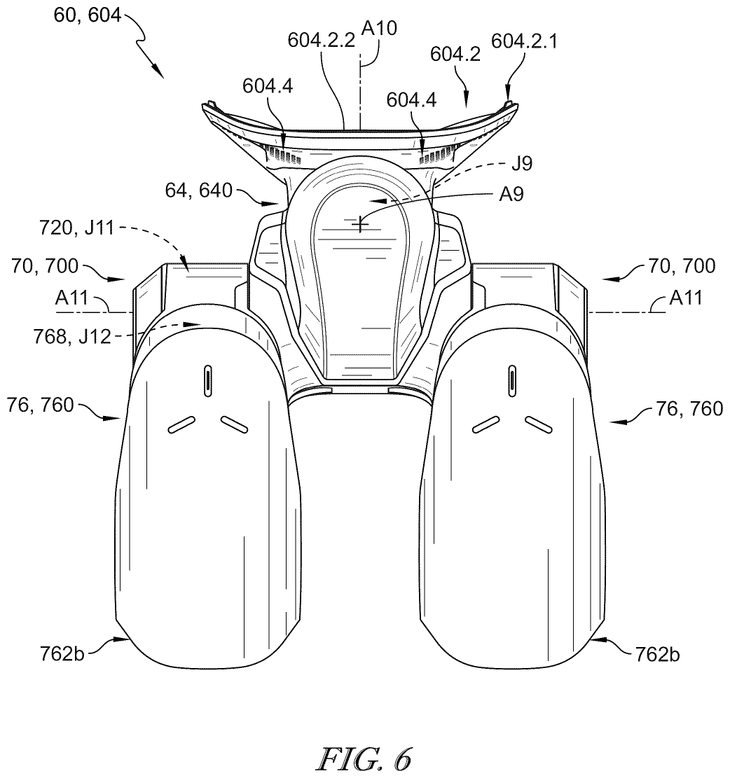

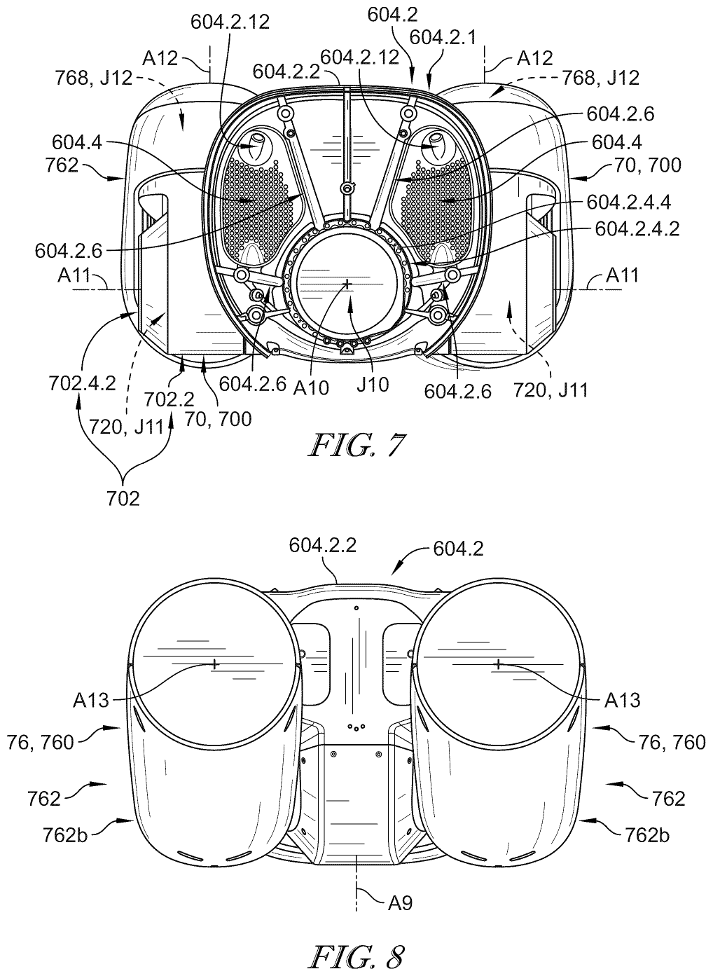

FIGS. 4-16 illustrate the waist 604 of the robot 1, which is coupled to the pelvis 64. The waist 604 includes: (i) a waist body 604.2 and (ii) perforated vent panels 604.4. The waist body 604.2 is shaped and contoured to transition the form of the robot 1 from the torso 16 to the pelvis 64. An actuator (J10) 620, which is disposed in the waist 604, facilitates torso twisting, which is defined as Z-axis rotation of the torso 16 relative to the pelvis 64. The torso twist actuator 620 (J10) is at least partially housed in the waist body 604.2. of the waist 604. The torso twist actuator 620 (J10) is substantially similar in structure to the other spine and hip actuators but is sized to have a momentary peak torque ranging from 101.6-152.4 N-m, preferably 114.3-139.7 N-m. Unlike the wiring contained in the rest of the robot 1, the wiring of the torso twist actuator 620 (J10) is positioned outside of the center of the actuator (J10) 620 and, as such, is exposed to the elements and foreign objects.

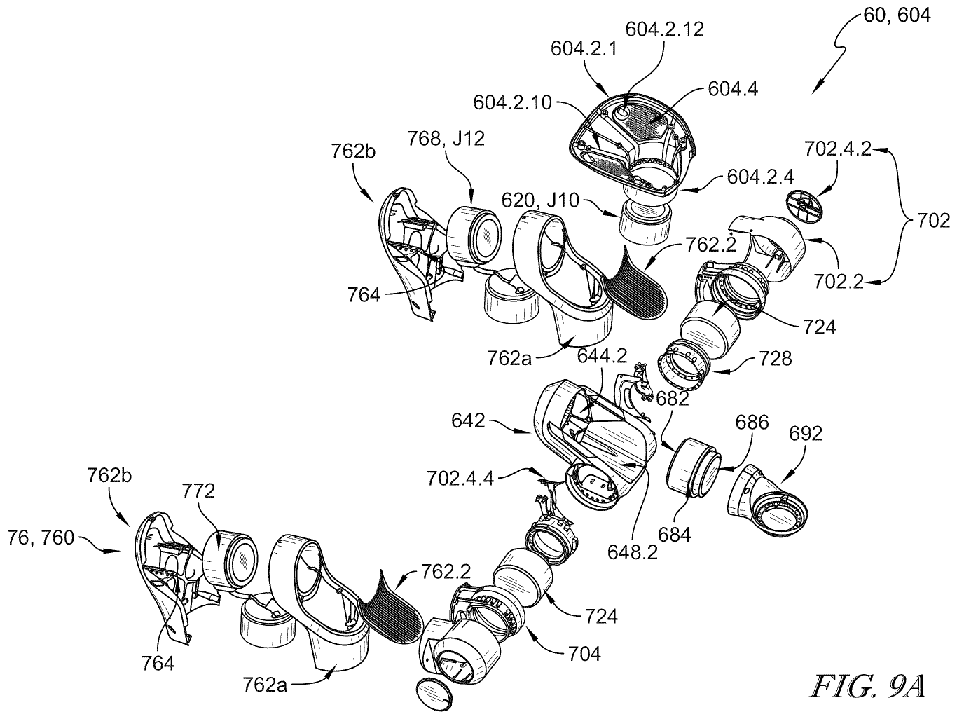

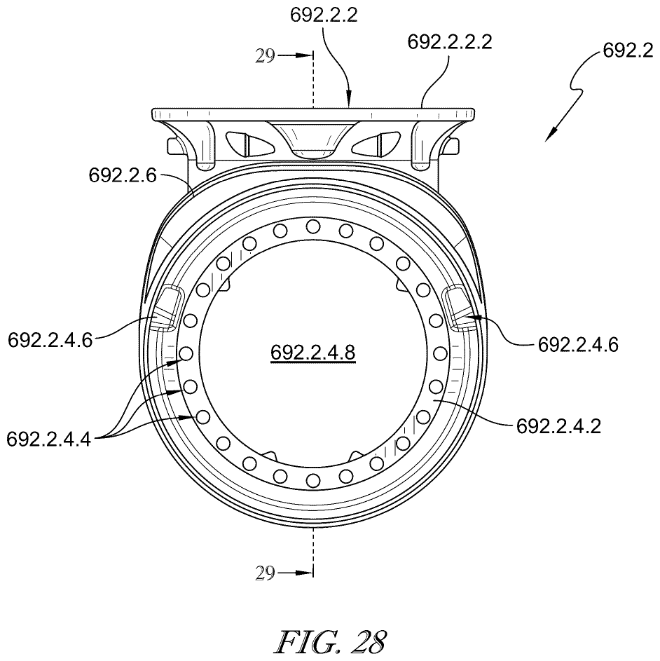

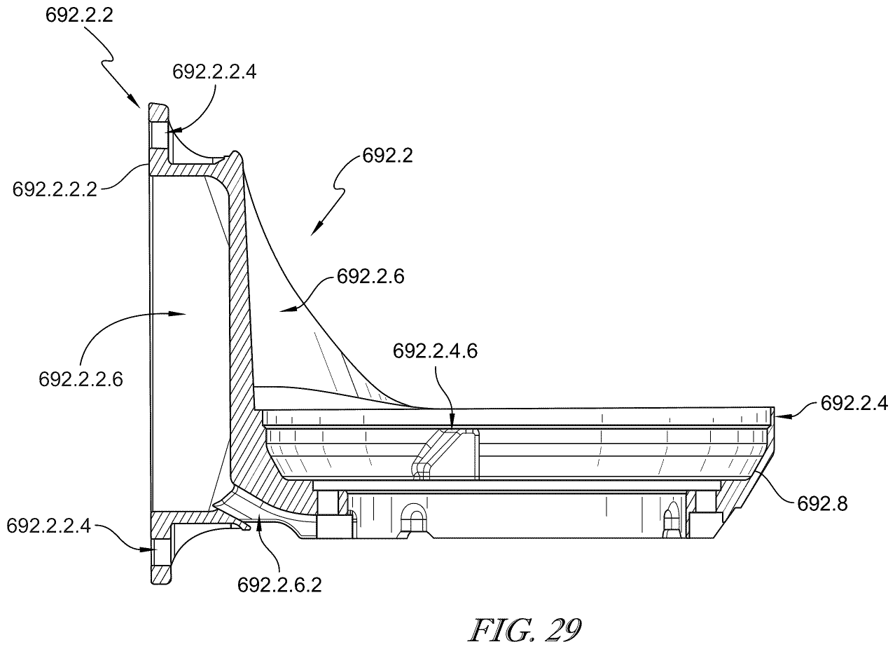

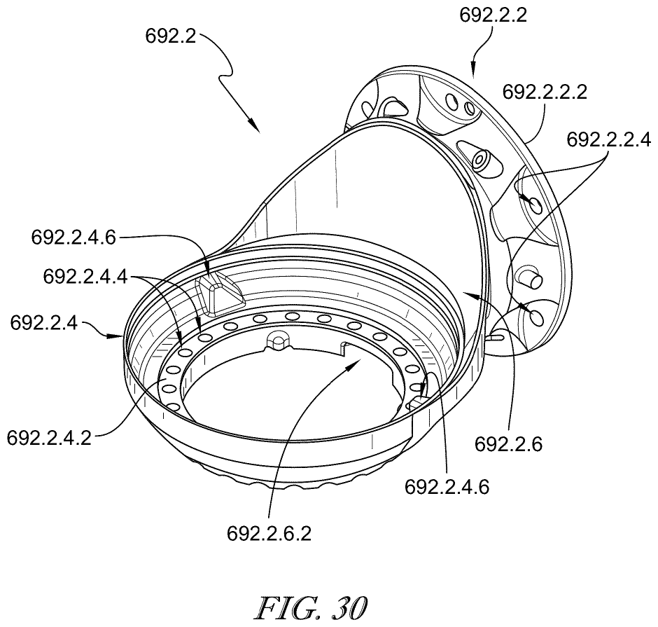

Additionally, as shown in FIGS. 9-16 and 28-30, the waist 604 also includes a spine support assembly 692. The spine support assembly 692 couples to one end of the torso twist actuator 620 (J10), which is housed in the waist body 604.2, and to one end of the torso lean actuator 680 (J9) 680, which is in the pelvis 64, thereby connecting the waist 604 to the pelvis 64. When the actuator (J10) 620 is activated, The waist body 604.2, and thus the torso 16, rotates or twists relative to the spine support assembly 692.

a. Waist Body

As shown in FIGS. 4-9, the waist body 604.2 includes: (i) a main body 604.2.1 with a waist rim 604.2.2, and (ii) a projecting actuator housing or waist bucket 604.2.4. The projecting actuator housing or waist bucket 604.2.4 extends from the main body 604.2.1 and has an actuator receptacle 604.2.4.2 and an actuator mount 604.2.4.4. These components are configured to receive the torso twist actuator 620 (J10) that couples the torso 16 to the pelvis 64. In other words, a first extent of the torso twist actuator 620 (J10) is coupled to the main body 604.2.1. The main body 604.2.1 has a shallow parabolic shape, with a height that is less than 30 mm and a width that is over 225 mm. Accordingly, the height of the main body 604.2.1 is less than 13% of its width. The ratio of height to width of the main body 604.2.1 may vary between 1:6 and 1:10. Alternatively, the main body 604.2.1 may include a series of flat or slightly curved segments to simplify manufacturing, or it may include reinforcing ribs or a honeycomb internal structure to increase strength and stiffness while minimizing weight.

This shallow main body 604.2.1 provides a curvilinear bottom shelf for the torso 16 that has a substantial area, for example, greater than 40 cm². This large area has a limited slope, as its height is less than 30 mm, which helps to maximize the volume of the torso 16 and provides additional stability to the robot 1. The larger torso volume and additional stability represent a substantial benefit over conventional robots that have very narrow lower torsos, such as a steep-sloped lower torso with a width that is substantially equal to the width of the actuator.

The projecting actuator housing 604.2.4 downwardly depends from the shallow, parabolic-shaped main body 604.2.1. In other words, the projecting actuator housing 604.2.4 is not housed within the main body 604.2.1, which ensures that a substantial portion of the torso twist actuator 620 (J10) is not located within the torso 16. As such, the intersection between the main body 604.2.1 and the housing 604.2.4 forms an angle that is between 90 degrees and 120 degrees. This sharp angle between these walls furthers the concept that the main body 604.2.1 does not include a steep sloped wall that narrows down to the diameter of the torso twist actuator (J10) 620. As shown in the figures, the projecting actuator housing 604.2.4 is not centered within the main body 604.2.1 and instead is offset towards a forward most extent of the torso 16. For example, the actuator housing 604.2.4 may be positioned adjacent to a frontal extent of the main body 604.2.1. It may have a lateral width that extends over 60 mm from said external surface of the housing 604.2.4 to the perimeter of the main body, and a rearward depth of over 100 mm that extends over 60 mm from said external surface of the housing 604.2.4 to the perimeter of the main body.

It should be understood that the height of the projecting actuator housing 604.2.4 must be sufficient to allow for enough clearance between the bottom extent of the main body 604.2.1 and the pelvis 64. However, extending the height of the projecting actuator housing 604.2.4 too far creates instability in this main connection between the torso 16 and the pelvis 64. Thus, the designer must ensure that the height of the projecting actuator housing 604.2.4 is sufficient for clearance but not so high as to cause instability issues. The balance struck in the disclosed robot 1 results in a height between 30 mm and 80 mm, wherein a shorter extent may be positioned at a frontal extent of said projection because the robot 1 does not have the ability to lean forward at a location formed in its lower torso.

Because the waist 604 is the only connection between the torso 16 and the pelvis 64, the must be capable of transferring at least a portion of the load the robot 1 undertakes while performing a task. In particular, this transfer usually occurs from the arm assemblies, through the torso 16, and into the legs. As such, the waist body 604.2 includes a plurality of casing attachment supports 604.2.6 that provide additional thickness in the waist body 604.2 and into the waist bucket 604.2.4. As shown in the illustrative embodiment, the waist body 604.2 may have four casing attachment supports 604.2.6. The bottom of the casing 162 couples to the waist 604 at these casing attachment supports 604.2.6. In other embodiments, the waist 604 may include more or less attachment supports. In further embodiments, said attachment supports may be eliminated, and the waist 604 and the frontal skeleton may be formed as a single integrated unit. The waist body 604.2 also includes vent openings 604.2.10 and fly wire ports 604.2.12. The vent openings 604.2.10 may be covered by the perforated vent panels 604.4, which are coupled to the waist body 604.2, or the perforated vent panels 604.4 may be formed in one piece within the vent openings 604.2.10. Air is drawn into an extent of the torso 16 through vent openings in the torso 16, passed through an extent of the robot's torso 16 over the cooling devices associated with the robot's computer or battery, and routed out through the vent openings 604.2.10 and the perforated vent panels 604.4 in the waist 604. In alternative embodiments, the direction of the generated air flow path may be reversed (i.e., in via the vent openings 604.2.10 in the waist 604, through an extent of the torso 16, and out via vent openings below the robot's arm assembly 5). The air that can be drawn into the torso 16 via fans helps cool the computing devices when the robot 1 is working and cool the battery when the robot is charged. This selective cooling is extremely beneficial because it eliminates the need for additional cooling devices (e.g., liquid cooling). In alternative embodiments, the direction of the air flow may be reversed (i.e., in via a vent opening in a bottom extent of the robot's torso/waist, through an extent of the torso, and out via an air vent portion under the robot's arm assembly 5). The fly wire ports 604.2.12 provide bottom access to the torso 16. The fly wire ports 604.2.12 may include covers 604.2.12.2 with a channel or hole to pass control wires to the lower portion of the robot 1.

b. Spine Support Assembly

As shown in FIGS. 4-15, the spine support assembly 692 couples to a second extent of the torso twist actuator (J10) 620, which extends through the projecting actuator housing or waist bucket 604.2.4, so as to connect the waist 604 to the pelvis 64. To facilitate the coupling of J9 and J10, the spine support assembly 692, as shown in FIGS. 9-16 and 28-30, includes: (i) a frame 692.2, (ii) side shrouds or covers 692.4.2, 692.4.4, and (iii) a bottom shroud or cover 692.6. The frame 692.2 has a first coupling portion 692.2.2 at a rear or posterior end thereof, a second coupling portion 692.2.4 at a front or anterior end thereof, and an intermediate connecting portion 692.2.6 extending therebetween. The first coupling portion 692.2.2 couples to an output adapter 688, which isa first extent of the torso lean actuator (J9) 680, and the second coupling portion 692.2.4 couples to or interfaces with a second extent of the torso twist actuator (J10) 620.

The various mounting fasteners utilized to connect the spine support assembly 692 with the actuators J9 and J10 can be covered with shrouds or covers 692.4.2, 692.4.4, 692.6 (see FIG. 16). The covers 692.4.2, 692.4.4, 692.6 can hide the fasteners utilized to couple different components, thereby improving aesthetics and preventing tampering while maintaining access when desired. The use of threaded fasteners also allows the torso 16 and spine support assembly 692 (and remainder of robot upper body) to be separated from the pelvis 64 (and remainder of robot lower body).

The first coupling portion 692.2.2 of the frame 692.2 can define a mounting surface 692.2.2.2 with one or more apertures 692.2.2.4 configured to receive fasteners and/or projections 688.4.6 formed on the output adapter 688. One or more threaded fasteners 692.8, such as bolts, can secure the spine support assembly 692 to the output adapter 688 and, thereby, to the pelvis 64 and the hip assembly. The first coupling portion 692.2.2 is also formed to define a cavity 692.2.2.6 that is sized to receive a portion of the torso lean actuator 680 (J9). As shown in FIG. 15, so that when the first coupling portion 692.2.2 is coupled to the torso lean actuator assembly 680, J9 the end of the lean actuator 680, J9 extends into the cavity 692.2.2.6 as shown in FIG. 15.

The second coupling portion 692.2.4 can define a mounting surface 692.2.4.2 configured to interface with a second extent of the torso twist actuator 620 (J10) and fasten thereto utilizing a plurality of threaded fasteners extending through through-bores 692.2.4.4 formed in the mounting surface 692.2.4.2, similar to the mounting configuration of the actuator 680 (J9) to the pelvis frame 644 described below. The second coupling portion 692.2.4 can also include motion limiting stops 692.2.4.6 formed thereon. These stopscan interface with a limiting projection 630.2 formed on an output adapter 630 of the actuator 620 (J10) to limit the range of motion of the torso 16 relative to the pelvis 64. This mechanism can work similarly to the motion limit stops 644.2.6.10 and the limiting projection 688.6 on an output adaptor 688 of the torso lean actuator 680 (J9), which are described in more detail below. The motion limit stops 692.2.4.6 define the range of motion of the torso twist actuator 620 (J10) relative to the pelvis frame 644. The motion limit stops 692.2.4.6 can be integrally formed with a wall of the second coupling portion 692.2.4 of the frame 692.2 to provide increased levels of strength. this can be beneficial because the movement of the torso 16 relative to the pelvis 64 can create significant inertia and exert large forces on the motion limit stops 692.2.4.6. Various ranges of motion can be utilized. In the illustrated embodiment, opposed motion limiting stops 692.2.4.6 are set 80° offset from one another, thereby allowing 40° of travel in either direction from a “zero” or “straight” configuration.

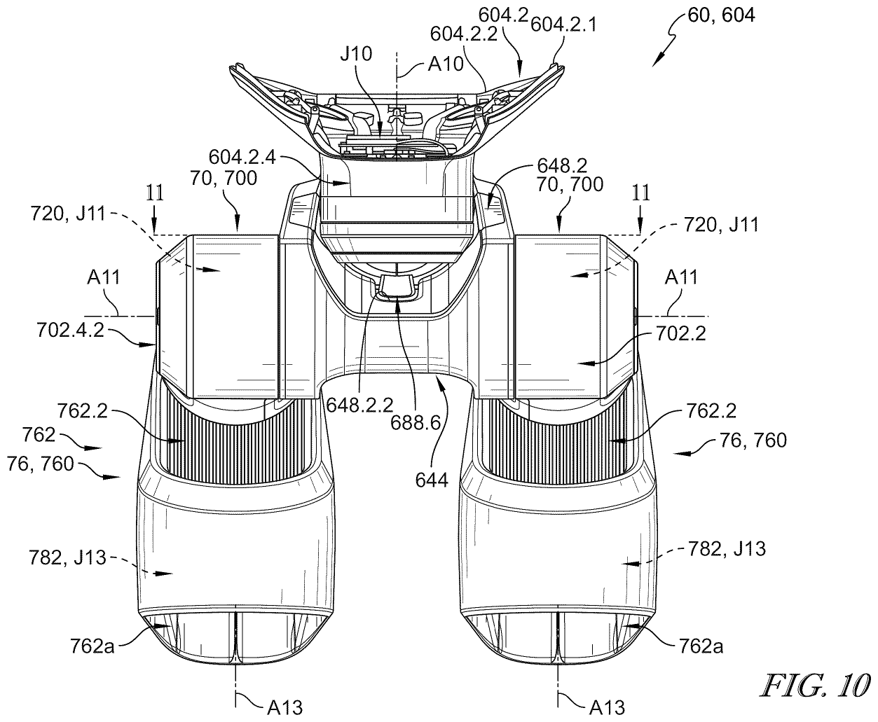

As shown in FIG. 11, the limiting projection 630.2 is sized and shaped to fit between these motion limit stops 692.2.4.6 on the frame 692.2 of the spine support assembly 692. The limiting projection 630.2 is configured to rotate with the output adapter 630 as the actuator 620 (J10) is activated, limiting the range of motion of the actuator 620 (J10) by contacting the motion limit stops 692.2.4.6 on the frame 692.2. The limiting projection 630.2 has a circumferential dimension that reduces the available range of motion as shown in FIG. 11. For example, in the illustrated embodiment, although the motion limit stops 692.2.4.6 are set 40° in each direction from vertical, the size of the limiting projection 630.2 occupies about 20° of this range, such that the actuator can rotate about 30° in each direction from a “zero” or “straight” configuration.

The connecting portion 692.2.6 can extend between the first and second coupling portions 692.2.2, 692.2.4. It can have a curved shape to bridge the substantially perpendicular orientations of the mounting surfaces 692.2.2.2, 692.2.4.2 of the first and second coupling portions 692.2.2, 692.2.4, while providing clearance to permit coupling and motion relative to each of the torso lean and torso twist actuator assemblies J9, J10. The connecting portion 692.2.6 can also include a wire conduit 692.2.6.2 to permit routing of the wiring 694.2 from the torso twist actuator (J10) 620 to the torso lean actuator (J9) 680, as shown in FIG. 15.

### H. Pelvis

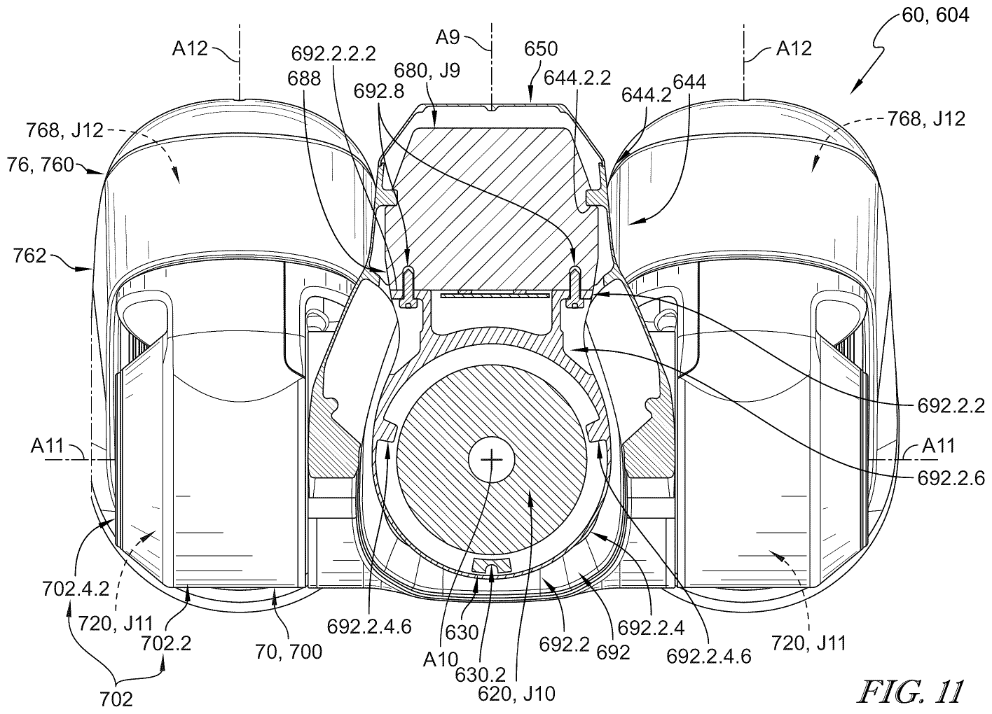

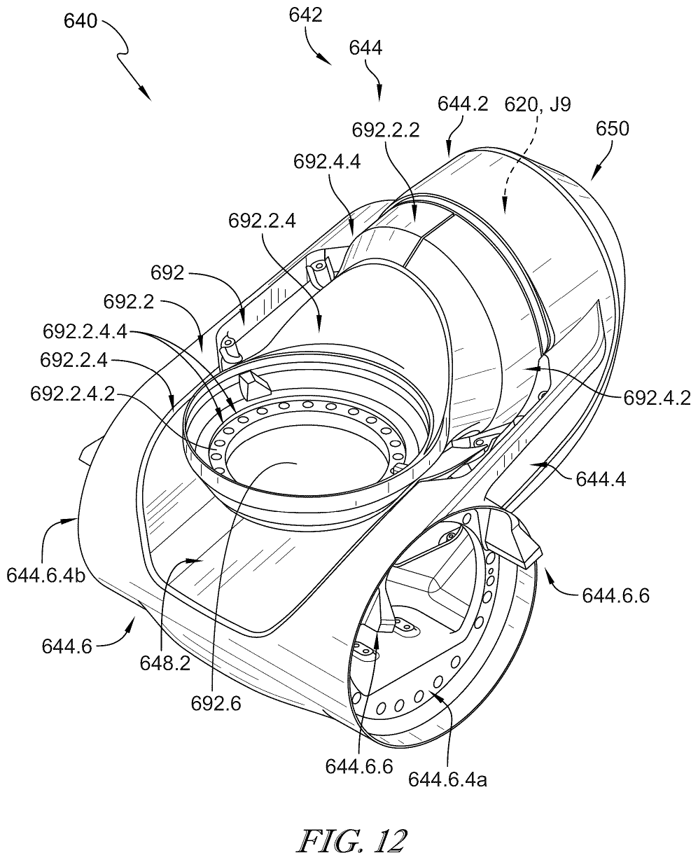

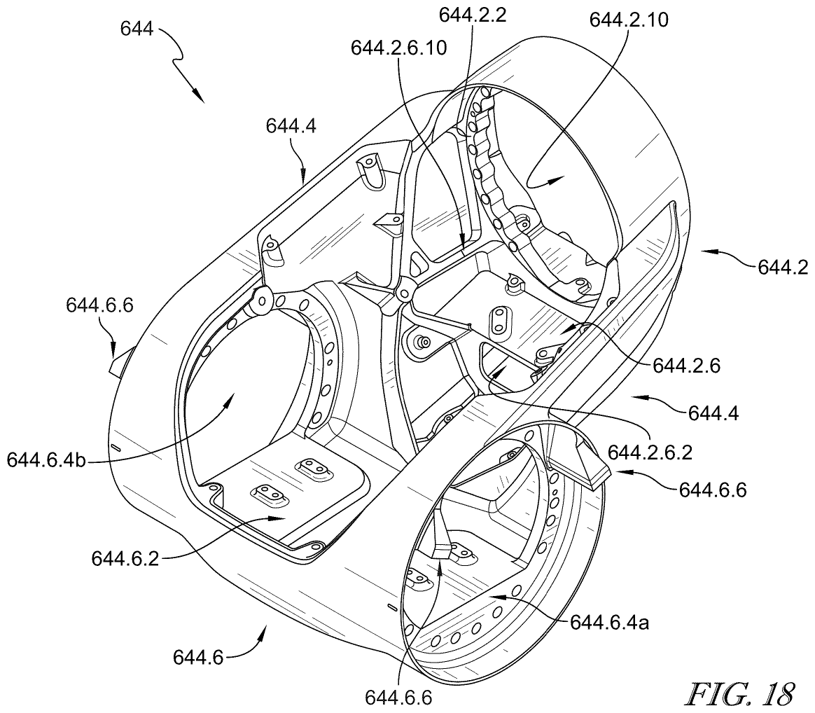

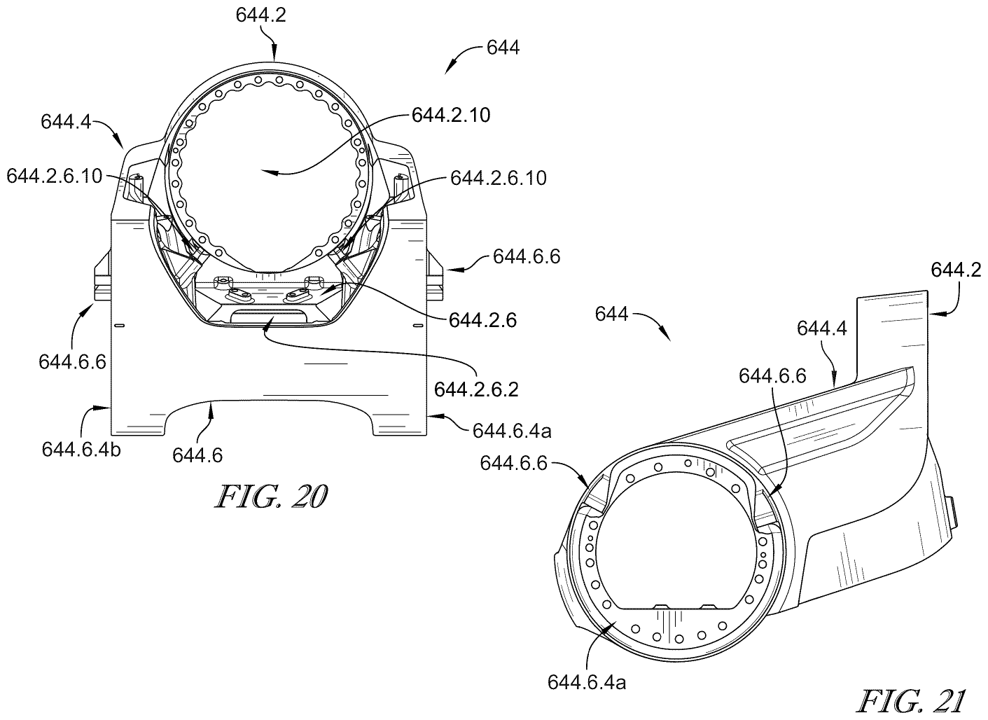

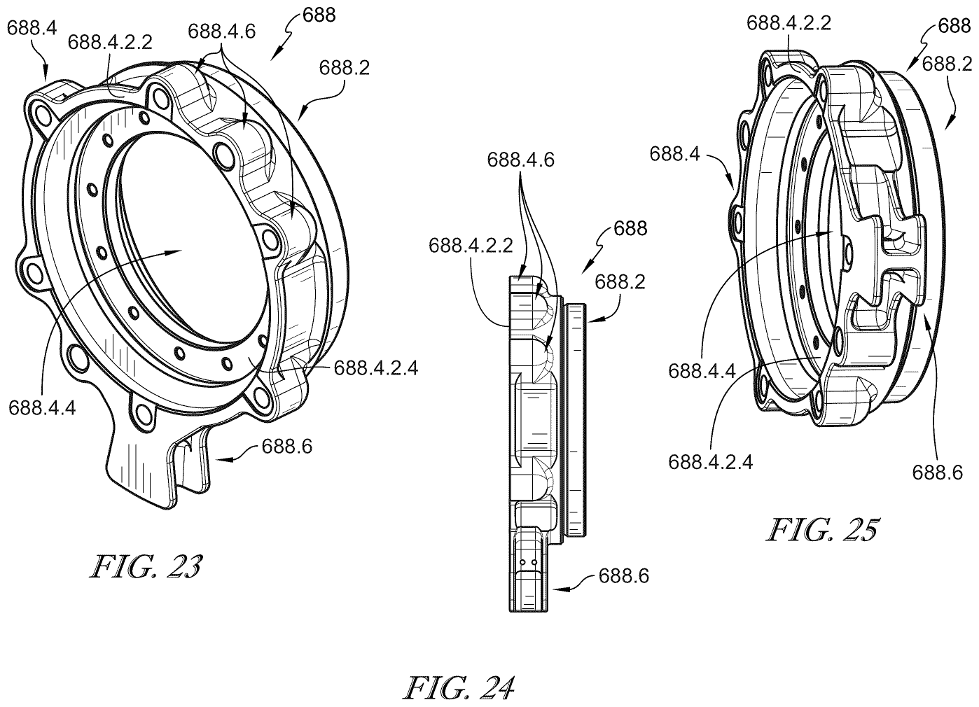

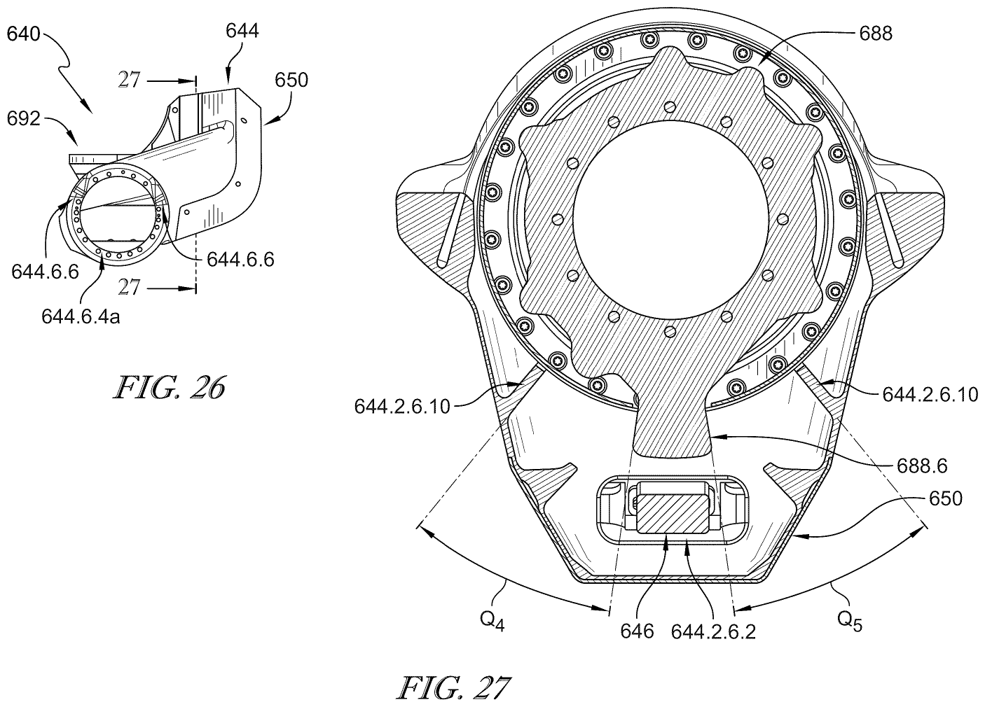

FIGS. 12-27 illustrate the pelvis 64 of the robot 1, which represents the middle of the robot and connects the torso 16 to the legs via the hip assembly. In other words, the pelvis 64 is coupled directly to the waist 604 and the hip assemblies. The pelvis 64 can be considered the “ground” region of the robot, against which the positions of other components can be measured. Torso leaning, which is defined as X-axis rotation of the torso 16 relative to the pelvis 64 can be accomplished using an actuator (J9) 680 disposed in the pelvis 64. As discussed above, torso twisting, or Z-axis rotation of the torso 16 relative to the pelvis 64 can be accomplished using an actuator (J10) 620 disposed in the waist 604, which is coupled to an output of the torso leaning actuator (J9) 680. The legs 6 can be coupled to opposing sides of the pelvis 64 via actuators J11 that control hip pitch, defined as Y-axis rotation of the legs 6 relative to the pelvis 64 The hip pitch actuator (J11) 720 can, in turn, be coupled to the hip roll actuator (J12) 768, which can control hip roll, defined as X-axis rotation of the legs 6 relative to the pelvis 64.

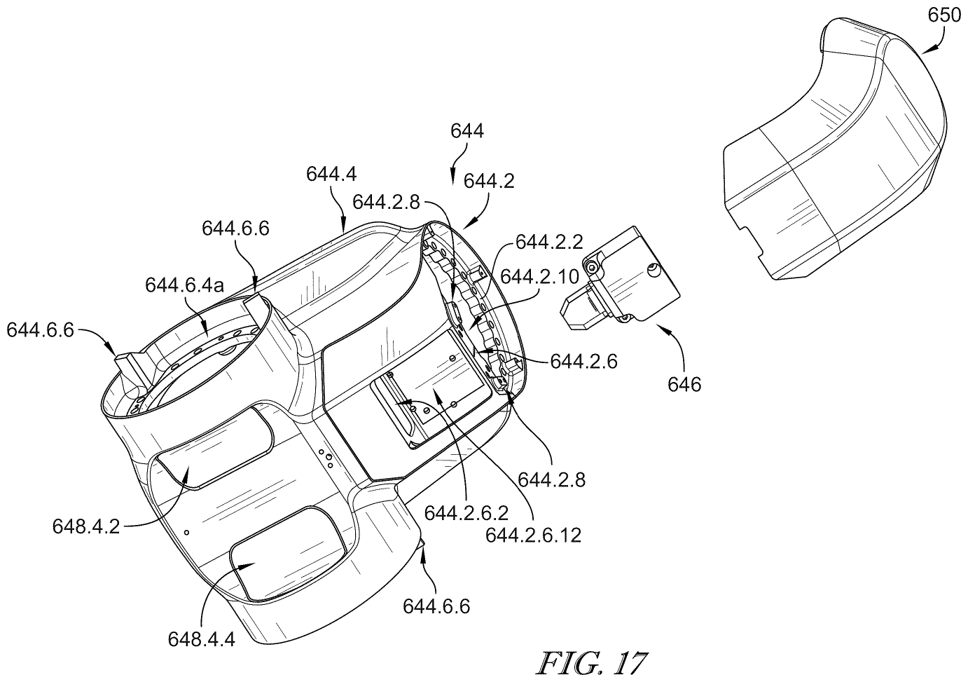

As shown in the exploded views of FIGS. 16 and 17, the pelvis 64 includes a housing 642 that comprises a frame 644, top and bottom covers 648.2, 648.4.2, 648.4.4, and a rear cover 650. The frame 644 is a core component to which other components can be mounted or coupled. The pelvis frame 644 can be a machined, cast, or 3D printed part that connects the torso lean actuator 680 (J9) to the hip pitch actuator assemblies (J11) 720.

Further, a known plane of the pelvis frame 644 can serve as a mounting position for the robot's main inertial measurement unit (IMU) 646, such that the IMU's position is known relative to the pelvis frame 644. This can serve as the “ground” or “zero” for the robot, against which the positions of all other components can be measured, calculated, or otherwise determined. The top cover 648.2, the bottom covers 648.4.2, 648.4.4, and the rear cover 650 are coupled to respective portions of the frame 644 over components coupled to the pelvis frame 644. This protects these components and improves aesthetics when access is not required. As noted above, the torso lean actuator (J9) 680 can be mounted to the pelvis frame 644. One side of this actuator, including one of its printed circuit boards (PCBs), as well as the IMU 646, can be accessed from the rear of the robot 1. The rear cover 650 is disposed over the rear of the pelvis frame 644 to protect these components and improve aesthetics when access is not required.

a. Pelvis Frame

FIGS. 16-30 illustrate the pelvis frame 644 in greater detail. As shown in these figures, the pelvis frame 644 has a depth-elongated lateral hyperboloid configuration and is coupled to multiple actuators whose rotational are positioned in the X and Y directions. Alternatively, the frame 644 may include an upper U-shaped structure, a lower U-shaped structure, and a cylindrical receiver coupled to said U-shaped structures. Further, the frame 644 has a height that is greater than its width, and a depth that is greater than both its height and width. The frame 644 also includes regions that have been significantly thickened to add support and rigidity to the central portion of the robot 1. In other embodiments, the frame 644 could feature an internal lattice or honeycomb structure to provide additional rigidity and strength, the U-shaped structures could be designed with variable curvature to optimize load distribution, include vibration damping elements or materials to reduce transmission of vibrations and improve overall robot stability and sensor performance, include rigid and flexible elements with rigid sections providing structural support and flexible sections allowing for controlled deformation to absorb impacts and improve overall robot compliance, incorporate integrated thermal management features, such as heat pipes or phase change materials, built-in force sensors or strain gauges at key locations to provide real-time feedback on structural loads and stresses, and/or a combination thereof.

The pelvis frame 644 includes: (i) a torso lean housing 644.2, (ii) an extender 644.4, and (iii) an actuator receiving assembly 644.6. The torso lean housing 644.2 is configured to couple with the torso lean actuator (J9) 680 and the rear cover 650. The extender 644.4 extends between and connects the torso lean housing 644.2 to the actuator receiving assembly 644.6. The actuator receiving assembly 644.6 is configured to couple with the hip pitch actuators (J11) 720.

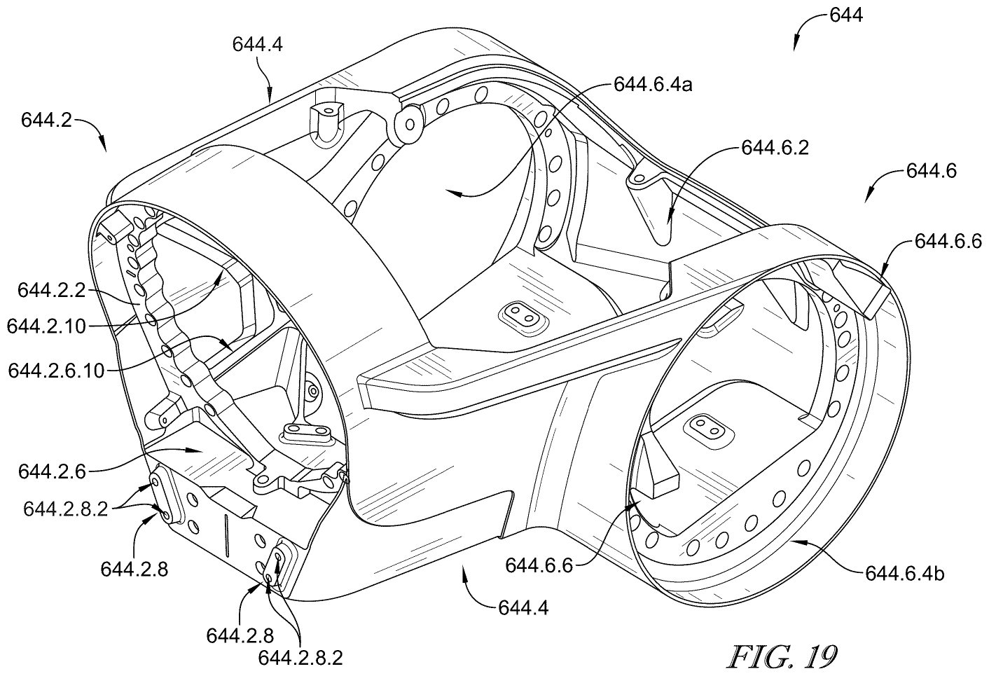

As shown in the rear view of FIGS. 16-22, the torso lean housing 644.2 of the pelvis frame 644 includes: (i) an actuator mount 644.2.2 for coupling with the torso lean actuator (J9) 680, (ii) a coupling wall portion 644.2.6 that extends from the actuator mount 644.2.2, and (iii) mounting pads 644.2.8 coupled to the coupling wall 644.2.6. The torso lean housing 644.2 also defines a rear-facing opening 644.2.10 that allows for access to the rear-facing side of actuator (J9) 680 when the rear cover 650 is removed. Also exposed when the cover 650 is removed are the mounting pads 644.2.8 with threaded bores 644.2.8.2 that can be utilized to mount the robot 1 to a support frame or stand, e.g., when performing maintenance on the robot. FIG. 19 shows the above-mentioned access available to the IMU 646, robot mounting pads 644.2.8, and rear portion of the torso lean actuator (J9) 680, including input PCB assembly 682, when the cover 650 is removed. Threaded fasteners (e.g., bolts) may be utilized to secure the actuator (J9) 680 to the actuator mount 644.2.2 of the torso lean housing 644.2 of the pelvis frame 644. In the illustrated embodiment, 24 such bolts may be utilized around the circumference of the actuator (J9) 680 to secure the actuator relative to the pelvis frame 644. In other embodiments, alternative coupling configurations can be employed.

The coupling wall portion 644.2.6 of the torso lean housing 644.2 is formed to define (i) an opening 644.2.6.2 for the IMU 646, (ii) motion limit stops 644.2.6.10, (iii) a machined planar surface 644.2.6.12 as shown in FIGS. 16-22. The IMU 646 is coupled to this machined planar surface 644.2.6.12 on a rear bottom portion of the pelvis frame 644. The motion limit stops 644.2.6.10 define the range of motion of the torso lean actuator (J9) 680 relative to the pelvis frame 644. The motion limit stops 644.2.6.10 can be integrally formed with a wall of the pelvis frame 644 to provide increased strength, which can be beneficial because the movement of the torso 1616 can create significant inertia and exert large forces on the motion limit stops 644.2.6.10. Accordingly, the motion limit stops 644.2.6.10 may also be reinforced with one or more ribs. Various ranges of motion can be utilized. In the illustrated embodiment, opposed motion limit stops 644.2.6.10 are set 80° offset from one another, thereby allowing 40° of travel in either direction from a “zero” or “straight” configuration. The motion limit stops 644.2.6.10 can interact with the limiting projection 688.6 formed on the output adapter 688 of the actuator 680 (J9) to limit its range of motion, as described in more detail below. The IMU 646 is coupled to the machined planar surface 644.2.6.12 on a rear bottom portion of the pelvis frame 644.

The actuator receiving assembly 644.6 includes: (i) an actuator receptacle 644.6.2 for the torso twist actuator (J10) 620 and (ii) actuator mounts 644.6.4a, 644.6.4b for coupling with the hip pitch actuators 720 (J11), as shown in FIGS. 16-22. The actuator receptacle 644.6.2 is sized to receive the torso twist actuator (J10) 620 and its associated spine support assembly 692. The actuator mounts 644.6.4a, 644.6.4b are positioned on opposite left and right sides of the frame 644 and are designed to enable the frame 644 to: (i) receive a portion of the left hip pitch actuator (J11) 720, (ii) be coupled to a first extent of the left hip pitch actuator (J11) 720, (iii) receive a portion of the right hip pitch actuator (J11) 720, and (iv) be coupled to a first extent of the right hip pitch actuator (J11) 720. In other words, the frame 644 has a left side with a left actuator mount 644.6.4a and a right side with a right actuator mount 644.6.4b. The actuator mounts 644.6.4a, 644.6.4b include outer surfaces that are positioned substantially parallel with one another, which enables the hip pitch actuators (J11) 720 to have hip pitch axes A₁₁ that are coplanar, are positioned within the transverse plane P_{T}, positioned within the coronal plane P_{C}, and perpendicular to the sagittal plane P_{S}.

In other embodiments, the actuator mounts 644.6.4a, 644.6.4b may not be substantially parallel with one another, but instead, said actuator mounts 644.6.4a, 644.6.4b may be angled relative to one another. For example, an inner angle that extends across the frame 644 and between the outer surfaces may be between 1 degree and 60 degrees, preferably between 10 degrees and 45 degrees. Angling said actuator mounts 644.6.4a, 644.6.4b causes the left hip pitch axis A₁₁ to also be angled relative to the right hip pitch axis A₁₁ and, as such, said left and right hip pitch axes A₁₁ will not be coplanar, positioned within the transverse plane P_{T}, positioned within the coronal plane P_{C}, or perpendicular to the sagittal plane P_{S}.

The actuator mounts 644.6.4a, 644.6.4b include motion limit stops 644.6.6 formed thereon to limit the range of motion of the hip 70 and the hip pitch actuator (J11) 720 relative to the pelvis frame 644. Similar to the motion limit stops 644.2.6.10 described above, the motion limit stops 644.6.6 can be integrally formed with the pelvis frame 644 to provide increased levels of strength because the robot's legs can develop a large amount of inertia during use. This can exert significant forces on the motion limit stops 644.6.6 that they must be capable of withstanding. Building the motion limit stops 644.6.6 into the structure of the pelvis 64 can help achieve sufficient levels of strength. Various ranges of motion can be utilized. In the illustrated embodiment, opposed motion limiting stops 644.6.6 are set 80° offset from one another, thereby allowing 40° of travel in either direction from a “zero” or “straight” configuration.

b. Covers

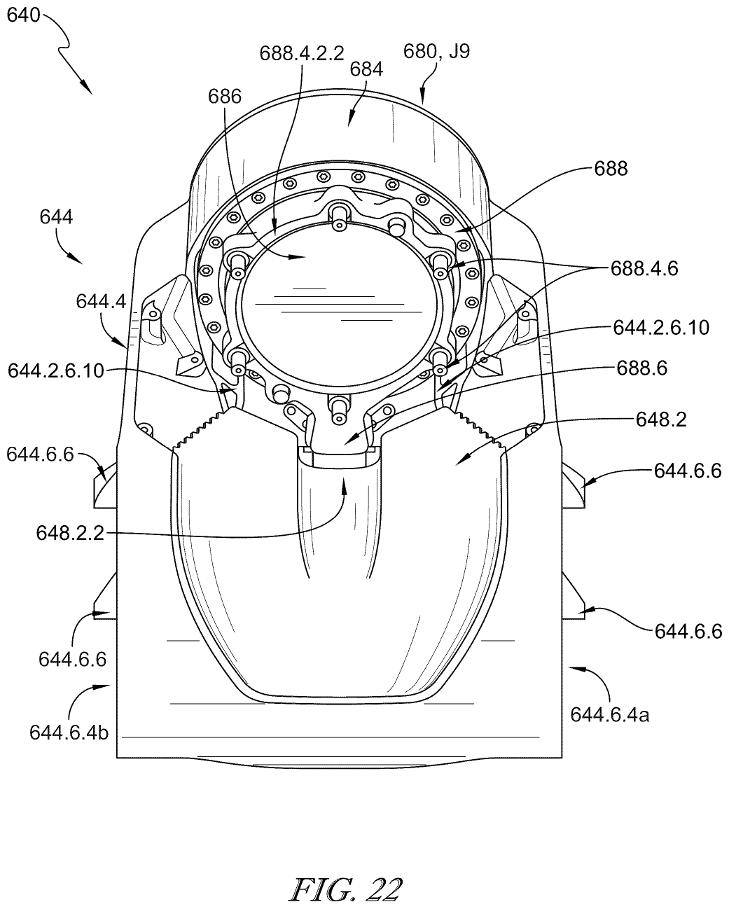

FIGS. 16, 17, and 22 illustrate the top cover 648.2, the bottom covers 648.4.2, 648.4.4, and the rear cover 650 in greater detail. The top cover 648.2, the bottom covers 648.4.2, 648.4.4, and the rear cover 650 may be selectively coupled to the frame 644 over various portions of the pelvis frame 644 to conceal fasteners, improve aesthetics, and protect underlying components (e.g., the IMU 646, the PCB assembly 682, the actuator 680, and/or other wiring in the pelvis frame 644), while allowing access when necessary. The different covers 648.2, 648.4.2, 648.4.4, 650 are selectively coupled to the frame 644 with fasteners, including, but not limited to, bolts, screws, pins, rivets, or other suitable fastening means. The top cover 648.2 is selectively coupled to the frame 644 within actuator receptacle 644.6.2 to interface with the torso twist actuator (J10) 620 and the spine support assembly 692 coupled thereto as shown in FIGS. 12-16. The bottom covers 648.4.2, 648.4.4 are each selectively coupled to the extender 644.4 of the pelvis frame 644. The rear cover 650 is selectively coupled to the torso lean housing 644.2 of the frame 644 and disposed over the rear of the pelvis frame 644 to cover and protect the rear-facing side of actuator 680 (J9), the IMU 646, the input PCB assembly 682, etc. As shown in FIGS. 16 and 22, the top cover 648.2 has a tapered channel or groove 648.2.2. The tapered groove 648.2.2 extends from rear to front with the larger depth being closer to the torso lean actuator (J9) 680. The tapered groove 648.2.2 is sized to allow the torso lean actuator (J9) 680 to be attached to the actuator mount 644.2.2 of the frame 644. The tapered groove 648.2.2 is sized and shaped to allow a limiting projection 688.6 on the output adapter 688 to slide through when the torso lean actuator (J9) 680 is installed on the actuator mount 644.2.2 of the frame 644 as shown in FIG. 22.

c. Torso Lean Actuator

FIGS. 15 and 22-27 illustrate the torso lean actuator (J9) 680 (X-axis rotation relative to pelvis) in greater detail. The torso lean actuator (J9) 680 has a similar architecture to the other actuators shown herein, extends perpendicular to the torso twist actuator 620 (J10), and fastens to the torso lean housing 644.2 of the pelvis frame 644 near one end of the actuator (J9) 680 and to the output adaptor 688 on the opposite end of the actuator 680. The spine support assembly 692 couples to the end of the actuator (J9) 680 with the output adaptor 688 to connect the waist 604 to the pelvis 64 as shown in FIGS. 12-15.

FIGS. 22-27 illustrate an output side of the torso lean actuator 680 (J9) and its relation to the pelvis frame 644. As discussed above, the output adapter 688 is coupled to the output side of the torso lean actuator (J9) 680. The output adapter 688 includes: (i) an actuator projection 688.2, (ii) an output mount 688.4, and (iii) a limiting projection 688.6. The actuator projection 688.2 is coupled to the actuator (J9) 680 and extends axially forward away from the actuator (J9) 680 toward the spine support assembly 692. The output mount 688.4 is coupled to the first coupling portion 692.2.2 of the frame 692.2. The limiting projection 688.6 extends radially from the output mount 688.4 downward toward the frame 644.

As shown in FIGS. 15 and 22-27, the output mount 688.4 includes: (i) a forward-facing mounting surface 688.4.2, (ii) a central opening 688.4.4, and (iii) projections 688.4.6 that can be utilized to facilitate coupling with another component, e.g., the spine support assembly 692. The forward-facing mounting surface 688.4.2 faces away from the torso lean actuator (J9) 680 and engages with the first coupling portion 692.2.2 of the frame 692.2 of the spine support assembly 692. The center opening 688.4.4 extends through the output adapter 688 so that wiring may extend between the torso twist actuator (J10) 620 and the torso lean actuator (J9) 680. The projections 688.4.6 extend from the forward-facing mounting surface 688.4.2 toward the spine support assembly 692 and into the first coupling portion 692.2.2 of the frame 692.2.

As shown in FIG. 27, the limiting projection 688.6 is sized and shaped to fit between the motion limit stops 644.2.6.10 on the frame 644. The limiting projection 688.6 is configured to rotate with the output adapter 688 as the actuator (J9) 680 is activated and limit the range of motion of the actuator (J9) 680 by contacting the motion limit stops 644.2.6.10 on the frame 644. The limiting projection 688.6 has a circumferential dimension that reduces the available range of motion as shown in FIG. 27. For example, in the illustrated embodiment the motion limit stops 644.2.6.10 are set 40° in each direction from vertical, but the size of the limiting projection 688.6 occupies about 20° of this range, such that the actuator can rotate about 30° in each direction from a “zero” or “straight” configuration.

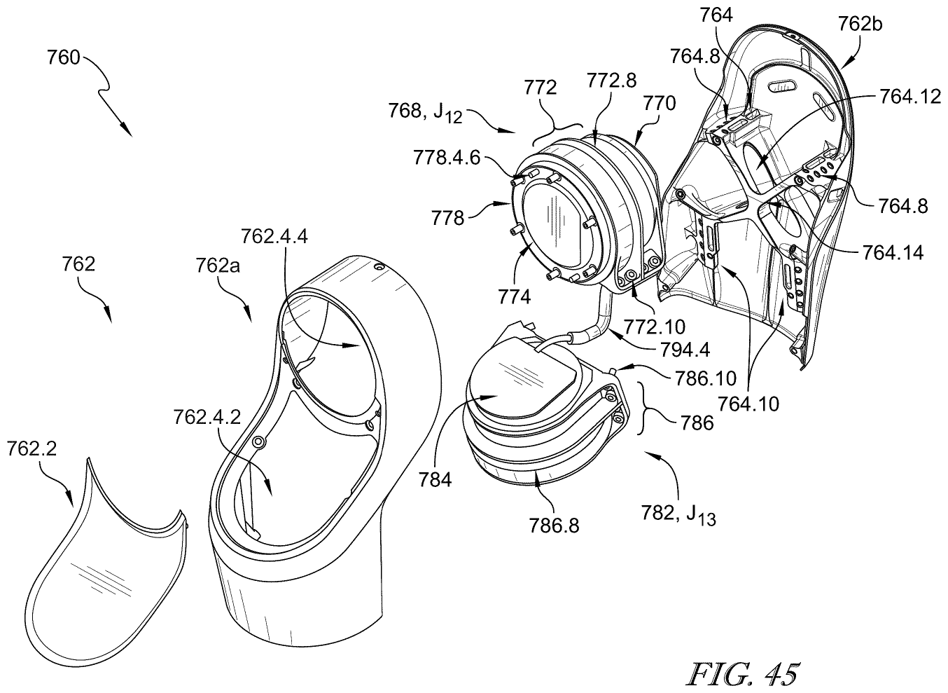

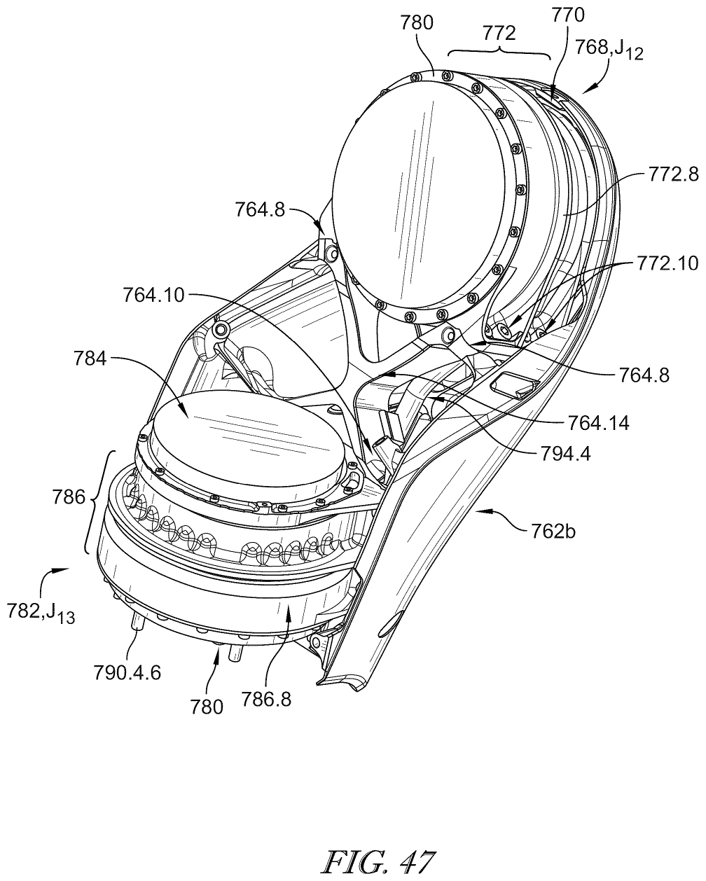

The partial cutaway view of FIG. 22, as well as the cross-sectional views of FIGS. 45 and 47, show additional components of the torso lean actuator (J9) 680. These include the output PCB assembly 686, the output adapter 688, the actuator 684, including through-bore 684.2 and internal wiring 684.4, the input PCB assembly 682, and the PCB cover 650. Also shown is the spine support assembly 692 that receives one end of the torso twist actuator (J10) 620 and the wiring 694.2 that couples the torso twist actuator J10 to the torso lean actuator (J9) 680 and passes power and control signals therethrough.

### I. Hip Assembly

The left and right hip assemblies are coupled to the pelvis 64, and specifically to the actuator mounts 644.6.4a, 644.6.4b of the pelvis frame 644. Said left and right hip assemblies include three actuators, which provide the robot 1 with three degrees of freedom. Said three actuators include: (i) a hip pitch actuator (J11) 720, (ii) a hip roll actuator (J12) 768, and (iii) a leg twist actuator (J13) 782. It should be understood that the hip pitch actuator (J11) 720, the hip roll actuator (J12) 768, and the leg twist actuator (J13) 782 are each assemblies that include the actuators J11, J12, J13 and additional parts to form the combined assembly. For example, the hip pitch actuator (J11) 720 is a component of the hip pitch actuator (J11) 720.

a. Hip Pitch Actuator

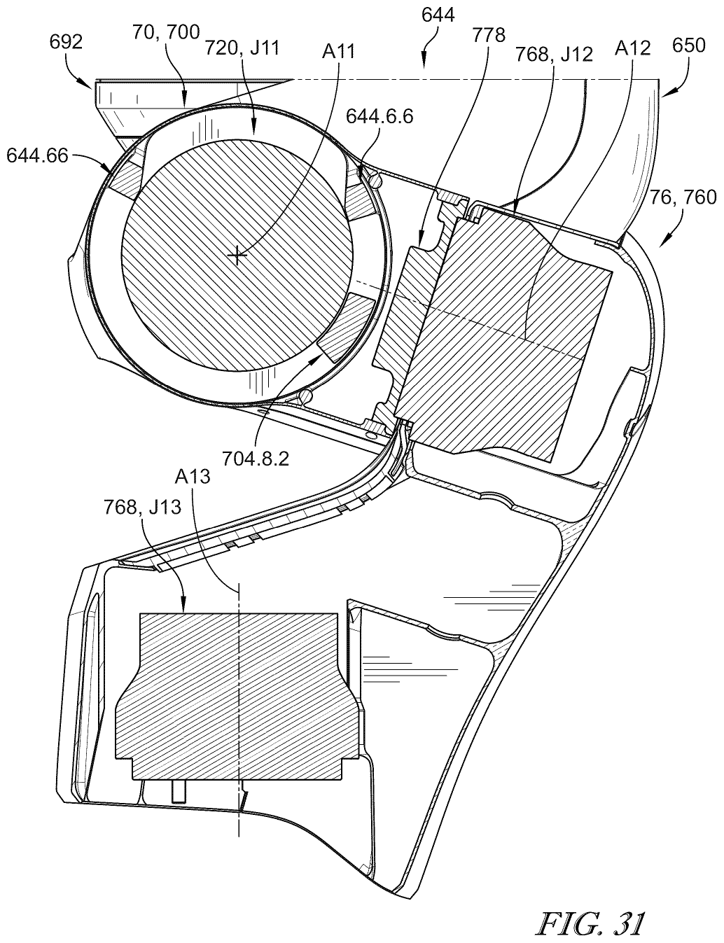

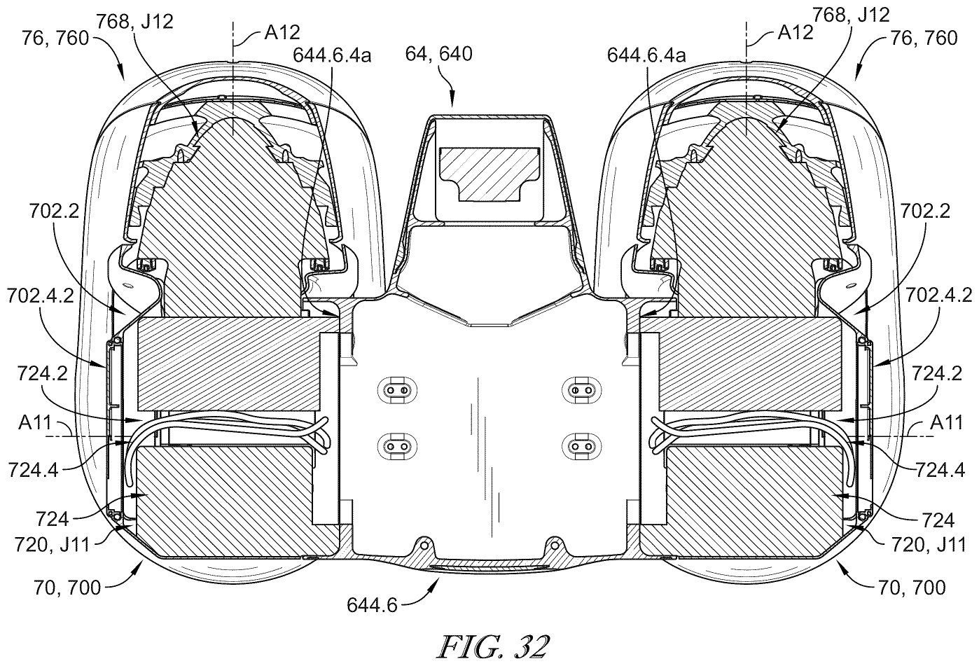

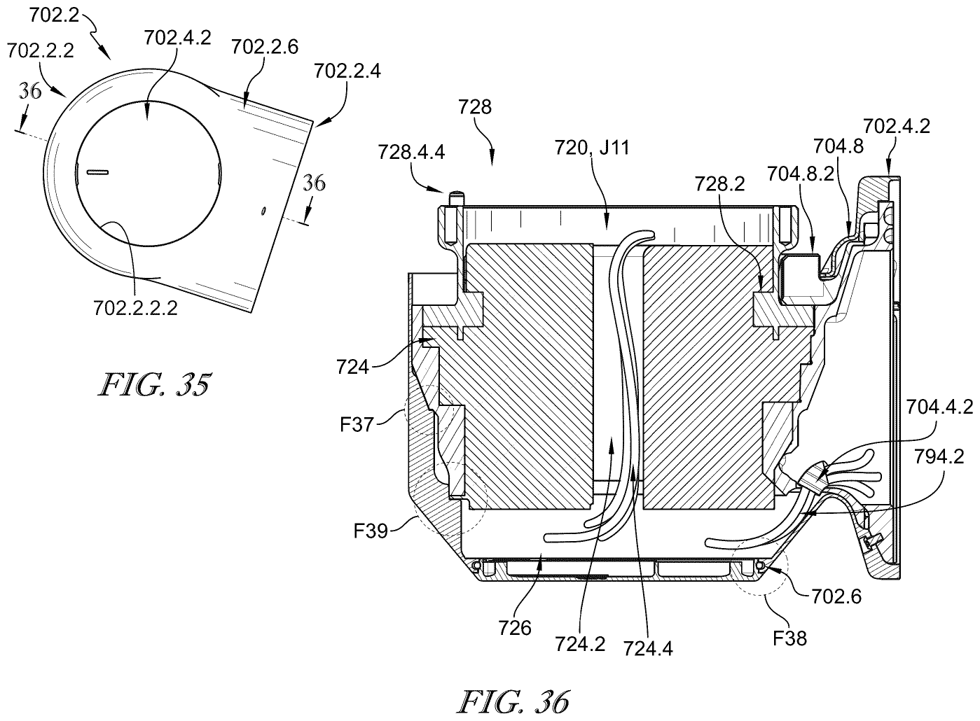

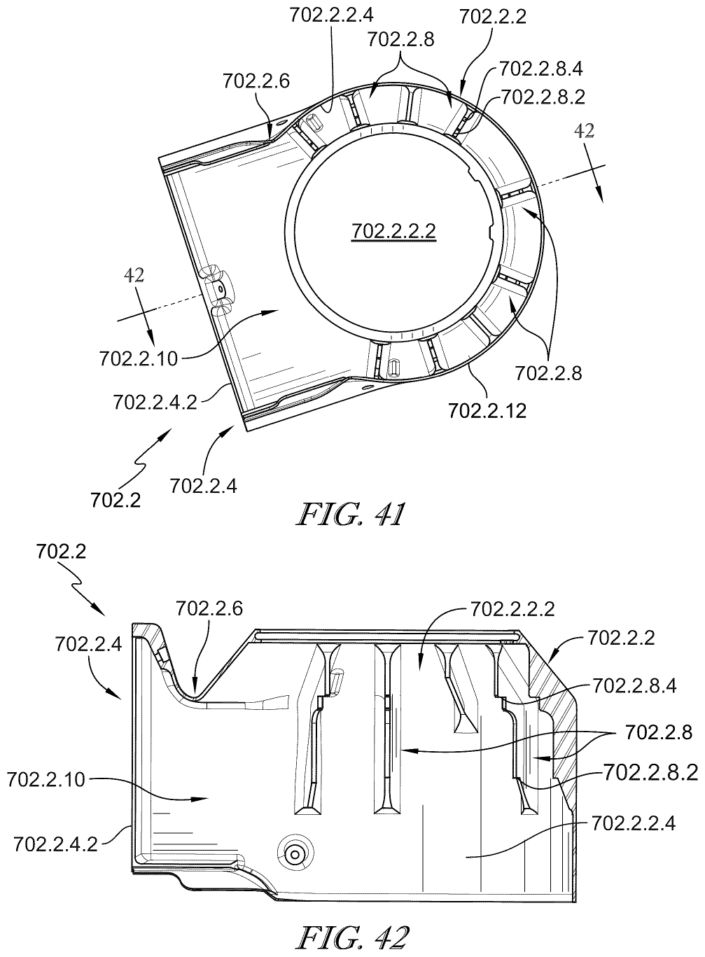

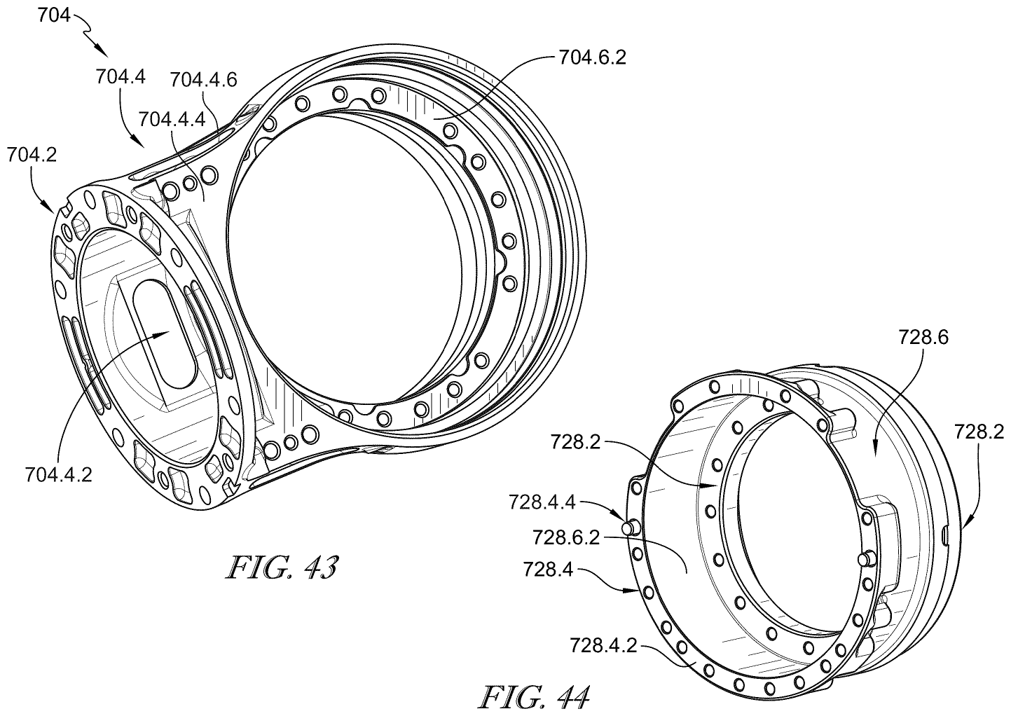

FIGS. 31-45 illustrate the hip 70, 700 and hip pitch actuator (J11) 720. The hip 70, 700 includes: (i) a housing 702 and (ii) a frame 704. Disposed inside the housing 702 is the hip pitch actuator (J11) 720. This actuator (J11) 720 serves as the connection point for each robot leg 6 to the pelvis 64. One end of each hip pitch actuator (J11) 720 is coupled to the respective actuator mount 644.6.4a, 644.6.4b of the frame 644 through an output adaptor or first extent 728. This coupling arrangement positions a portion of the hip pitch actuator (J11) 720 within the pelvis 64. The other end of the hip pitch actuator (J11) 720 is received within the frame 704 of the hip pitch actuator (J11) 720 and coupled therewith such that the frame 704 can be rotated or twisted relative to pelvis 64. A portion of the frame 704 or a second extent of the hip pitch actuator (J11) 720 is coupled to one end or a first extent of the hip roll actuator (J12) 768 housed in the upper thigh 76. The hip pitch actuator (J11) 720 includes an input PCB assembly 722, an actuator 724, an output PCB assembly 726, and an output adaptor or pelvis adapter 728.

i. Housing

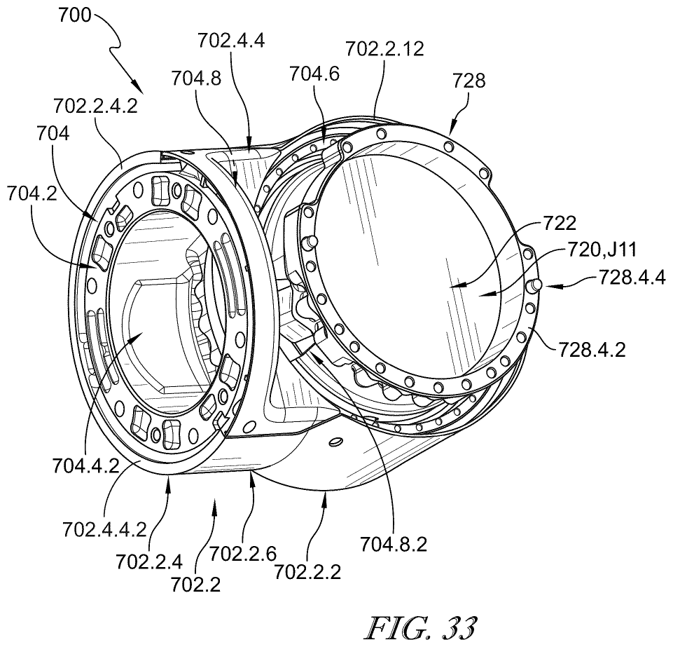

The housing 702 includes: (i) a main housing 702.2, (ii) a lateral outboard PCB cover 702.4.2, (iii) an inboard cover 702.4.4, (iv) a seal 702.6, and (v) fasteners as shown in FIGS. 33-43. The main housing 702.2 couples to the frame 704 to improve aesthetics and protect underlying components (e.g., the hip pitch actuator 720, J11). The main housing 702.2 has a similar shape and contour as the underlying frame 704 to ensure a close fit over the frame 704 and the underlying components. The PCB cover 702.4.2 couples to the main housing 702.2 and conceals and protects the output PCB assembly 726 of the hip pitch actuator (J11) 720, while also allowing access through an access aperture 702.2.2.2 formed in the main housing 702.2 via cover removal if desired. The inboard cover 702.4.4 couples to the frame 704 on a side of the frame 704 opposite the main housing 702.2 to improve aesthetics and protect underlying components (e.g., the hip pitch actuator (J11) 720). The inboard cover 702.4.4 has a similar shape and contour as the underlying frame 704 to ensure a close fit over the frame 704 while covering the exposed areas of the frame 704 not covered by the main housing 702.2. The seal 702.6 is arranged between the main housing 702.2 and the PCB cover 702.4.2 to help hold the cover 702.4.2 in place and prevent ingress of dust and/or liquid into the hip 70 and the hip pitch actuator (J11) 720 as shown in FIGS. 36 and 38. The fasteners couple the main housing 702.2 and the inboard cover 702.4.4 to the frame 704 and the PCB cover 702.4.2 to the main housing 702.2.

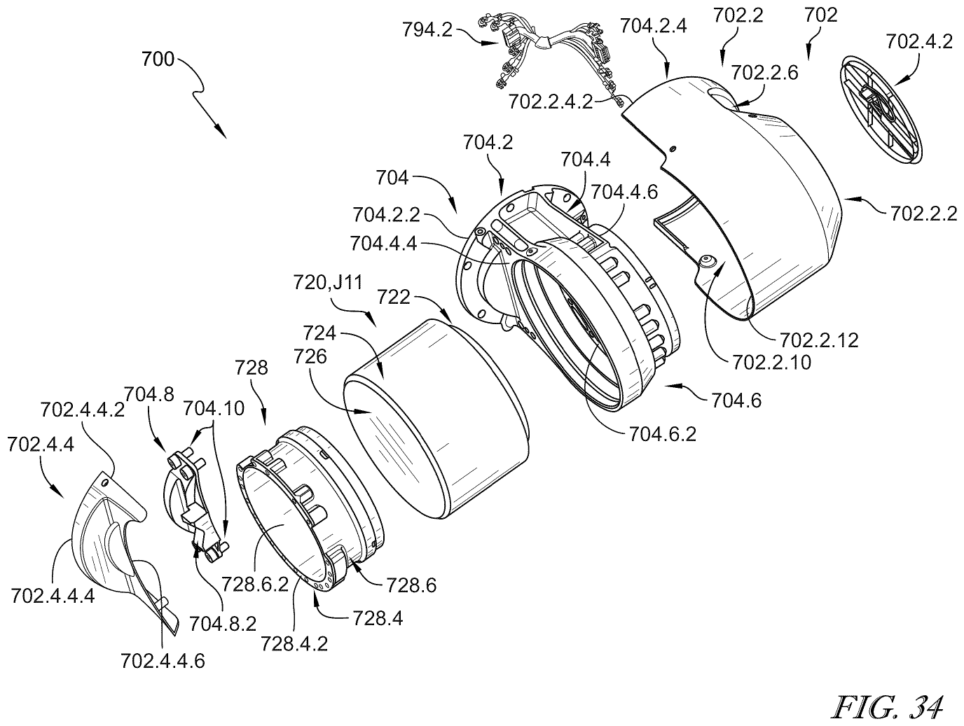

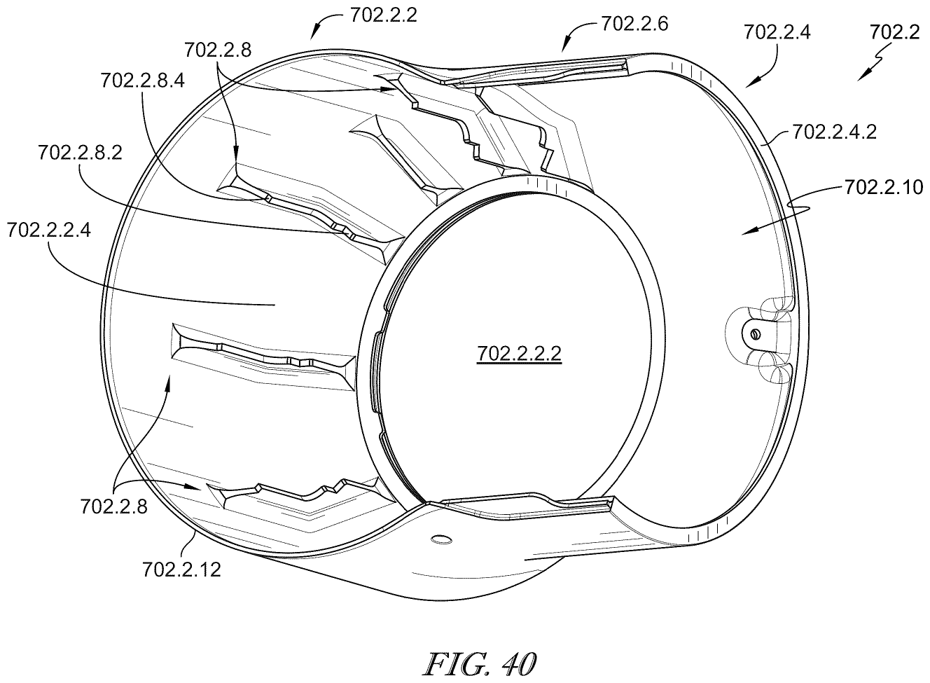

As shown in FIGS. 34-42, the main housing 702.2 includes (i) a first portion 702.2.2, (ii) a second portion 702.2.4, (iii) a connecting portion 702.2.6, and (iv) locating support ribs 702.2.8. The first portion 702.2.2 extends around a portion of the frame 704 that receives the hip pitch actuator (J11) 720 and defines the access aperture 702.2.2.2 to access the PCB assembly 726 of the hip pitch actuator (J11) 720. The second portion 702.2.4 extends around another portion of the frame 704 that couples to the hip roll actuator (J12) 768. The connecting portion 702.2.6 extends between and interconnects the first portion 702.2.2 and the second portion 702.2.4. Each of the locating support ribs 702.2.8 extend from an internal surface 702.2.2.4 of the first portion 702.2.2 and create shoulder surfaces 702.2.8.2, 702.2.8.4 that mate with (i) the portion of the frame 704 received by the first portion 702.2.2 of the main housing 702.2 and/or (ii) the hip pitch actuator (J11) 720 to ensure the desired engagement and position of the housing 702 over the frame 704 and the hip pitch actuator (J11) 720. The locating support ribs 702.2.8 are spaced apart circumferentially around the hip pitch actuator (J11) 720 as shown in FIGS. 40-42.

The first portion 702.2.2, the second portion 702.2.4, and the connecting portion 702.2.6 of the main housing 702.2 cooperate to define an opening 702.2.10 that is sized to allow the main housing 702.2 to be slid over the frame 704 from one side of the frame 704. As a result, a portion of the frame 704 and the hip pitch actuator (J11) 720 is exposed on the opposite side because the main housing 702.2 does not extend entirely or completely around the entire frame 704. The inboard cover 702.4.4 couples to the frame 704 from an opposite side of the main housing 702.2 and has a similar shape and contour of the frame 704. The inboard cover 702.4.4 is sized so as to extend over exposed areas of the frame 704 not covered by the main housing 702.2, while leaving access for a hip roll coupler 704.2 of the frame 704 at one end and the hip pitch actuator (J11) 720 at the other end.

As shown in FIGS. 33 and 34, the inboard cover 702.4.4 has (i) a mating surface 702.4.4.2 that engages and mates with a portion of a lip surface 702.2.12 of the main housing 702.2, (ii) a first end surface 702.4.4.4 that cooperates with an end surface 702.2.4.2 of the main housing 702.2, and (iii) a second end surface 702.4.4.6 that cooperates with a portion of the lip surface 702.2.12 of the main housing 702.2. The inboard cover 702.4.4 is coupled to the frame 704 in a position such that the first end surface 702.4.4.4 is flush with the end surface 702.2.4.2 of the second portion 702.2.4 and the second end surface 702.4.4.6 is aligned with the first portion 702.2.2. The first end surface 702.4.4.4 of the inboard cover 702.4.4 and the end surface 702.2.4.2 of the second portion 702.2.4 cooperate to allow access to the hip roll coupler 704.2 of the frame 704. The second end surface 702.4.4.6 of the inboard cover 702.4.4 and a portion of the lip surface 702.2.12 of the main housing 702.2 left exposed cooperate to allow access to the hip pitch actuator (J11) 720 so that the hip pitch actuator (J11) 720 may be coupled to the frame 644 of the pelvis 64.

ii. Frame

The frame 704, as shown in FIGS. 33-37, 44, and 45, includes: (i) a hip roll coupler 704.2, (ii) an extender 704.4, (iii) an actuator receiving assembly 704.6, and (iv) a bracket 704.8. The hip roll coupler 704.2, the extender 704.4, and the actuator receiving assembly 704.6 are integrally formed as a single-piece component in the illustrative embodiment. The bracket 704.8 is a separate piece component that is coupled to the extender 704.4 with fasteners 704.10 as shown in FIG. 34. The bracket 704.8 defines a limiting projection 704.8.2 configured to interfere with the motion limit stops 644.6.6 formed on the pelvis frame 644 to limit the range of motion of the hip pitch actuator (J11) 720.

In some embodiments, the bracket 704.8 may be integrally formed with the hip roll coupler 704.2, the extender 704.4, and the actuator receiving assembly 704.6 so that the limiting projection 704.8.2 is integrally formed with the frame 704. The actuator receiving assembly 704.6 is configured to receive hip pitch actuator (J11) 720. The hip roll coupler 704.2 is configured to couple with the hip roll actuator (J12) 768 housed in the upper thigh 76. The extender 704.4 extends between and interconnects the hip roll coupler 704.2 and the actuator receiving assembly 704.6. The extender 704.4 is configured to separate the actuators (J11, J12) and includes a passage 704.4.2 for wiring 794.2 so that the wiring can extend from the output PCB assembly 726 of the actuator 724 to the output PCB assembly 774 of the hip roll actuator (J12) 768.

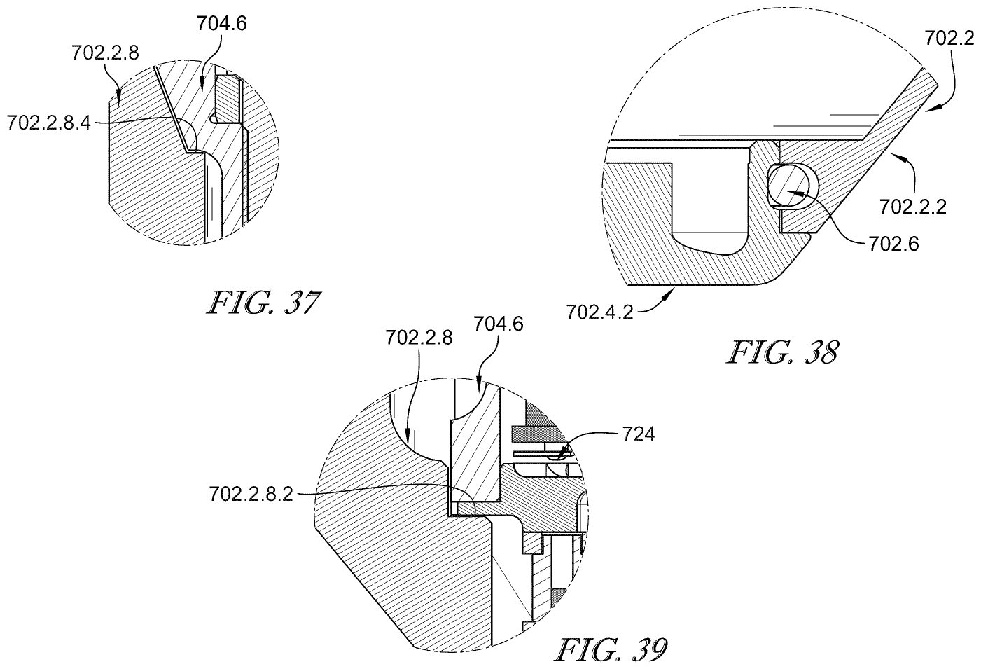

As shown in FIG. 36, the actuator receiving assembly 704.6 of the frame 704 is at least partially surrounded by the first portion 702.2.2 of the main housing 702.2, the hip roll coupler 704.2 is at least partially surrounded by the second portion 702.2.4 of the main housing 702.2, and the extender 704.4 is at least partially surrounded by the connecting portion 702.2.6 of the main housing 702.2. With the main housing 702.2 arranged over the frame 704, the actuator receiving assembly 704.6 of the frame 704 engages the shoulder surfaces 702.2.8.2 of the locating support ribs 702.2.8 as shown in FIGS. 36 and 37.

The bracket 704.8 defines the limiting projection 704.8.2 as shown in FIGS. 31-36. The limiting projection 704.8.2 is configured to interfere with the motion limit stops 644.6.6 formed on the pelvis frame 644 to limit the range of motion of the hip pitch actuator (J11) 720. As shown in FIG. 31, the limiting projection 704.8.2 is sized and shaped to fit between the motion limit stops 644.6.6 on the frame 644 of the pelvis 64. The limiting projection 704.8.2 is configured to rotate with the frame 704 as the actuator (J11) 720 is activated and limit the range of motion of the actuator (J11) 720 by contacting the motion limit stops 644.6.6 on the frame 644. The limiting projection 704.8.2 has a circumferential dimension that reduces the available range of motion as shown in FIG. 31. For example, in the illustrated embodiment the motion limit stops 644.6.6 are set 40° in each direction from vertical, but the size of the limiting projection 704.8.2 occupies about 20° of this range, such that the actuator can rotate about 30° in each direction from a “zero” or “straight” configuration.

iii. Coupling to Hip Pitch Actuator

The hip pitch actuator (J11) 720 is coupled to the actuator receiving assembly 704.6 of the frame 704 such that the frame 704 can be rotated or twisted relative to pelvis 64. The hip pitch actuator (J11) 720 includes the actuator 724, the output PCB assembly 726, and the output adaptor or pelvis adapter 728. The hip pitch actuator (J11) 720 serves as the connection point for each robot leg 6 to the pelvis 64 through the output adaptor 728. Each hip pitch actuator (J11) 720 is coupled to the pelvis 64 through the output adapter 728 such that (i) the hip pitch actuator (J11) 720 is positioned below the torso lean actuator (J9) 680, (ii) the hip pitch actuator (J11) 720 is positioned below the torso twist actuator (J10) 620, and (iii) the hip pitch axis of rotation A₁₁ of the hip pitch actuator (J11) 720 intersects the torso twist axis of rotation A₁₀ of the torso twist actuator (J10) 620.

As shown in FIGS. 33-36 and 44, the output adapter 728 includes (i) an actuator mount 728.2, (ii) a pelvis mount 728.4, and (iii) an extender wall 728.6 that extends between and interconnects the actuator mount 728.2 and the pelvis mount 728.4. The actuator mount 728.2 couples to a portion of the actuator 724 of the hip pitch actuator (J11) 720 using a plurality of threaded fasteners. The frame 704 is coupled to the other end of the actuator 724 of the hip pitch actuator (J11) 720 so that the frame 704 may be rotated relative to the output adapter 728. The pelvis mount 728.4 couples to the side of the pelvis frame 644, i.e., the respective actuator mount 644.6.4a, 644.6.4b of the frame 644, using a plurality of threaded fasteners (e.g., bolts). The fasteners can be positioned such that they are hidden from view outside the pelvis 64 and are accessible and visible from inside the recess defined by the pelvis frame 644. Removal of the top and bottom covers 648.2, 648.4.2, 648.4.4 of the pelvis 64 can facilitate access to the fasteners joining the hips and legs to the pelvis 64.

The pelvis mount 728.4 has a mounting surface 728.4.2 that abuts the respective actuator mount 644.6.4a, 644.6.4b of the pelvis frame 644 when the output adaptor 728 is coupled to the pelvis frame 644. The pelvis mount 728.4 may also include projections 728.4.4 that extend from the mounting surface 728.4.2 into bores and/or slots formed on the actuator mount 644.6.4a, 644.6.4b of the pelvis frame 644 to facilitate coupling with the pelvis frame 644. The actuator mount 728.2 extends away from an interior surface 728.6.2 of the extender wall 728.6 at a location spaced apart from the pelvis mount 728.4 as shown in FIG. 44. The actuator 724 can include an input PCB assembly 722 that can receive power and control signals through wiring 734.2a, 734.2b disposed within the pelvis frame 644. This wiring can, in turn, be coupled to wires 732.4 that extend from the torso 16. Internal wiring 724.4 can extend through a bore 724.2 in the actuator 724 to connect the input PCB assembly 722 with the output PCB assembly 726. Further, wiring 794.2 can couple the output PCB assembly 726 with the output PCB assembly 774 of the hip roll actuator (J12) 768 to pass power and control signals thereto.

b. Hip Roll and Twist Actuator Assemblies

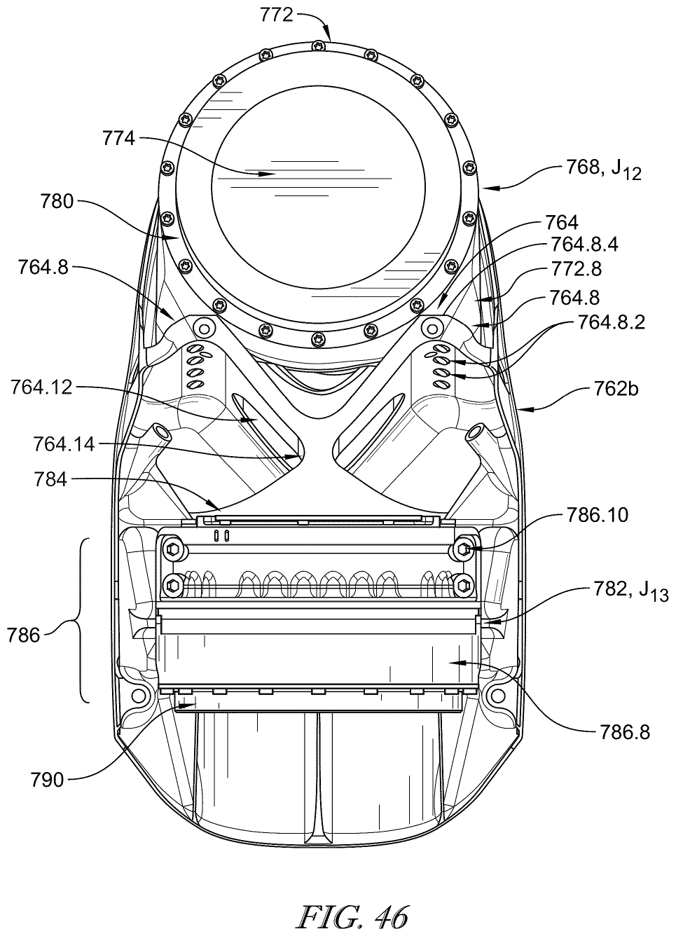

FIGS. 46-53 illustrate the upper thigh 76, 760 and the hip roll and leg twist actuator assemblies J12, J13. The upper thigh 76, 760 includes an upper thigh housing 762 and an internal support frame 764. Disposed inside the housing 762 are the hip roll actuator (J12) 768 and a first extent of the leg twist actuator (J13) 782, which are mounted to the support frame 764. A first extent of the hip roll actuator (J12) 768 is coupled to aa second extent of the hip pitch actuator (J11) 720 through the hip roll coupler 704.2 of the frame 704. The input of the hip roll actuator (J12) 768 is coupled to a portion of the frame 764. Another portion of the frame 764 can further couple with the input of the leg twist actuator (J13) 782. The lower thigh 80 and the remainder of the lower leg 6 can be coupled to the output of the leg twist actuator (J13) 782. The hip roll actuator 768 (J12) includes an input PCB assembly 770, an actuator 772, an output PCB assembly 774, and an output adaptor 778. The leg twist actuator 782 (J13) includes an input PCB assembly 784, an actuator 786, an output PCB assembly 788, and an output adaptor 790.

i. Housing

The housing 762 includes: (i) a front housing 762a, (ii) a rear housing 762b, and (iii) a cover 762.2 as shown in FIGS. 46-53. The front housing 762a couples or mounts to the rear housing 762b using threaded fasteners and serves to conceal the actuator assemblies. Similarly, the cover 762.2 couples to the front housing 762a to cover the input PCB assembly 784 of the leg twist actuator (J13) 782 to protect these components and improve aesthetics when access is not required. The front housing 762a defines (i) a first actuator access opening 762.4.2 and (ii) a second actuator access opening 762.4.4 as shown in FIG. 45. The first actuator access opening 762.4.2 allows for access to the input PCB assembly 784 of the leg twist actuator (J13) 782 when the cover 762.2 is removed. The second access opening 762.4.4 allows access to the output of the hip roll actuator (J12) 768 so that the hip roll actuator (J12) 768 may be coupled to the hip roll coupler 704.2 of the frame 704. In some embodiments, the actuator access openings 762.4.2, 762.4.4 may be a single opening and the cover 762.2 may only cover a portion of the single opening to block access to the input PCB 784 of the leg twist actuator (J13) 782 while still allowing access to the output of the hip roll actuator (J12) 768. As shown in FIGS. 46-53, the rear housing 762b of the housing 762 is integrally formed with the internal support frame 764 such that the rear housing 762b and the frame 764 are a single piece component. In some embodiments, the frame 764 may be: (i) integrally formed with the front housing 762a, (ii) formed separately and coupled to the rear housing 762b using fasteners, (iii) or formed separately and coupled to the front housing 762a using fasteners.

ii. Frame

The frame 764 includes: (i) upper mounting pads 764.8, (ii) lower mounting pads 764.10, and (iii) supporting ribs 764.14 as shown in FIGS. 46-53. The upper mounting pads 764.8 are located near or closer to an upper end 762.4.2 of the rear housing 762b and the lower mounting pads 764.10 are located near or closer to a lower end 764.4.4 of the rear housing 762b opposite the upper end 762.4.2. The opposed upper and lower mounting pads 764.8, 764.10 have bores 764.8.2, 764.10.2 formed therein to receive fasteners 772.10, 786.10 to couple housings 772.8, 786.8 of actuators 772, 786 to the frame 764. The supporting ribs 764.14 extend between and interconnect the upper and lower mounting pads 764.8, 764.10 to provide strength. As shown in FIGS. 46-53, the support ribs 764.14 form a central “X” pattern between the upper and lower mounting pads 764.8, 764.10. A central opening 764.12 extending through the crossing support ribs 764.14 of the frame 764 can allow for passage of the wiring 794.4 between the hip roll and leg twist actuator assemblies J12, J13.

As shown in FIGS. 45-46 and 50-53 the upper mounting pads 764.8 and the lower mounting pads 764.10 each have a mating surface 764.8.4, 764.10.4 that abuts or engages a portion of the actuator 772, 786, e.g., a housing 772.8, 786.8. The mating surfaces 764.8.4, 764.10.4 have a similar shape and contour as the housing 772.8 to help facilitate coupling the respective actuator, i.e., the hip roll actuator (J12) 768 and the leg twist actuator (J13) 782, to the frame 764. The bores 764.8.2, 764.10.2 extend into the mating surfaces 764.8.4, 764.10.4 so that the fasteners 772.10, 786.10 may be inserted through the housing 772.8, 786.8 into the upper mounting pads 764.8 or the lower mounting pads 764.10.

iii. Coupling to Hip Roll and Twist Actuator Assemblies

FIGS. 46-53 illustrate the hip roll and twist actuator assemblies J12, J13 in greater detail. The hip roll actuator (J12) 768 can be similar to the actuator assemblies described above. For example, it can include an electric rotary actuator with two portions that can rotate relative to one another when activated. One portion or second extent of the actuator 772, e.g., the housing 772.8, can be coupled to the frame 764 of the rear housing 762b and another portion or first extent that rotates relative to the housing can be coupled to the hip pitch actuator (J11) 720 via an output adapter 778. The output adapter 778 can include projections 778.4.6 that can extend into bores and/or slots formed on the pelvis mount 728.4 of the hip pitch actuator (J11) 720. Each hip roll actuator (J12) 768 is coupled to the frame 764 of the thigh 76 such that (i) the hip roll actuator (J12) 768 is positioned adjacent to the hip pitch actuator 720 (J11) and (ii) if extended the hip roll axis A₁₂ of the hip roll actuator (J12) 768 intersects the hip pitch axis A₁₁ of the hip pitch actuator (J11) 720.

An output PCB assembly 774 can receive power and control signals through wiring 794.2 that come from the hip pitch actuator (J11) 720. Such power and control signals can be passed through the actuator 772 via internal wiring 772.4 (extending through an internal bore 772.2, see FIG. 49) to an input PCB assembly 770. Such power and control signals can further be carried to the leg twist actuator (J13) 782 via wiring 794.4, which couples with an input PCB assembly 784. Such power and control signals can similarly be passed through the actuator 786 via internal wiring 786.4 (extending through an internal bore 786.2, see FIG. 49) to an output PCB assembly 788 of the leg twist actuator (J13) 782. Transmission of power and control signals can be extended to further extremities of the robot in a similar manner. Coupling the various actuators of the robot 1 using discrete connections between adjacent actuators and/or extending through actuators can facilitate modular assembly of the robot 1. This can also facilitate a greater range of motion for the robot 1, as each wire length or connection can be configured to allow for the movement of the particular joint or area through which it travels. This avoids the need to run a single wired connection from, for example, a core to an extremity of the robot while traversing several joints and providing sufficient length and strain relief to accommodate the various movement patterns that can occur.

The leg twist actuator (J13) 782 can be similar to the hip roll actuator (J12) 768. For example, it can include an electric rotary actuator with two portions that can rotate relative to one another when activated. One portion or a first extent of the actuator 786, e.g., a housing 786.8, can be coupled to the frame 764 of the rear housing 762b and another portion or a second extent that rotates relative to the housing can be coupled to the lower thigh 80 and remainder of the robot leg 6 via an output adapter 790. The output adapter 790 can include projections 790.4.6 that can extend into bores and/or slots formed on an upper portion of the lower thigh 80. Each leg twist actuator (J13) 782 is coupled to the frame 764 of the thigh 76 such that (i) the leg twist actuator (J13) 782 is positioned below the hip roll actuator (J12) 768 and (ii) if extended, the leg twist axis A₁₃ of the leg twist actuator (J13) 782 intersects the hip roll axis A₁₂ of the hip roll actuator (J12) 768.

### J. Wiring

As shown herein, wire sets/bundles 684.4, 694.2, 724.4, 734.2a, 734.2b, 772.4, 786.4, 794.4 are electrically coupled the following actuators to one another, whether directly or indirectly: (i) the torso twist actuator J10, (ii) the torso lean actuator J9, (iii) the hip pitch actuator (J11) 720, (iv) the hip roll actuator (J12) 768, and (v) the leg twist actuators (J13) 782. Accordingly, the wiring (i.e., a single wire or wire set/bundle) to connect, power, and control the actuators does not extend across multiple actuators. Stated another way, said single wire or wire set/bundle does not extend across multiple degrees of freedom. This helps ensure that the electrical power and control wires for each actuator (e.g., J9-J13) are not accidentally pinched, cut, or damaged by the movement of said actuators. The wire bundles are used to connect the electrical current from one side of an actuator to the other side of an actuator, and continue to the next actuator.

To prevent a single wire or wire bundle from extending across multiple actuators, three sets or bundles of wires are utilized in connection with a single actuator: (i) an input wire set/bundle to an input PCB, (ii) an internal wire set/bundle connecting the input PCB to an output PCB, and (iii) an output wire set/bundle from the output PCB, where the output wire set/bundle from one actuator may be the input wire set/bundle to the next actuator. The power may be connected to either the input or the output PCB. Each actuator (e.g., actuators J9-13) has a fixed input on a frame side and a moving output on the face of the actuator. It should be understood that in other embodiments, other wire configurations or coupling methods may be utilized. For example, said electrical wiring and control wires may be formed within the robot's shell or outer layers. In this example, each actuator would be connected to said shell/outer-based wire using a single bundle of wires. In another example, one or two wire sets/bundles may be utilized instead of three wire sets/bundles. More than three wire sets/bundles (e.g., for to ten) may be used in further alternative embodiments.

Generally, each actuator is coupled to the following actuator using a single wire grouping. This is accomplished by coupling one PCB assembly of one actuator to one PCB assembly of an adjacent actuator. As discussed above, it should be understood that each of these wire groups includes multiple wires. In an alternative embodiment, said wire groups may include multiple wires coupled to one another in a lengthwise/serial configuration. In other words, a single wire contained within the wire group may be fabricated from a plurality (e.g., between 1 and 10) of wires that are connected in series. Further, it should be understood that each wire contained within the wire group may include a single conductive wire strand, but preferably multiple conductive wire strands. The said conductive wire strands may be encased by a non-conductive sleeve and may be linearly arranged with one another, twisted relative to one another, in a helix configuration, or any other known arrangement of strands within a wire.

To pass the electrical signals and current from a PCB assembly on one side of an actuator to a PCB assembly on an opposite side of an actuator, each actuator may include an opening or a through-bore formed through the center of said actuator and is referred to in this Application as the through-bore (e.g., through-bores 684.2, 724.2, 772.2, 786.2, etc.). As shown in the Figures, the through-bore extends completely through the actuator. By extending said through-bore completely through the actuators, the internal wire groups can be positioned within these through-bores in order to couple the PCB assemblies on opposite sides of the actuator assemblies (e.g., input and output PCB assemblies). This is beneficial because it eliminates the need to route the wires or make conductive paths that extend over a rotating joint, which in turn increases the durability of the robot 1. As shown in FIG. 11, the torso twist actuator (J10) 620 has a through-bore, but the associated wiring is not passed therethrough.

### K. Distances and Angles

TABLE 2

| Distance | Lower | Upper | Preferred Lower | Preferred Upper |
|---|---|---|---|---|
| (mm) | Bound | Bound | Bound | Bound |
| D4 | 7 | 11 | 8 | 10 |
| D5 | 7 | 11 | 8 | 10 |

TABLE 3

| Angle | Lower | Upper | Preferred Lower | Preferred Upper |
|---|---|---|---|---|
| (Degrees) | Bound | Bound | Bound | Bound |
| Q4 | 24 | 36 | 27 | 33 |
| Q5 | 24 | 36 | 27 | 33 |
| Q6 | 122 | 183 | 137 | 167 |
| Q7 | 71 | 107 | 80 | 98 |
| Q8 | 64 | 95 | 72 | 87 |
| Q9 | 104 | 156 | 117 | 143 |
| Q12 | 28 | 42 | 32 | 39 |
| Q13 | 31 | 46 | 35 | 42 |
| Q14 | 14 | 22 | 16 | 20 |
| Q15 | 106 | 159 | 119 | 146 |

### L. Industrial Application

While the disclosure shows illustrative embodiments of a robot (in particular, a humanoid robot), it should be understood that embodiments are designed to be examples of the principles of the disclosed assemblies, methods, and systems, and are not intended to limit the broad aspects of the disclosed concepts to the embodiments illustrated. As will be realized, the disclosed robot, and its functionality and methods of operation, are capable of other and different configurations and several details are capable of being modified all without departing from the scope of the disclosed methods and systems. For example, one or more of the disclosed embodiments, in part or whole, may be combined with a disclosed assembly, method and system. As such, one or more steps from the diagrams or components in the Figures may be selectively omitted and/or combined consistent with the disclosed assemblies, methods, and systems. Additionally, one or more steps from the arrangement of components may be omitted or performed in a different order. Accordingly, the drawings, diagrams, and detailed description are to be regarded as illustrative in nature, not restrictive or limiting, of the said humanoid robot.

While the above-described robot is designed as a general-purpose humanoid robot, it should be understood that its assemblies, components, learning capabilities, and/or kinematic capabilities may be used with other robots. Examples of other robots include: articulated robot (e.g., an arm assembly having two, six, or ten degrees of freedom, etc.), a cartesian robot (e.g., rectilinear or gantry robots, robots having three prismatic joints, etc.), Selective Compliance Assembly Robot Arm (SCARA) robots (e.g., with a donut shaped work envelope, with two parallel joints that provide compliance in one selected plane, with rotary shafts positioned vertically, with an end effector attached to an arm, etc.), delta robots (e.g., parallel link robots with parallel joint linkages connected with a common base, having direct control of each joint over the end effector, which may be used for pick-and-place or product transfer applications, etc.), polar robots (e.g., with a twisting joint connecting the arm with the base and a combination of two rotary joints and one linear joint connecting the links, having a centrally pivoting shaft and an extendable rotating arm, spherical robots, etc.), cylindrical robots (e.g., with at least one rotary joint at the base and at least one prismatic joint connecting the links, with a pivoting shaft and extendable arm that moves vertically and by sliding, with a cylindrical configuration that offers vertical and horizontal linear movement along with rotary movement about the vertical axis, etc.), self-driving car, a kitchen appliance, construction equipment, or a variety of other types of robot systems. The robot system may include one or more sensors (e.g., cameras, temperature, pressure, force, inductive or capacitive touch), motors (e.g., servo motors and stepper motors), actuators, biasing members, encoders, housing, or any other component known in the art that is used in connection with robot systems. Likewise, the robot system may omit one or more sensors (e.g., cameras, temperature, pressure, force, inductive or capacitive touch), motors (e.g., servo motors and stepper motors), actuators, biasing members, encoders, housing, or any other component known in the art that is used in connection with robot systems.

In other embodiments, other configurations and/or components may be utilized. As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. The server functions may be implemented in a distributed fashion on a number of similar platforms, to distribute the processing load.

Hence, aspects of the disclosed methods and systems outlined above may be embodied in programming. Program aspects of the technology may be thought of as “products” or “articles of manufacture” typically in the form of executable code and/or associated data that is carried on or embodied in a type of machine-readable medium. “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

A machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the disclosed methods and systems. Volatile storage media include dynamic memory, such as the main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is to be understood that the invention is not limited to the exact details of construction, operation, exact materials, or embodiments shown and described, as obvious modifications and equivalents will be apparent to one skilled in the art. While the specific embodiments have been illustrated and described, numerous modifications come to mind without significantly departing from the spirit of the invention, and the scope of protection is only limited by the scope of the accompanying Claims. It should also be understood that substantially utilized herein means a deviation less than 15% and preferably less than 5%. It should also be understood that near means within 10 cm, proximate means within 5 cm, and adjacent means within 1 cm. It should also be understood that other configuration or arrangements of the above-described components is contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

It should also be noted that any couplers, fasteners, and any other securement members disclosed herein may be replaced, modified, supplemented with any one of the following coupling means may include or exclude threaded fasteners (e.g., bolts, screws, studs), projections (e.g., tabs, bosses, barbs), snap-fit connectors (integral snap hooks, living hinges), bayonet mounts, pin-and-hole connections (e.g., clevis pins, hitch pins), press-fit/interference fits, clamp or clip mechanisms, magnets (permanent, electromagnetic), hook-and-loop, rivets (solid, blind/pop, tubular), ball detent connectors, sliding rails, cam locks, toggle clamps, quick-release pins (e.g., detent pins, lynch pins), spring-loaded connectors (e.g., pogo pins, spring clips), wedge locks, dowel pins, ratchet mechanisms, T-slot connectors, twist locks, latches (rotary, draw latches), locking tabs (push-in, fold-over), key-and-keyway (keyed shafts, couplings), set screws (grub screws), collets, locking collars (split collars, clamping collars), adhesives (epoxies, cyanoacrylates, etc.), welding (e.g., MIG, TIG, spot, friction-stir, laser-based, electron beam), shrink fits (thermal interference fit), brazing (silver, brass, etc.), soldering, ultrasonic welding, heat staking, forging (hot or cold), inertial/friction welding, press-brake or folding locks (sheet metal bends forming locking tabs), spiral or snap rings (circlips, retaining rings), buckles (strap-based), puzzle-like interlocks (machined or molded geometries), toggle latches (over-center latch mechanisms), locking wedges, swaging (deforming material into a mating feature), any combination or hybrid of the above.

Further, each of the above described exoskeletons, housing, and/or frames may be made from any known material, including aluminum alloys, titanium alloys, steel alloys, carbon fiber reinforced polymers (CFRP), glass fiber reinforced polymers (GFRP), polyether ether ketone (PEEK), polyamide (PA), polyphenylene sulfide (PPS), magnesium alloys, brass, nylon. Additionally, said housing 104 may be formed using any known method, including CNC machining, milling, turning, grinding, electrical discharge machining (EDM), stamping, deep drawing, die casting, sand casting, investment casting, injection molding, insert molding, over-molding, compression molding, selective laser sintering (SLS), selective laser melting (SLM), fused deposition modeling (FDM), stereolithography (SLA), direct metal laser sintering (DMLS), binder jetting, laminated object manufacturing (LOM), resin transfer molding (RTM), vacuum infusion, filament winding, sheet metal fabrication, laser cutting, waterjet cutting, plasma cutting, press brake forming, roll forming, extrusion, pultrusion, blow molding, thermoforming, vacuum forming, lost foam casting, hot isostatic pressing (HIP), cold spray additive manufacturing, any combination thereof, and/or any other similar manufacturing type or method.

In this application, to the extent any U.S. patents, U.S. patent applications, or other materials (e.g., articles) have been incorporated by reference, the text of such materials is only incorporated by reference to the extent that they do not conflict with materials, statements and drawings set forth herein. In the event of such conflict, the text of the present document controls, and terms in this document should not be given a narrower reading in virtue of the way in which those terms are used in other materials incorporated by reference. It should also be understood that structures and/or features not directly associated with a robot cannot be adopted or implemented into the disclosed humanoid robot without careful analysis and verification of the complex realities of designing, testing, manufacturing, and certifying a robot for completion of usable work nearby and/or around humans. Theoretical designs that attempt to implement such modifications from non-robotic structures and/or features are insufficient (and in some instances, woefully insufficient) because they amount to mere design exercises that are not tethered to the complex realities of successfully designing, manufacturing and testing a robot.

1. A humanoid robot, comprising:
a torso coupled to a waist, an arm assembly, and a head and neck assembly, and wherein the waist includes:
a main body;
a torso twist actuator having: (i) a first extent coupled to the main body, (ii) a second extent, and (iii) a torso twist axis that is coplanar with a coronal plane of the humanoid robot, when the humanoid robot is in a neutral position;
a pelvis having:
a pelvis frame coupled to a left hip assembly and a right hip assembly;
a torso lean actuator coupled to the pelvis frame and including: (i) a portion that is positioned within said pelvis frame, (ii) a first extent, and (iii) a torso lean axis; and
a spine support assembly coupled to the second extent of the torso twist actuator and the first extent of the torso lean actuator, and wherein a spine angle is formed between the torso twist axis and the torso lean axis, when the humanoid robot is in the neutral position.

2. The humanoid robot of claim 1, wherein the left hip assembly and the right hip assembly each include a hip pitch actuator having a portion positioned within the pelvis frame, a first extent coupled to an actuator mount of the pelvis frame, a second extent, and a hip pitch axis.

3. The humanoid robot of claim 2, wherein the pelvis frame includes motion limit stops integrally formed with the pelvis frame and configured to limit the range of motion of each hip pitch actuator to between 10 degrees and 40 degrees backward and to between 145 degrees and 175 degrees forward.

4. The humanoid robot of claim 2, wherein the left hip assembly and the right hip assembly each include a hip roll actuator having a first extent coupled to the second extent of the hip pitch actuator, a second extent, and a hip roll axis, wherein a non-90 degree angle is formed between a reference plane that is parallel with a transverse plane of the humanoid robot and the hip roll axis.

5. The humanoid robot of claim 4, wherein the left hip assembly and the right hip assembly each include a leg twist actuator: (i) having a first extent coupled to the second extent of the hip roll actuator, and a second extent, and (ii) positioned below an extent of both the hip pitch actuator and the hip roll actuator.

6. The humanoid robot of claim 5, wherein the hip pitch actuators, hip roll actuators, and leg twist actuators of the left and right hip assemblies each include a cross-roller bearing and a through-bore for internal wiring.

7. The humanoid robot of claim 5, wherein the leg twist actuators of the left and right hip assemblies each include a leg twist axis that is substantially parallel with the torso twist axis when the humanoid robot is in the neutral position.

8. The humanoid robot of any of claim 1, wherein the torso lacks an actuator configured to allow the robot to move its torso toward a support surface that supports the humanoid robot.

9. The humanoid robot of any of claim 1, wherein the humanoid robot lacks a rotary actuator that is aligned with and positioned below the torso twist axis.

10. A humanoid robot, comprising:
a lower region configured to be in contact with a support surface upon which the humanoid robot works;
a central region coupled to the lower region and having:
a waist with a torso twist actuator with a torso twist axis;
a leg twist actuator with a leg twist axis, and wherein the leg twist axis and the torso twist axis are arranged substantially parallel with one another when the humanoid robot is in a neutral position; and
an upper region coupled to the central region and having:
a head and neck assembly,
an arm assembly, and
a torso coupled to the waist and lacking an actuator that is both positioned above the torso twist actuator and is configured to allow the robot to move its torso toward the support surface.

11. The humanoid robot of claim 10, further comprising a pelvis coupled to the waist and having a left side with a left actuator mount and a right side with a right actuator mount.

12. The humanoid robot of claim 11, further comprising an inertial measurement unit mounted to a planar surface on a rear bottom portion of the pelvis and configured to serve as a reference point for determining positions of other robot components.

13. The humanoid robot of claim 11, further comprising left and right hip assemblies coupled to the left and right actuator mounts respectively, each hip assembly including a hip pitch actuator, a hip roll actuator, and a leg twist actuator.

14. The humanoid robot of claim 13, further comprising a torso lean actuator-coupled to the pelvis and configured to enable lateral leaning of the torso, wherein the torso lean actuator is positioned above the hip pitch actuator assemblies.

15. The humanoid robot of claim 14, wherein for each hip assembly, the hip roll actuator-includes a first extent coupled to the second extent of the hip pitch actuator, a second extent, and a hip roll axis, wherein a non-90 degree angle is formed between a reference plane that is parallel with a transverse plane of the humanoid robot and the hip roll axis.

16. The humanoid robot of claim 15, wherein for each hip assembly, the leg twist actuator; (i) includes a first extent coupled to the second extent of the hip roll actuator, and a second extent, and (ii) is positioned below an extent of both the hip pitch actuator and the hip roll actuator.

17. A humanoid robot, comprising:
a lower region configured to be in contact with a support surface upon which the humanoid robot stands in a neutral position;
a central region coupled to the lower region and having:
a waist with a torso twist actuator with a torso twist axis;
a leg twist actuator with a leg twist axis, and wherein the leg twist axis and the torso twist axis are arranged substantially parallel with one another when the humanoid robot is in the neutral position;
a pelvis coupled to the waist, and
wherein the humanoid robot lacks: (i) a structure that is directly coupled to both of the leg twist actuator and the torso twist actuator, and (ii) a rotatory actuator that is co-linear with and positioned below the torso twist axis.

18. The humanoid robot of claim 17, wherein the waist includes a waist body having a parabolic shape with a height that is less than its width.

19. The humanoid robot of claim 18, further comprising left and right hip assemblies coupled to the pelvis, and wherein each hip assembly includes a hip pitch actuator, a hip roll actuator, and a leg twist actuator.

20. The humanoid robot of claim 19, wherein for each hip assembly:
the hip pitch actuator-includes a portion positioned within the pelvis, a first extent coupled to the respective actuator mount, a second extent, and a hip pitch axis; and
the hip roll actuator-includes a first extent coupled to the second extent of the hip pitch actuator, a second extent, and a hip roll axis, wherein a non-90 degree angle is formed between the hip roll axis and a reference plane that contains the hip pitch actuator and is parallel with the transverse plane.
